(19) United States
(12) Patent Application Publication
(10) Pub. No.: US 2002/0038279 A1
(43) Pub. Date: Mar. 28, 2002

(54) Method and apparatus for using a transaction system involving fungible, ephemeral commodities including electrical power

(76) Inventors: Ralph Samuelson, Mountain View, CA (US); Tichomir Tenev, San Jose, CA (US); Edward G. Cazalet, Los Altos Hills, CA (US); John Stremel, Santa Clara, CA (US)

Correspondence Address: GLENN PATENT GROUP, 3475 EDISON WAY, SUITE L, MENLO PARK, CA, 94025, US

(21) Appl. No.: 09/932,694

(22) Filed: Aug. 16, 2001

Related U.S. Application Data
(63) Continuation-in-part of application No. 09/613,685, filed on Jul. 11, 2000.
(63) Continuation-in-part of application No. 09/564,415, filed on May 2, 2000.
(63) Continuation-in-part of application No. 09/542,854, filed on Apr. 4, 2000.
(63) Continuation-in-part of application No. PCT/US01/16886, filed on May 23, 2001.
(60) Provisional application No. 60/158,603, filed on Oct. 8, 1999.
(60) Provisional application No. 60/168,478, filed on Dec. 1, 1999.
(60) Provisional application No. 60/168,213, filed on Nov. 30, 1999.
(60) Provisional application No. 60/206,852, filed on May 23, 2000.
(60) Provisional application No. 60/291,218, filed on May 15, 2001.

(51) Int. Cl. G06F 17/60

(52) U.S. Cl. 705/37; 705/36

(57) ABSTRACT

A method and apparatus is disclosed for using a transaction system involving fungible, ephemeral commodities including electrical power, the transmission of electrical power, trading such commodities, managing user resources and credit resources, as well as managing compliance reporting of these activities.

This application is related to Provisional Patent Application No. 60/158,603 docket number APXX0001PR, entitled “Reliable Distributed System and Market Engine”, filed Oct. 8, 1999; Provisional Patent Application No. 60/168,478 docket number APXX0002PR, entitled “Method and Apparatus of Managing Fungible, Ephemeral Commodities including Electrical Power”, dated Dec. 1, 1999; Provisional Patent Application No. 60/168,213 docket number APXX0003PR, entitled “Independent for Profit Power Exchanges and ‘RTO Lite’”, dated Nov. 20, 1999; and Provisional Patent Application No. 60/206,852 docket number APXX0007PR, entitled “Macro Market Tools”, dated May 23, 2000.

This application claims priority to Provisional Patent Application No. 60/291,218 docket number APXX0008PR, entitled “Web market Window”, dated May 15, 2001.

This application is a Continuation-In-Part from patent application Ser. No. 09/564,415 docket number APXX0001, entitled “The Virtual Trading Floor for Trading Fungible, Ephemeral Commodities Including Electrical Power”, filed May 2, 2000; patent application Ser. No. 09/613,685 docket number APXX0002 entitled “Method and Apparatus of Managing Fungible, Ephemeral Commodities including Electrical Power”, filed Jul. 11, 2000; patent application Ser. No. 09/542,854 docket number APXX0003, entitled “Method and System of Managing AC Power Networks Based upon Flow-Gate Market Transactions”, filed Apr. 4, 2000; Patent Application No. PCT/US01/15,858 docket number APXX0004P, entitled “Method and Apparatus for an Engine System Supporting Transactions, Schedules and Settlements involving Fungible, Ephemeral Commodities including Electrical Power”, filed May 16, 2001; Patent Application No. PCT/US01/16,886 docket number APXX0007, entitled “Method and System Supporting Trading of Fungible, Ephemeral Commodities Including Electrical Power”, filed May 23, 2001.

### TECHNICAL FIELD

This invention relates to using a transaction system for trading, operational scheduling, and settling transactions involving ephemeral, fungible commodities with regards to electrical power as applied to grids of one or more AC power networks.

### BACKGROUND ART

The United States and, in particular, the state of California find themselves in a state of crisis regarding the availability and cost of electrical power. Many experts are investigating this crisis, including the inventors. Several primary problems contribute to that crisis.

1. The electrical power grid has seen almost no new electrical power generation capacity added in years.

2. Tools to optimally manage electrical consumption are antiquated and insensitive to changing consumption and cost patterns in real time, often amounting to no more than simple manual switches. While turning off unused equipment such as electric lights has been useful, it does not help the facility managers who must make decisions based upon plans encompassing the facility needs, such as producing products to sell and providing hot water and comfortable room temperatures in hotels.

3. The system of transmitting electrical power, particularly AC electrical power has significant congestion paths, known herein as flow gates. There has been little economic incentive to increase the transmission capacity through the flow gates, in part because there is no coherent policy provided fair and predictable economic return to the required capital investments.

4. Deregulation in the California energy industry brought many things with it, including a restriction to only short-term energy contracts. As the older, long term contracts ended, this left the bulk of the state's energy costs vulnerable to daily market fluctuations and led to the prices on the spot market dominating the cost of energy not only in California, but throughout the United States.

Regarding adding electrical power generation capacity. Many large facilities are unwelcome in the neighborhoods where they may be built, due to pollution and a lack of esthetic appeal. Up until recently, this was cited as the primary reason for little new power capacity.

One promising alternative is power generation associated with an existing facility. Many facilities can produce large quantities of burnable fuel, which could be used to generate electricity. Such facilities include, but are not limited to, municipal waste treatment plants, commercial livestock farms raising hogs and/or chickens, feed lots, saw mills, as well as farms raising vegetable matter, such as corn and sorghum. It is in the public interest that such facilities produce electrical power. Additionally, other facilities, including breweries, refineries and chemical plants, can produce electricity from steam, heated fluids or other gases, and/or heat already required by the facility.

These new facilities face must figure out how to manage such an endeavor without incurring a large management overhead. Today's power management procedures and technology is based upon large facilities, often generating hundreds of megawatts. Such facilities often require three shifts of operations staff, each of which may number a dozen or more people. These facilities also require energy traders, scheduling experts and an accounting staff to finalize and oversee the settlements phase. This management process is too expensive for a facility that sells power on the order of a megawatt. What is needed is a tool supporting all these management functions at a fraction of the overhead of contemporary methods.

Existing management systems for large generation facilities face a problem in reliably communicating between all these different necessary management functions. Usually the reliability error is in the interfaces between different management subsystems. What is needed is a unified mechanism supporting all the primary management activities discussed above, providing a consistent, easy to use tool for organizing the activities and communicating the results of the various managerial agents of a large generation facility.

As used herein, a fungible commodity refers to a commodity traded strictly in terms of the quantity of that commodity. No single unit of a fungible commodity is distinguishable from another unit of that commodity. A kilowatt-hour of 60 Hz AC power delivered on a power line is not distinguishable from another kilowatt-hour delivered at the same time to the same place on the same line. An ephemeral, fungible commodity is a fungible commodity whose existence is extremely short-lived. Electrical power generation, network bandwidth, seats on an airplane and entry slots onto a freeway during rush hour are all examples of fungible commodities which exist but for a short duration of time. In contradistinction, starting lots in an assembly line produce tangible results, which may differ widely in content, thus showing an example of an ephemeral, non-fungible commodity.

There are some basic physical properties of electrical power distribution which are important to understand. An AC power network is an electrical network connecting AC power generators to AC power loads on power lines controlled so that the network as a whole can be seen to function at an essentially constant frequency and uniform phase across the network. Drifts in phase are compensated by phase shifting devices to enforce the uniform phase property across the AC power network. Drifts in frequency are compensated at the generators. Such frequency variations are typically caused by variances between the loads and generated power. The effect of these compensations is to operationally provide essentially constant frequency and uniform phase throughout the AC power network.

The AC power distribution frequency in the United States, Canada, Mexico and some other countries is 60 Hz and in some other countries is 50 Hz. In certain cases, the power is distributed in a 2-phase transmission scheme. In certain other instances, the power is distributed in a 3-phase transmission scheme.

A grid as used herein refers to an electrical power system which may comprise more than one AC power network as well as DC power lines which may transfer energy between nodes of different AC power networks or between nodes of a single AC power network.

Cities, generators and the like act as the nodes of an AC power network. A specific node may comprise more than one generator or load. A bus connects these local facilities of a node. High voltage AC transmission lines transfer power between the cities and the generators in major load centers of an AC power network.

By way of example, in the United States, there's an AC power network called the Western States Coordinating Council, which covers British Columbia in Canada down to Northern Mexico and over to the Rocky Mountains. There's another AC power network in Texas and there is another AC power network essentially covering the rest of the United States and Canada, with the exception of a portion of Quebec. These three AC power networks are connected together by direct current lines to form the North American grid. They are not connected in AC. They are asynchronous, in that they are not synchronized either in terms of frequency or phase across the United States, Canada and northern Mexico.

Electrical power generation can be readily seen to be ephemeral and fungible. One kilowatt is reasonably treated the same as another, persisting only a relatively short period of time. Electrical power transmission can also be seen as ephemeral and fungible. Electrical power transmission is most commonly performed as AC transmission lines between nodes of an AC power network. DC power lines are used additionally to connect specific nodes of either a single AC power network or nodes of distinct AC power networks.

Electrical power storage is of typically limited time duration. The most commonly used storage system is to pump water uphill to a storage site where it is held until needed. When needed, it is gravity-fed through one or more turbines to generate electricity. Such systems, for economic reasons, are not used to store power for very long, often for no more than a day or two. It should be noted that the interface points for power into such systems are ephemeral and fungible.

Power switching between lines involving high power (megawatts and above) is not commonly done. Current examples of AC power switching include switching between amplifiers and antenna feeds in broadcast radio systems, and typically involve no more than a fraction of a megawatt. While there are some high power AC switches, they are large and expensive devices. High power AC switches rarely change state. Note that the power traversing the interfaces of such switches to a power network are ephemeral and fungible.

There are some basic physical properties distinguishing AC power distribution systems from other flow-based systems such as DC power, gas, water and oil transmission systems. AC power networks differ from gas, water, oil and other fluid flow distribution systems in that changes in power generation and loading propagate across such networks at approximately the speed of light. The effect of power generation and power loading effects the whole AC power network in a manner that, for practical purposes, is simultaneous.

Due to the stability of frequency and phase across an AC power network, changes in power have a super positioning effect. This insures that the power being carried on any line in the network is essentially a linear function of the generators and loads on the network. Furthermore, if a path of lines connects two nodes, generating power at the first node carried by the path is offset by power generated at the second node, as related by the above mentioned linear function.

These AC power networks are operated within a safe range, so that the patterns of flows are fairly predictable, given the configuration of the network does not change. The National Electric Reliability Council computes a system of a set of numbers called power transfer distribution factors available on the North American Reliability Council website, www.nerc.com, showing how the power is distributed across these various lines. It is a linear function of the amount injected, which changes sign when the direction of transfer changes from Node 1 to Node 2 into Node 2 to Node 1. Such functions are skew symmetric with respect to the nodes.

Consider a DC network: one can directly control the delivery of power from one point to another. This cannot be done on AC power networks. It is a characteristic of AC power networks that all lines are affected in roughly fixed proportions, sometimes referred to as “transfer distribution factors” and by the generating and loading at specific nodes.

By way of example, when AC power is sent from Bonneville Power Authority in the state of Washington to San Francisco, some of it comes down the direct path and some of it comes down through Idaho to Arizona and back up from Southern California to Northern California.

One may be limited in what can be brought from the Bonneville Power Authority to San Francisco because there's a problem with the flow coming up from Southern California to Northern California. Please note, this particular path, known as Path 15, is often the first path to become congested.

These constrained flow elements are called flowgates. A flowgate of a given AC power network refers herein to a collection of at least one line whose total maximum safe carrying capacity acts as a congested element of the network, constraining AC power delivery between two or more nodes of that network.

Historical congestion analysis of specific AC power networks reveals that only a small number of flowgates account for almost all congestion problems. Such flowgates are herein referred to as significant flowgates. Path 15 is considered a significant flowgate.

The associated AC power transfer across a given flowgate is additive due to the super positioning effects previously discussed. Thus, in sending 100 megawatts along a path, the transmission may have a 10% impact on the flowgate, putting 10 megawatts on the flowgate. A second generator may have a 5% impact on that flowgate. Generating 100 megawatt at the second generator would add 5 megawatt across the flowgate.

FIG. 1A depicts an exemplary AC power network based upon contemporary AC power technology as found in the prior art. The network contains 12 nodes labeled 10, 20, 30, 40, 50, 60, 70, 80, 90, 100, 110 and 120 respectively.

AC transmission line 12 runs between node 10 and node 20. Line 14 runs between node 10 and node 40. Line 22 runs between node 20 and node 30. Line 36 runs between node 30 and node 40. Line 42 runs between node 40 and node 120. Line 44 runs between node 40 and node 60. Line 46 runs between node 40 and node 50. Line 52 runs between node 50 and node 110. Line 54 runs between node 50 and node 60. Line 56 runs between node 50 and node 70. Line 62 runs between node 60 and node 110. Line 64 runs between node 60 and node 70. Line 82 runs between node 80 and node 90. Line 92 runs between node 90 and node 120. Line 94 runs between node 90 and node 110. Line 96 runs between node 90 and node 100. Line 102 runs between node 100 and node 110. Line 112 runs between node 110 and node 120.

Flowgate A 210 is a constraint on the network. Lines 32, 34 and 42 are constrained by flowgate A 210 by a total maximum safe carrying capacity, in that these lines have transmission capacity limitations which are easily overloaded when this maximum safe carrying capacity is exceeded.

Flowgate B 220 is a constraint on the network. Lines 42 and 44 are constrained by flowgate B 220.

Flowgate C 230 is a constraint on the network. Lines 52 and 62 are constrained by flowgate C 230 to a total maximum safe carrying capacity.

By way of example, a mountain range such as the Cascade mountain range in the state of Washington might have a limited number of passes. The transmission lines through each mountain pass may form a single flowgate. Flowgates A 210, B 220 and C 230 illustrate the overall effect that might result for transmission paths through three mountain passes.

Another problem, as yet addressed, is revenue sharing between multiple vendors supporting energy transmission along a flow path. By way of example, consider one of the few passes through the Cascade mountain range located in the state of Washington. Through each of these narrow corridors runs one or more strips of land populated by power transmission towers and high voltage power lines. The AC power transmitted on these power lines is frequency and phase matched. The collection of these AC power lines may create a single system constraint, a flowgate.

By way of example, suppose there are three transmission lines between two nodes in an AC power network, each individually capable of carrying 100 megawatts. These three transmission paths may collectively form a flowgate, which has a collective transmission limit of 200 megawatts, even though the sum of the three transmission lines is 300 megawatts.

Assume that some group of investors wants to finance a new set of towers supporting one or more transmission lines through this mountain pass. The new transmission facility will in all probability become part of the flowgate of transmission lines through that mountain pass from the moment it becomes operational. The question: How are flowgate transmission revenues to be shared when more than one group has made the capital investment to support such transmission? Note that if investors cannot reasonably predict a fair return on their investment, they will be unlikely to make the investment.

What is needed is a mechanism providing incentives to groups seeking to add transmission capabilities through fair and predictable revenue sharing from flowgate transmission revenues.

FIG. 1B depicts a list of associated AC power functions described by their coefficients for each flowgate of a collection of flowgates for each of the busses of the various nodes of the exemplary AC power network of FIG. 1A as disclosed in the prior art.

Note that these AC power functions are essentially linear and can be described by their coefficients.

Bus 1 locally connects all facilities of Node 10. Bus 2 locally connects all facilities of Node 20. Bus 3 locally connects all facilities of Node 30. Bus 4 locally connects all facilities of Node 40. Bus 5 locally connects all facilities of Node 50. Bus 6 locally connects all facilities of Node 60.

Bus 7 locally connects all facilities of Node 70. Bus 8 locally connects all facilities of Node 80. Bus 9 locally connects all facilities of Node 90. Bus 10 locally connects all facilities of Node 100. Bus 11 locally connects all facilities of Node 110. Bus 12 locally connects all facilities of Node 120.

Note that the facilities at these nodes, connected by the associated buss, often vary greatly in terms of generation capacity as well as loading capacity. By way of example, a city often consumes far more AC power than it generates. Another example, a node for a major hydroelectric dam such as Grand Coulee Dam would tend to generate far more AC power than it consumed.

Note that the associated AC power functions for the various busses are all fractions of 1, since the most power that could be transferred is the amount of power at the generation node. Note further that some of these AC power functions are negative. Bus 11 has strictly zeroes for its power function. It is essentially acting as a reference node for calculating the associated functions. When electricity is generated at Bus 1 and consumed at Bus 11, the values in the first row of FIG. 2 indicate the ratio of power transferred across flowgates A, B, and C. If the power is generated at Bus 11 and consumed at Bus 1, the same values apply but are of reversed sign.

Consider how AC power transfers are managed today in most of North Amerca. Transmission rights are considered and negotiated in terms of point-to-point transfers within the network known as contract paths. Such thinking is contrary to the previously discussed physics of these AC power networks, because changes in power generation or load at any node have an essentially linear effect on all transmission lines in the network, and consequently impact all flowgates within that network to some extent.

The contract path system maintains the fiction that AC power can be directed to follow a path through the network chosen as one might with natural gas. By changing the valves, one can mythically direct AC power a particular way through the AC power network. The contract path system was put in place because it was thought conceptually easier since one only had to make reservations along the single path. The fundamental problem with the contract path approach is that the contract path arrangement for transmission does not accord with the way the power actually flows in an AC power network.

Today's contract path is a first-come, first-served priority scheme. What is bought has very limited resale capability. By way of example, consider three nodes A, B and C forming a triangle in an AC power network. Suppose one bought a power transmission from A to B and bought a transmission from B to C. Using the contract path approach, does not mean one owns the power transmission from A to C, because contract paths are not additive. Owning power transmission from A to B and from B to C would not entitle power transmission from A to C. To transport from A to C, one would have to purchase separately transmission from A to C. This is because there might be some flowgate constraint which would not be met in the two separate paths which would be triggered in the combined path. So in the contract based market, which is the traditional market, once you have purchased the transmission from A to B, it's only value is for moving energy from A to B.

Today, there are several ad hoc approaches to limiting flow on one path because of the impact on another path. These contract path approaches ignore the physics of AC power networks. This leads to situations where even though some other path may actually be the constraint, when a particular path becomes over-constrained, cuts are issued to compensate. The central operator acts, because a flowgate will attempt to exceed its safe carrying capacity, forbidding transmission often across apparently irrelevant paths to compensate. The result is market chaos, since participants do not have reasonable assurance that their deals will actually go to delivery.

Another alternative approach is to take all of these generator costs, and the preferences of the buyers, into a mathematical optimization program, and figure out the optimal flow. This alternative approach has significant disadvantages. In a commercial market, getting people to reveal all their costs is quite difficult. Most people are very reluctant to do that. Further, such costs frequently change. The loads have to reveal their preferences between consuming and non-consuming players, which is a tremendous informational burden. It is extremely unlikely that they could or would do it. Even if they did, all this information is a tremendous burden on the central operator collecting all the information.

Such an alternative approach requires two-way communication among all the players, with all these devices and systems to control, when the people consume power and when they turn on and off these distributed devices. It has proven impossible to provide the requisite level of reliable communication and direct control systems. Besides, people are unwilling to turn over control of their business lives to a central operator.

Another approach in industry is used by a system operator called PJM, for Pennsylvania, New Jersey and Maryland, who have developed a system called Locational Marginal Pricing (LMP). It is a central dispatched methodology. However, a local flow model is buried within it. It supports some centralized management of generators, related equipment and facilities in order to get a consistent solution that is based upon the power distribution matrix. This is a matrix of all power transfer distribution factors between nodes of the AC power network.

This approach suffers from at least the same problems facing any other centralized control scheme. There is a very limited amount of detailed information such a system can acquire, or use, to optimize AC power transfers. The power users are again blind to their options. The players cannot determine what works best for them. The central operator dictates to them. This situation is not optimal. Also, under LMP, prices are not known until after the deal is done, which may be at the time of delivery or day ahead of delivery. Generation operators do not obtain the information they need to plan their hydroelectric, maintenance, and unit commitment decisions. Nor can price risks be easily hedged.

NERC has developed a methodology addressing flowgates to some extent. This is discussed in a document entitled “Discussion Paper on Aligning Transmission Reservations and Energy Schedules to Actual Flows”, distributed in November, 1998 by the NERC Transaction Reservation and Scheduling Self-Directed Work Team. This team proposed an electrical power industry shift to a system of reserving and scheduling transmission based on actual use of congested flowgates, which they called the FLOWBAT method. Their proposal suffers from a serious omission, it does not address the issue of allocating flowgate capacity when demand exceeds supply. By their silence on this issue, it appears that they would continue the current practice of first-come, first-served allocation. The flaws discussed above for centralized planning continue to be relevant in this approach.

Certain economists have expressed reservations with a flowgate market model utilizing a limited number of flowgates. They believe that leaving any flowgates out of the system, even minor ones, introduces gaming opportunities, which will cause the RTO to incur costs that must be paid by everyone. However, flowgates are numerous, and may arise unpredictably. It may not be feasible to trade every flowgate, as would be required to overcome the potential for gaming.

Supporting a large number of flowgates in a market model leads to several other problems. First, there is the technical problem of providing a user interface that makes it possible for users to cope with the complexity of numerous flowgates.

Second, there is the problem of maintaining liquidity with this many flowgates. Customers want to buy and sell the bundles of flowgates they need to move energy from one point in the network to another. They may not feel comfortable posting bids and offers for individual flowgates without an assurance that they will be able to buy or sell the remaining flowgates they need for their bundle at a reasonable price. If everyone withholds bids and offers from the market until they see bids and offers for all the flowgates they want to buy or sell, the market could significantly lack liquidity.

What is needed is a method of using a market model supporting large numbers of flowgates and providing users with a straightforward method of trading the AC power transfer, while discouraging gaming opportunities.

What is needed is a system supporting trading transmission rights and quantities of fungible ephemeral commodities in the form of complete bundles. These complete bundles would allow purchase of delivered energy with one transaction. The system should permit the bundles to be internally large and complicated, supporting trading in every flowgate right, and potential flowgate right and providing users with straightforward trading mechanisms for AC power transfer. Such trading mechanisms insure compliance with flowgate constraints, and thus the physics of AC power networks, while discouraging gaming opportunities.

LMP accomplishes this, but does so at a cost of forcing participants to trade FTRs at a limited number of discrete times. What is needed is an approach combining the flexibility of LMP with the benefits of true continuously traded forward markets.

While certain RTO's like the flowgate concept, they often do not want the responsibility for identifying a small number of commercially significant constraints. They want the market to identify the significant constraints.

To summarize, what is needed is a method of using a transaction system for electrical ephemeral, fungible commodities optimizing the trading, scheduling, congestion management, ancillary services, metering, billing and settlements of accounts for electrical grids. Such a system and the methods of its use should support the needs of coordinating the management of a large enterprise as well as encourage the entry of small facility operators into the power generation, transmission business, as well as aid consumption management by electrical power consumers.

### SUMMARY OF THE INVENTION

The presently preferred embodiment of the invention fulfills at least the requirements and needs discussed with regards to the prior art. The invention includes methods and apparatus support the certified client initiating at least one action in the transaction system; as well as use of at least two of the following: Managing a user resource collection; Managing a bilateral trading portfolio; Managing a market position portfolio; Managing a market trading collection; Managing a credit resource collection; And managing compliance reporting based upon at least one of the collection comprising the user resource collection, the market position portfolio, the bilateral trading portfolio, and the market trading collection.

The market trading collection is comprised of at least one market trade. A market trade involves a market interval with a product type, location and time interval, as well as at least an amount and a price. A market trade may be either an ask and/or a bid and/or a commitment regarding the market interval, amount and price.

The market position portfolio is comprised of at least one market position summary for at least one market interval, which summarizes open bids and asks for that market interval. The market position portfolio may include market position summaries for market intervals that differ in at least one of the following: product type, location and/or at least one time interval. Presentation of the market position summary may include the summary of bid and ask prices and amounts, as well as presentation of product type, location and time interval(s). When the certified client is a trader, it preferably supports simultaneous presentation of the market position summary and trading position for at least one market interval.

Note that the apparatus may include, but is not limited to, one or more computers implementing the methods as program systems, as well as mechanisms which lack program pointers, thus program steps.

The invention advantageously provides for greater integration of management tasks, thereby reducing potential errors encountered at interfaces between various tools individually performing these tasks.

The invention further advantageously provides a uniform user interface to aid operators in the extremely complex task of trading fungible, ephemeral commodities, including, but not limited to, DC and AC electricity, AC power transfers, flowgate rights, and point-to-point AC power transfer rights with bundled flowgate transmission rights.

The invention advantageously provides a seamless integration from trading, through scheduling and into operational control of the equipment found in an AC power network, or more generally, in a grid containing at least one AC power networks. Such embodiments offer cost efficient management systems to existing, as well as potential, energy consumers, energy producers, and transmission operators.

### BRIEF DESCRIPTION OF THE DRAWINGS

FIG. 1A depicts an exemplary AC power network based upon contemporary AC power technology as found in the prior art;

FIG. 1B depicts a list of associated AC power functions described by their coefficients for each flowgate of a collection of flowgates for each of the busses of the various nodes of the exemplary AC power network of FIG. 1A as disclosed in the prior art;

FIG. 2A depicts various certified clients, 3100, 3120, 3140, and 3160-3180, controlling a means for using 5000 a transaction system 6000;

FIG. 2B depicts a simplified block diagram in which the mean 5000 for using means supporting transaction system 6000 includes a transaction system 3000 comprised of at least one computer communicatively coupled with the certified client(s) and controlled by program system(s) made up of program steps residing in accessibly coupled 3022 memory 3026;

FIG. 2C depicts a refinement of transaction system 3000 as a system diagram in FIG. 2B;

FIG. 2D depicts a refinement of transaction system 3000 as a system diagram in FIG. 2C;

FIG. 2E depicts a grid management system providing functions and services for grid market operations including a collection of client computers 3700, 3720, 3740, 3760 and 3780 respectively coupled through network 3200 to server system 3500 including server computer 3520, and web server computer 3560, as well as server computer 3580 and database engine 3590;

FIG. 2E depicts a collection of client computers 3700, 3720, 3740, 3760 and 3780 respectively coupled through network 3200, as depicted in FIG. 2E, with further refinements showing a program system 4000 supporting communicating with one or more members of the engine system, as well as encryption devices;

FIG. 3A depicts a virtual trading floor 1000, containing validated orders and market intervals with associated market states and further containing a certified client collection of certified clients;

FIG. 3B depicts a market interval containing a product type, location and time interval;

FIG. 3C depicts a refinement of a market interval as depicted in FIG. 3B further containing multiple time intervals;

FIG. 3D depicts a macro market interval 1500 for a fungible, ephemeral commodity from FIG. 3A;

FIG. 4 depicts a detail flowchart of operation 5000 of FIG. 2A-2E for method of a certified client interactively using a transaction system supporting transactions involving at least one fungible, ephemeral commodity;

FIG. 5A depicts a detail flowchart of operation 5012 of FIG. 4 for the certified client initiating the action in the transaction system;

FIG. 5B depicts a detail flowchart of operation 5212 of FIG. 5A for the certified client responding to the financial commitment presented by the transaction system;

FIG. 6A depicts a validated order 1200 of the validated order collection;

FIG. 6B depicts a refinement of FIG. 6A of a validated order 1200 of the validated order collection;

FIG. 7A depicts a refinement of FIG. 3B of a market interval of an energy product type;

FIG. 7B depicts a refinement of FIG. 3B of a market interval of an AC power transfer product type;

FIG. 7C depicts a refinement of FIG. 7B of a market interval of an AC power transfer product type;

FIG. 7D depicts a refinement of FIGS. 7B and 7C of a market interval of an AC power transfer point-to-point product type;

FIG. 8 depicts a validated order 1200 comprised of at least two validated orders, each with an associated market interval;

FIG. 9A depicts a market interval of a DC power line;

FIG. 9B depicts market interval 1100 of FIG. 3B further containing a window time interval during which the market interval is active only within the window time interval;

FIG. 9C depicts market interval 1100 of FIG. 9B containing a window time interval and multiple time intervals;

FIG. 10 depicts a view of certified client user interface 7000 showing an ordering screen with hourly time interval based market intervals for a specific energy market;

FIG. 11 depicts a view of certified client user interface 7100 showing an ordering screen for daily on-peak time interval based market intervals for a specific energy market;

FIG. 12 depicts a view of certified client user interface 7200 showing an ordering screen for hourly time interval based market intervals for a specific flowgate market;

FIG. 13 depicts a view of certified client user interface 7300 showing an ordering screen for hourly time interval based market intervals with respect to a specific facility (“Hyatt Generation”) including energy transmission costs from multiple displayed markets;

FIG. 14 depicts a view of certified client user interface 7400 showing an ordering screen for hourly time interval based market intervals from a trade book perspective;

FIG. 15 depicts a view of certified client user interface 7500 showing an overview trading position for specific hours of two successive days including the trade book and a limited number of certified clients;

FIG. 16 depicts a detailed view of certified client user interface 7600 showing the trading position for specific hours of two successive days with regards to one certified client based upon FIG. 15;

FIG. 17 depicts a view of certified client user interface 7700 providing an overview of the reports on transactions and/or schedules available for presentation to the user;

FIG. 18 depicts a view of certified client user interface 7800 providing a detailed view of the monthly invoice for the certified client including fees to the transaction engine service provider, who may be a first party, (APX Fees 7802);

FIG. 19 depicts a detail flowchart of operation 5022 of FIG. 4 for managing the user resource;

FIG. 20A depicts a detail flowchart of operation 5022 of FIG. 4 for managing the user resource;

FIG. 20B depicts a detail flowchart of operation 5452 of FIG. 20A for creating the first knowledge interval;

FIG. 21A depicts a detail flowchart of operation 5022 of FIG. 4 for managing the user resource;

FIG. 21B depicts a detail flowchart of operation 5022 of FIG. 4 for managing the user resource;

FIG. 21C depicts a detail flowchart of operation 5192 of FIG. 5A for the certified client initiating the bid;

FIG. 22 depicts a detail flowchart of operation 5592 of FIG. 21A for operating the equipment usage item;

FIG. 23A depicts a detail flowchart of operation 5042 of FIG. 4 for managing the market position portfolio;

FIG. 23B depicts a detail flowchart of operation 5732 of FIG. 23A for presenting the local market position portfolio;

FIG. 24 depicts a detail flowchart of operation 5752 of FIG. 23B for presenting the market position summary;

FIG. 25A depicts a detail flowchart of operation 5000 of FIG. 4 for the method of using the transaction system;

FIG. 25B depicts a detail flowchart of operation 5832 of FIG. 25A for maintaining the market position database;

FIG. 26 depicts a detail flowchart of operation 5852 of FIG. 25B for maintaining the market position;

FIG. 27A depicts a detail flowchart of operation 5042 of FIG. 4 for maintaining the local market position portfolio;

FIG. 27B depicts a detail flowchart of operation 5000 of FIG. 2A-2E for the method of using the transaction system;

FIG. 28A depicts a detail flowchart of operation 5000 of FIG. 2A-2E for the method of using the transaction system;

FIG. 28B depicts a detail flowchart of operation 5872 of FIG. 26 for maintaining the current bid list;

FIG. 29 depicts a detail flowchart of operation 5032 of FIG. 4 for managing the bilateral trading portfolio;

FIG. 30A depicts a detail flowchart of operation 5032 of FIG. 4 for managing the bilateral trading portfolio;

FIG. 30B depicts a detail flowchart of operation 5062 of FIG. 4 for managing the credit resource collection, for each of the credit resources of the credit resource collection;

FIG. 31 depicts a detail flowchart of operation 8152 of FIG. 30B for managing the credit resource, for at least one of the credit resources of the credit resource collection;

FIG. 32A depicts a detail flowchart of operation 5022 of FIG. 4 for managing the user resource;

FIG. 32B depicts a detail flowchart of operation 5022 of FIG. 4 for managing the user resource;

FIG. 33A depicts a detail flowchart of operation 5022 of FIG. 4 for managing the user resource;

FIG. 33B depicts a detail flowchart of operation 5022 of FIG. 4 for managing the user resource;

FIG. 34A depicts a detail flowchart of operation 5052 of FIG. 4 for managing said market trade collection; and

FIG. 34B depicts a detail flowchart of operation 8412 of FIG. 34A for presenting said market trade, for at least one of said market trades.

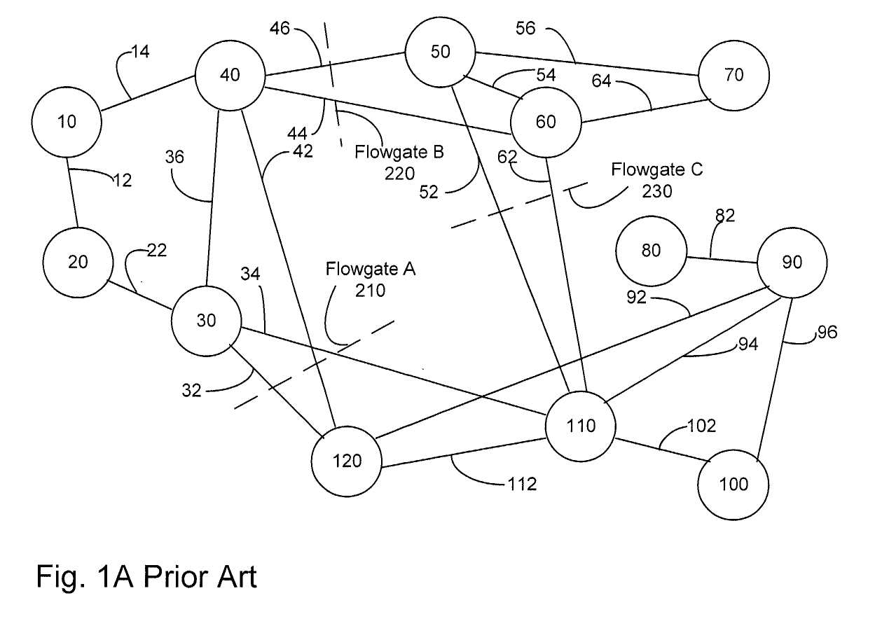

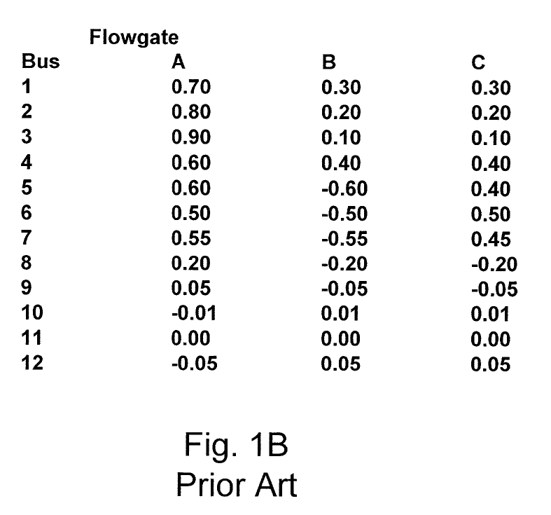

### DETAILED DESCRIPTION OF THE INVENTION

Note that a commitment may be performed without requiring a schedule. For example, a first certified client may buy a certain amount of green tickets, e.g. a form of tradable ecology-based energy credit, from a second certified client. In such situations, there might be no schedule generated for that commitment, but each certified client involved in the commitment would find the commitment referenced in the settlement.

A commitment may be scheduled for performance, but not actually be performed. For example, a network operator may curtail the availability of electrical power to consumers in certain areas to avert a blackout. Those consumers, while having scheduled commitments, did not fully enjoy the performance of the commitments. While the schedule would reflect the commitment, the settlements for those consumers would reference the actual performance of that commitment.

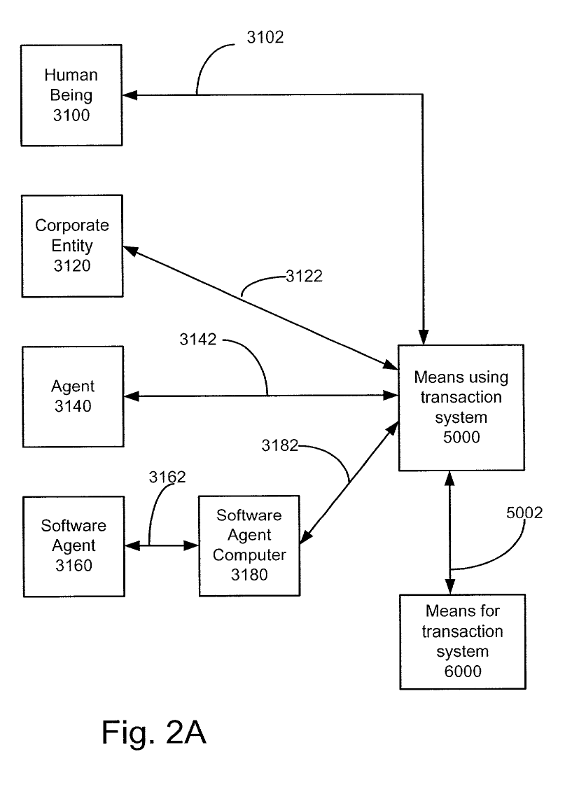

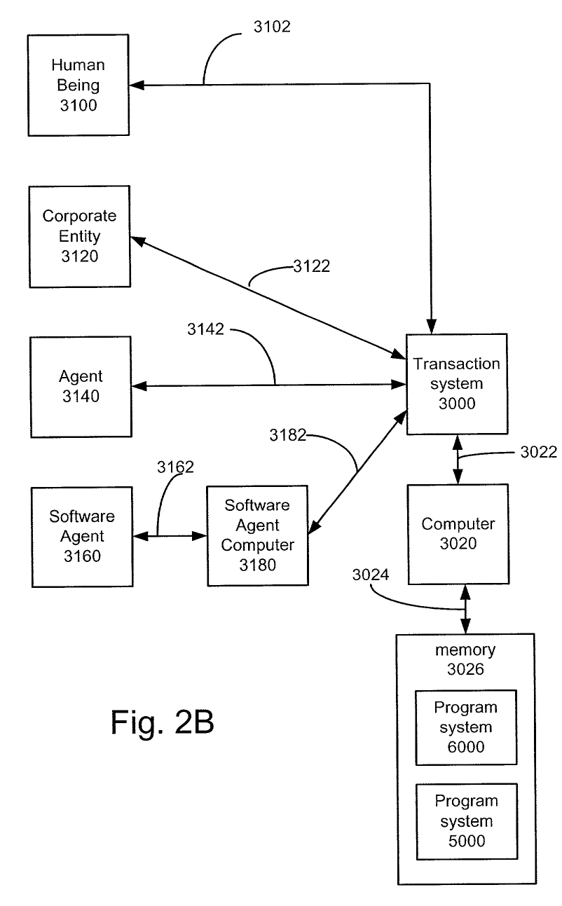

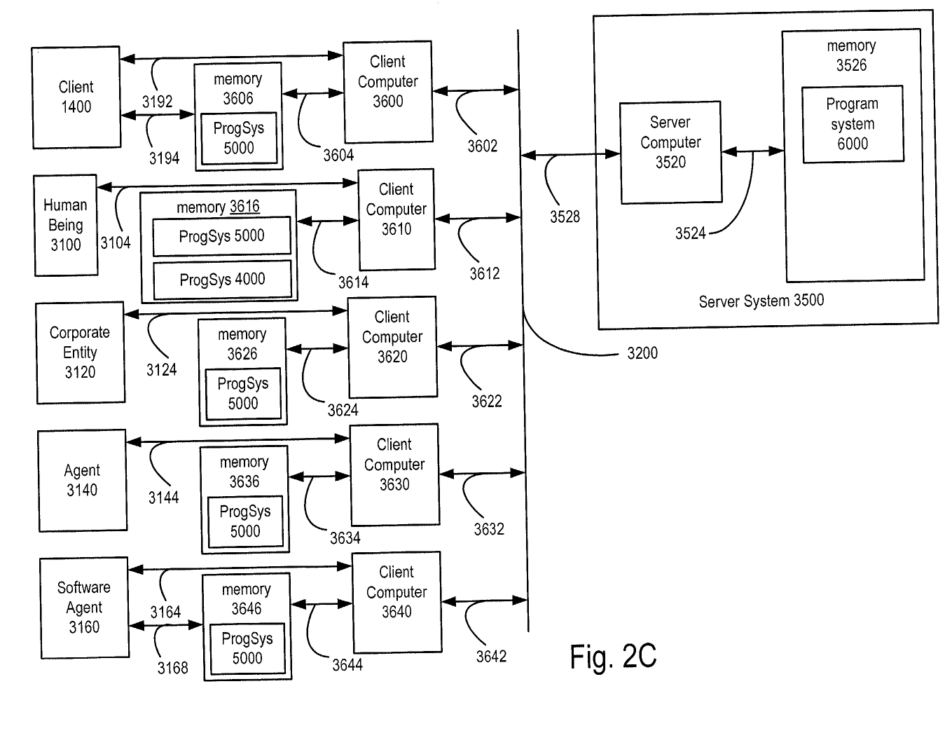

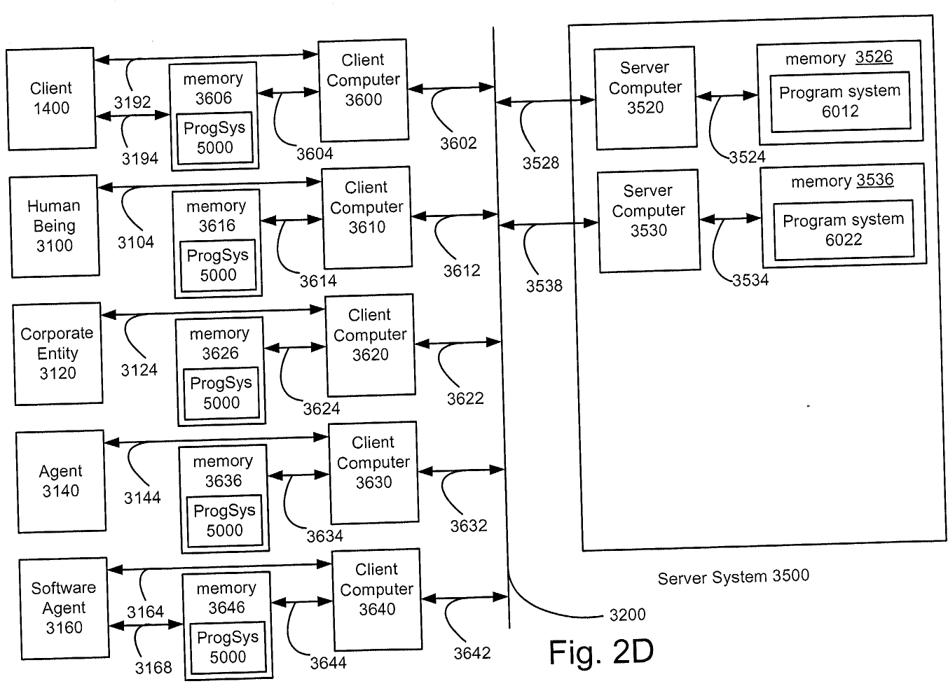

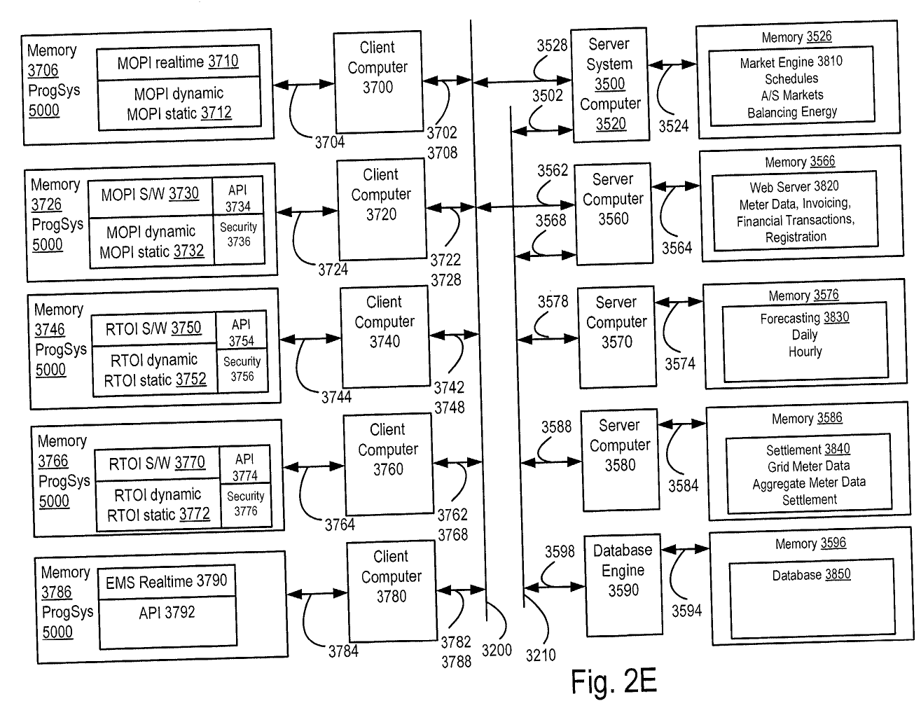

FIG. 2A depicts various certified clients, 3100, 3120, 3140, and 3160-3180, controlling a means for using 5000 a transaction system 6000.

The certified client may control 3102, 3122, 3142 and 3182 the means of use 5000 acoustically and/or tactilely and/or via wireless communications and/or via wireline communications the transaction system 6000.

Means for using 5000 and/or transaction system 6000 may include implementations of the respective operational methods, which do not rely upon instruction pointers and as such may not be considered as computers in a traditional sense.

Note that these entities, the human being 3100, corporate entity 3120, agent 3140 and software agent 3160 may communicate with means 5000 by use of messages as represented by arrows 3102, 3122, 3142, and 3182, respectively. Such messages may use a wireline physical transport layer as represented by one or more of the arrows 3102, 3122, 3142, and 3182. Such messages may use a wireless physical transport layer as represented by one or more of the arrows 3102, 3122, 3142, and 3182. Such messages may use body signals in certain further embodiments of the invention. Such messages may further use hand signals. Such message may also use acoustic signaling of messages. Such messages may also further use verbal messages in a human language.

FIG. 2B depicts a simplified block diagram in which the mean 5000 for using means supporting transaction system 6000 includes a transaction system 3000 comprised of at least one computer communicatively coupled with the certified client(s) and controlled by program system(s) made up of program steps residing in accessibly coupled 3022 memory 3026.

The operational methods 5000 and 6000 are respectively supported by program systems 5000 and 6000 containing program steps residing in memory 3026 accessibly coupled 3022 to at least one computer 3020 in the transaction system.

The transaction system may further comprise a client computer communicatively coupled to a server computer included in a server system. The certified client may operate the client computer to interactively use the transaction system.

The server system may provide a market engine supporting a virtual trading floor involving at least one of the fungible, ephemeral commodities. The server system may further comprise an engine system supporting the virtual trading floor involving the fungible, ephemeral commodities.

Transaction system 3000 is comprised of at least one computer 3020 coupled 3024 to computer readable memory 3026. The communication and interaction between transaction system 3000 and computer 3020 is denoted by arrow 3022. Such communication and interaction 3022 may employ a variety of communications technologies, including a wireless physical transport layer in certain embodiments of the invention. Alternatively, communication and interaction 3022 may employ a wireline physical transport layer.

Note that the invention may include only a market engine of the invention supporting at least any two of the following: a virtual trading floor 6032, bilateral trading 6042 and/or external market trading 6052, as well as maintain the commitment list 6062.

FIG. 2C depicts a refinement of transaction system 3000 as a system diagram in FIG. 2B. This transaction system is comprised of a client computer collection and a server system 3500 coupled to a network 3200.

The client computer collection is comprised of at least one client computer 3600 operated (used) 3192 by certified client 1400. Client computer 3610 may be operated (used) 3104 by a human being as client 3100. Client computer 3620 may be operated (used) 3124 by a corporate entity as client 3120. Client computer 3630 may be operated (used) 3144 by an authorized agent as client 3140. The certified client may be represented by an agent, authorized by the first party, to act on behalf of the first party with respect to contracting.

Server system 3500 includes at least one server computer 3520 coupled to network 3200. Network 3200 further couples 3602, 3612, 3622, 3632 and 3642 to client computers 3600, 3610, 3620, 3630 and 3640, respectively. Network 3200 at least supports communication between client computers and at least one server computer 3520 of server system 3500. As used herein, the term network refers not only to Local Area Networks (LANs), but also to Wide Area Networks (WANs). Network supported communication as used herein includes, but is not limited to, digital communication protocols as well as analog communication protocols. Network supported communication as used herein further includes, but is not limited to, message passing protocols and packet based protocols. Network supported communication as used herein further includes, but is not limited to, communication protocols including TCP/IP. Network supported communication as used herein further includes, but is not limited to, communication protocols supporting the Internet. Network supported communication as used herein further includes, but is not limited to, communication protocols supporting the World Wide Web.

Client computer 3610 with coupled 3614 computer readable memory 3616 may be operated 3104 by a client 1400 further coupled 3194 to computer readable memory 3606. Memory 3616 is shown containing program system 5000 and program system 4000. Program system 4000 implements a method of operating the client computer with respect to the transaction system, including the server and/or server system as illustrated in FIGS. 2C to 2E. Due to space constraints in FIGS. 2C to 2E, program system 4000 is only explicitly shown here. This is not means to limit the scope of the Claims, but is done strictly for the purpose of clarifying the discussion and drawings.

Client computer 3640 with coupled 3644 computer readable memory 3646 may be operated 3164 by a software agent as client 3160. The coupling 3194 may provide various personal optimizations and shortcuts, including, but not limited to, macro style functions and standard contract forms employed by the client 1400.

Server system 3500 may include at least one server computer 3520 coupled 3524 to computer readable memory 3526.

FIG. 2D depicts a refinement of transaction system 3000 as a system diagram in FIG. 2C. This transaction system is comprised of a client computer collection and a server system 3500 coupled to a network 3200.

Server system 3500 may include at least one server computer 3520 coupled 3524 to computer readable memory 3526.

Note that server computer coupled computer readable memory may contain a read-write accessible memory. Note that the read-write accessible memory may contain at least one mass storage unit. In certain a mass storage unit may include a disk drive. A mass storage unit may be accessed using a file management system. A mass storage unit may be accessed as a database.

The invention also comprises a method of operating a client computer with a client computer message address interfaced with a reliable distributed system composed of a server system containing server computers with associated messaging addresses. The method includes a login procedure, a message composition procedure for an outgoing message to the reliable distributed system, and a message analysis procedure for an incoming message from the reliable distributed system.

The login procedure may maintain a list of messaging addresses of the collection of computers of the distributed system, a first login message and a login protocol and performs the following:

a. A first server computer of the server system is selected, and a first login message is sent to the associated address of the first server computer.

b. If there is a first acknowledgment message received from the first server computer message address then the login procedure proceeds to perform the login protocol.

c. Whenever the login protocol fails with the first server computer or

whenever there is no acknowledgment message received from the first server computer within a predetermined amount of time or

whenever there remain server computers in the server system for which login has not been attempted,

a new first server computer is selected from the remaining server computers of the server system and these steps are repeated.

d. Whenever the login protocol succeeds with the first server computer, the first server computer is designated the connection computer.

The message composition procedure for an outgoing message to the distributed system may comprise performing the following: Maintaining a list of message formats. Determining the selection of a first message format. Using the first message format to create an outbound message. Sending the outbound message to the connection computer.

The message analysis procedure for an incoming message from the distributed system may comprise performing the following: Receiving the message from the connection computer. Validating the received message creates a valid received message.

An object class structure may be used to support message passing, each message comprising a message type and at least one message field. Each message-passing object comprises handling an unknown message type and handling for an unknown message field.

Handling an unknown message type for a received message from a first object by a second object may comprise the first object sending the second object a reply message indicating unknown received message type and referencing the received message.

Handling an unknown message field of the received message by the second object may comprise handling the other fields of the received message by the second object.

The invention may operate a reliable distributed system of a collection containing at least one process group running on several computers comprising receiving confirmed messages from certified clients and maintaining a group state. Each process group computer possesses a messaging address. The computers of a process group communicate among themselves with a virtually synchronous messaging system.

Receiving a confirmed message from a certified client may occur at one computer of the first collection of computers running the process group. Upon receipt the receiving computer broadcasts the confirmed message from the certified client to all computers of the first collection of computers.

Maintaining a group state on each computer of the first collection of computers of the process group may comprise the following operations: Each computer processes the confirmed message from the certified client to create a group state candidate. Each computer broadcasts a virtually synchronous group state candidate message to the other computers. Each computer receives the virtually synchronous group state candidate messages of the other computers. Each computer analyzes the received virtually synchronous group state candidate messages and its own virtually synchronous group state candidate to create a new group state.

Reliable distributed computer systems have been developed in the prior art, as in Reliable Distributed Computing With the Isis Toolkit, edited by Birman and Van Renesse, ISBN 0-8186-5342-6, © 1994 Institute for Electrical and Electronic Engineers, Inc. These reliable distributed systems are based around process groups of cooperating concurrent processes redundantly performing the same operations on copies of the same data while being distributed through a multi-computer system.

The prior art (particularly in Chapter 11, “Reliable Communication in the Presence of Failures” pages 176-200, in Reliable Distributed Computing With the Isis Toolkit) discloses basic communication protocols, ABCAST and GBCAST, for broadcasting messages within a process group and for detecting and reacting to network failures. The protocols provide strong guarantees for message delivery causality and message delivery atomicity. Message delivery causality is the guarantee that a message should not be delivered before its predecessor. Message delivery atomicity guarantees that two messages are delivered in the same sequence to all recipients.

The invention may employ a messaging system for message passing concurrent objects, instances of which reside on computers each possessing a controller belonging to a collection of computers comprising ABCAST protocol and GBCAST protocol. The ABCAST protocol is an atomic broadcast protocol used to communicate messages between object instances across the computers of the collection of computers. The GBCAST protocol is a global broadcast protocol to communicate messages between controllers of the computers of the collection of computers.

The invention may employ an object class structure executing in a process group of computers communicating with each other via a messaging protocol supporting at least virtual synchrony. Each instance of each object of the object class structure comprises an object instance clone reading on each of the process group computers.

Each object instance may further send and receive messages from other object instances and each object instance clone communicates with messages to other object instance clones of the same object instance.

However, the ABCAST and GBCAST protocols are not sufficient by themselves to implement a message driven architecture. A message driven architecture requires that objects can not only send message to each other, but also reply to those messages. The R-Object class, as used herein, refers to an object class supporting at least ABCAST, GBCAST and a message driven architecture.

Each object class may further possess a state, which is a member of a collection of states. Each instance of each object class state changes as an atomic event. All activities of each object class occur as atomic events. Atomic events may be triggered by message reception. Each instance of an object receives messages triggering state changes in the same sequence as all other instances of that object. This enforces all R-Object instances changing their state through exactly the same sequence without having to directly communicate that new state among themselves.

A concurrent computing entity may reside on each of the computers of a process group of computers where it owns access to a binary file or memory used for storing the resilient object instance state. It executes updates to the binary file as a transaction. The storage in the binary file is organized into table objects. Each table object consists of a set of records.

In certain embodiments of the invention, all individuals wishing to access the RTO systems must establish a login session with the appropriate system. This applies to RTO participants, RTO staff, as well as other systems that are integrated into the platform. Each login session is established under the protocols of the security integrated into the RTO systems. The location of the session may not be important to the system, allowing the RTO to operate multiple sites. The multiple RTO sites may each operate as a monitor site, a failover site, or to share workload. Login session at multiple sites can be connected to server system 3500 simultaneously, and are synchronized by server system 3500.

Each RTO participant may share the same security information for authorized scheduling entities (ASEs), RTO operators, and transmission operators (TOs). This security information may be maintained through the registration interface, through which all permissions for each participant may be maintained. This information may be used to validate all login sessions.

Access to the server system 3500 and/or server computer 3560 may be obtained by establishing a login session with the appropriate system. This may apply to RTO participants, including ASEs, RTO operators, and TOs, as well as other computer systems, such as EMS/SCADA systems. This ensures that only authorized individuals and systems can access the APX systems.

The security information may be checked each time that an RTO participant or computer system attempts to log into server system 3500 or server computer 3520 or web server 3560. Login information may include a login ID and password. Login information may be passed in an encrypted form. If access is permitted, the login session may then be configured in accordance with the permissions associated with the particular login ID.

This ensures that each RTO participant may access only those systems and data to which the participant is authorized.

Access to each system may also be controlled in terms of modes including at least receiving data, placing bids, and viewing positions. This mechanism restricts each login session to its authorized systems, making available only its authorized information, and does so in only its authorized modes.

Each login session may include a real-time, two-way communication session or a secure web-based connection between the RTO participant software and the servers. Each session may rely on one or more encryption mechanisms to encode the communication. For the real-time connections, this mechanism may include frequent encryption key change, which may further be invisible to the user to ensure privacy of communication between each RTO participant and the systems 3500 and 3560.

The invention may include help desk staff. The help desk staff may not have access to market data, scheduling data, or any participant business data. Further, the help desk staff may be unable observe A/S auction or EIS market activity. The help desk staff may not know who or what was selected or dispatched, or at what price. The help desk staff may in certain embodiments only monitor system conditions, such as the number of sessions logged on, the level of activity in the market (for performance monitoring), and when bidding is opened or closed. The help desk staff may maintain reliable data archives and backups on all servers. The help desk staff may perform these maintenance and archival tasks without regard to content.

In certain embodiments, certified users are primarily approved scheduling entities (ASEs), the control area operators (CAOs), and the RTO operators (regardless of location). These certified users may participate in the RTO at the operational level, using services of the server system 3500 or web server 3560.

The invention may include a method of operating a client computer communicatively coupled to an engine system. The engine system includes at least one of the following: a market engine, a scheduling engine and a settlement engine. The client computer communicating with the engine system supports certified client transactions regarding market intervals. Each market interval contains at least one fungible, ephemeral commodity, a location and a time interval.

An engine group includes at least two engine group computers, each implementing a market engine, a scheduling engine or a settlement engine. Note that two engine group computers may redundantly implement a market engine. Alternatively, two engine group computers may redundantly implement a scheduling engine. Additionally, two engine group computers may redundantly implement a settlement engine. An engine group may include two engine group computers implementing different engines. The engine group provides multiple access mechanisms by which communications between the client computer and the engine system may take place.

Note that the engine system may include one or more engine groups. Note that the engine system may be implemented as an engine group.

The client computer may interact with at least one member of the engine group by establishing the client computer as the certified client through communication with the engine system and participating as the certified client communicating with the engine system.

The engine group advantageously removes the potential for a single point of failure in the communication between the client and the engines implemented by the engine group, increasing the overall communication system reliability.

FIG. 2E depicts a grid management system providing functions and services for grid market operations including a collection of client computers 3700, 3720, 3740, 3760 and 3780 respectively coupled through network 3200 to server system 3500 including server computer 3520, and web server computer 3560, as well as server computer 3580 and database engine 3590.

The discussion of variations regarding the use of client computers is found in FIGS. 2C and 2D. A certified client, possibly a human being, corporate entity, agent, or software agent may each control any of the examples of client computers 3700, 3720, 3740, 3760 and 3780.

As used herein, MOPI refers to Market Operations Participant Interface. MOPI is an interface may that include, but is not limited to, the functions and capabilities of Participants, who are certified clients of the system.

As used herein, RTOI refers to RTO Operator Interface. RTOI is an interface that may include, but is not limited to, the functions and capabilities of Participants, who are certified clients of the system and who interact as RTO Operators within one or more grids.

As used herein, EMS refers to Energy Management System.

EMS and RTOI components may each further perform operations including, but not limited to,

Receiving energy management schedules,

Confirming receipt of energy management schedules,

Receiving requests for energy equipment status,

Providing energy equipment status,

Sending requests for energy equipment status,

Receiving energy equipment status reports,

Receiving metering data about transmission lines,

Receiving frequency data about transmission lines, and

Command override messages putting a specific remote energy site offlimits to automated control and places it under manual control of the operator.

Sending output adjustment commands to remote energy generation sites.

Note that these output adjustment commands have the effect of modifying the transmission line frequencies and the output adjustment commands take into account the effect on transmission line frequencies as well as flowgate constraints in making these commands.

There may be client computers with accessible memory containing MOPI components such as client computers 3700 and 3720 or containing RTOI components such as client computers 3740 and 3760 or containing EMS components such as client computer 3780. There may be no client computers with accessible memory containing MOPI components such as client computers 3700 and 3720. There may be no client computers with accessible memory containing RTOI components such as client computers 3740 and 3760. There may be no client computers with accessible memory containing EMS components such as client computer 3780.

Client computer 3700 accessibly couples 3704 to computer readable memory 3706 as well as communicatively couples 3702 to network 3200. The MOPI realtime component 3710 and MOPI dynamic and static component 3712 may both reside in accessibly coupled memory 3706.

The MOPI realtime component 3710 may include a method of using market engine 3810 with MOPI dynamic and static component 3712. The method of using market engine 3810 may include, but is not limited to, participating in sessions with market engine 3810 in which at least one of the following may occur. An order may be sent, which may include one or more ask orders and/or one or more bid orders. A market price may be requested. A market price may be received. A validated commitment may be received. Notification of the opening or closing of a market interval may be received.

The MOPI realtime component 3710 may include the ability to use communication with more than one server computer 3520 within server system 3500 to communicate within a session with the market engine 3810.

The MOPI realtime component 3710 may include the ability to encrypt the communication with server system 3500. Alternatively, the client computer 3700 may include security devices insuring security independently of the method of using the market engine. Additionally both the MOPI realtime component 3710 and the client computer 3700 may act together to provide two layers of security.

Client computer 3720 accessibly couples 3724 to computer readable memory 3726 as well as communicatively couples 3722 to network 3200. The MOPI software component 3730 and MOPI dynamic and static component 3732 may both reside in accessibly coupled memory 3726.

The MOPI realtime component 3730 may include a method of using market engine 3810 with MOPI dynamic and static component 3712. The method of using market engine 3810 may include, but is not limited to, participating in sessions with market engine 3810 in which at least one of the following may occur. An order may be sent, which may include one or more ask orders and/or one or more bid orders. A market price may be requested. A market price may be received. A validated commitment may be received. Notification of the opening or closing of a market interval may be received.

The MOPI realtime component 3730 may include the ability to use communication with more than one server computer 3520 within server system 3500 to communicate within a session with the market engine 3810. MOPI realtime component 3730 may further include API 3734, which controls the ability to use communication with more than one server computer 3520 within server system 3500 to communicate within a session with the market engine 3810.

The MOPI realtime component 3730 may include the ability to encrypt the communication with server system 3500. Alternatively, the client computer 3720 may include security devices insuring security independently of the method of using the market engine. Additionally both the MOPI realtime component 3730 and the client computer 3720 may act together to provide two layers of security. MOPI realtime component 3730 may include security module 3736 providing the ability to encrypt the communication with server system 3500.

Client computer 3740 accessibly couples 3744 to computer readable memory 3746 as well as communicatively couples 3742 to network 3200. The RTOI software component 3750 and RTOI dynamic and static component 3752 may both reside in accessibly coupled memory 3746.

The RTOI realtime component 3750 may include a method of using market engine 3810 with RTOI dynamic and static component 3712. The method of using market engine 3810 may include, but is not limited to, participating in sessions with market engine 3810 in which at least one of the following may occur. An order may be sent, which may include one or more ask orders and/or one or more bid orders. A market price may be requested. A market price may be received. A validated commitment may be received. Notification of the opening or closing of a market interval may be received.

The RTOI realtime component 3750 may include the ability to use communication with more than one server computer 3520 within server system 3500 to communicate within a session with the market engine 3810. RTOI realtime component 3750 may further include API 3754, which controls the ability to use communication with more than one server computer 3520 within server system 3500 to communicate within a session with the market engine 3810.

The RTOI realtime component 3750 may include the ability to encrypt the communication with server system 3500. Alternatively, the client computer 3740 may include security devices insuring security independently of the method of using the market engine. Additionally both the RTOI realtime component 3750 and the client computer 3740 may act together to provide two layers of security. RTOI realtime component 3750 may include security module 3756 providing the ability to encrypt the communication with server system 3500.

Client computer 3760 accessibly couples 3764 to computer readable memory 3766 as well as communicatively couples 3762 to network 3200. The RTOI software component 3770 and RTOI dynamic and static component 3772 may both reside in accessibly coupled memory 3766.

The RTOI realtime component 3770 may include a method of using market engine 3810 with RTOI dynamic and static component 3712. The method of using market engine 3810 may include, but is not limited to, participating in sessions with market engine 3810 in which at least one of the following may occur. An order may be sent, which may include one or more ask orders and/or one or more bid orders. A market price may be requested. A market price may be received. A validated commitment may be received. Notification of the opening or closing of a market interval may be received.

The RTOI realtime component 3770 may include the ability to use communication with more than one server computer 3520 within server system 3500 to communicate within a session with the market engine 3810. RTOI realtime component 3770 may further include API 3774, which controls the ability to use communication with more than one server computer 3520 within server system 3500 to communicate within a session with the market engine 3810.

The RTOI realtime component 3770 may include the ability to encrypt the communication with server system 3500. Alternatively, the client computer 3760 may include security devices insuring security independently of the method of using the market engine. Additionally both the RTOI realtime component 3770 and the client computer 3760 may act together to provide two layers of security. RTOI realtime component 3770 may include security module 3776 providing the ability to encrypt the communication with server system 3500.

Client computer 3780 accessibly couples 3784 to computer readable memory 3786 as well as communicatively couples 3782 to network 3200. The EMS realtime component 3790 may both reside in accessibly coupled memory 3706.

The EMS realtime component 3790 may include a method of using market engine 3810 with EMS dynamic and static component 3712. The method of using market engine 3810 may include, but is not limited to, participating in sessions with market engine 3810 in which at least one of the following may occur. An order may be sent, which may include one or more ask orders and/or one or more bid orders. A market price may be requested. A market price may be received. A validated commitment may be received. Notification of the opening or closing of a market interval may be received.

The EMS realtime component 3790 may include the ability to use communication with more than one server computer 3520 within server system 3500 to communicate within a session with the market engine 3810. EMS realtime component 3790 may further include API 3794, which controls the ability to use communication with more than one server computer 3520 within server system 3500 to communicate within a session with the market engine 3810.

The EMS realtime component 3790 may include the ability to encrypt the communication with server system 3500. Alternatively, the client computer 3780 may include security devices insuring security independently of the method of using the market engine. Additionally both the EMS realtime component 3790 and the client computer 3780 may act together to provide two layers of security. EMS realtime component 3790 may include security module 3796 providing the ability to encrypt the communication with server system 3500.

Because many components are integrated into the architecture, they are available to all operational functions. The RTOI software component 3750 and RTOI dynamic and static component 3752, for example, may share the common communications and communicate directly with the RTO participants and RTO staff simultaneously. This permits the creation of integrated user interfaces that contain all of the functions of the services delivered via these systems in a single point of contact. The users are not forced to deal with integration issues and disparate mechanisms to communicate with the RTO.

In certain embodiments of the invention, all individuals wishing to access the RTO systems must establish a login session with the appropriate system.

This applies to RTO participants, RTO staff, as well as other systems that are integrated to the platform. Each login session is established under the protocols of the security integrated into the RTO systems. The location of the session may not be important to the system, allowing the RTO to operate multiple sites. The multiple RTO sites may each operate as a monitor site, a failover site, or to share workload. Login session at multiple sites can be connected to server system 3500 simultaneously, and are synchronized by server system 3500.

Each RTO participant may share the same security information for authorized scheduling entities (ASEs), RTO operators, and transmission operators (TOs). This security information may be maintained through the registration interface, through which all permissions for each participant may be maintained. This information may be used to validate all login sessions.

Access to the server system 3500 and/or server computer 3560 may be obtained by establishing a login session with the appropriate system. This may apply to RTO participants, including ASEs, RTO operators, and TOs, as well as other computer systems, such as EMS/SCADA systems. This ensures that only authorized individuals and systems can access the APX systems.

The security information may be checked each time that an RTO participant or computer system attempts to log into server system 3500 or server computer 3520 or web server 3560. Login information may include a login ID and password. Login information may be passed in an encrypted form. If access is permitted, the login session may then be configured in accordance with the permissions associated with the particular login ID.

This ensures that each RTO participant may access only those systems and data to which the participant is authorized.

Access to each system may also be controlled in terms of modes including at least receiving data, placing bids, and viewing positions. This mechanism restricts each login session to its authorized systems, makes available only its authorized information, and does so in only its authorized modes.

Each login session may include a real-time, two-way communication session or a secure web-based connection between the RTO participant software and the servers. Each session may rely on one or more encryption mechanisms to encode the communication. For the real-time connections, this mechanism may include frequent encryption key change, which may further be invisible to the user to ensure privacy of communication between each RTO participant and the systems 3500 and 3560.

Certain embodiments may include help desk staff. The help desk staff may not have access to market data, scheduling data, or any participant business data. Further, the help desk staff may be unable observe A/S auction or EIS market activity. The help desk staff may not know who or what was selected or dispatched, or at what price. The help desk staff may in certain embodiments only monitor system conditions, such as the number of sessions logged on, the level of activity in the market (for performance monitoring), and when bidding is opened or closed. The help desk staff may maintain reliable data archives and backups on all servers. The help desk staff may perform these maintenance and archival tasks without regard to content.

In certain embodiments, certified users are primarily approved scheduling entities (ASEs), the control area operators (CAOs), and the RTO operators (regardless of location). These certified users may participate in the RTO at the operational level, using services of the server system 3500 or web server 3560.

The invention also comprises a method of operating a client computer communicatively coupled to an engine system. The engine system includes at least one of the following: a market engine, a scheduling engine and a settlement engine. The client computer communicating with the engine system supports certified client transactions regarding market intervals. Each market interval contains at least one fungible, ephemeral commodity, a location and a time interval.

An engine group includes at least two engine group computers, each implementing a market engine, a scheduling engine or a settlement engine. Note that two engine group computers may redundantly implement a market engine. Alternatively, two engine group computers may redundantly implement a scheduling engine. Additionally, two engine group computers may redundantly implement a settlement engine. An engine group may include two engine group computers implementing different engines. The engine group provides multiple access mechanisms by which communications between the client computer and the engine system may take place.

Note that the engine system may include one or more engine groups. Note that the engine system may be implemented as an engine group.

The client computer may interact with at least one member of the engine group by establishing the client computer as the certified client through communication with the engine system and participating as the certified client communicating with the engine system.

The engine group advantageously removes the potential for a single point of failure in the communication between the client and the engines implemented by the engine group, increasing the overall communication system reliability.

FIG. 2E depicts a collection of client computers 3700, 3720, 3740, 3760 and 3780 respectively coupled through network 3200, as depicted in FIG. 2E, with further refinements showing a program system 4000 supporting communicating with one or more members of the engine system, as well as encryption devices.

Program system 4000 contains program steps residing in the accessibly coupled memory of the client computers, implementing the method of operating the client computers in their communicative interactions with one or more of the engines or the engine group shown in FIG. 2E. Note that any client computer may accessibly coupled to more than one kind of memory. The discussion herein refers to accessibly coupled memory as including any memory, which can even once be accessibly coupled to the client computer.

The MOPI realtime component 3710 may include the program system 4000, or be included within the program system 4000 as the implementation of the method of operating the client computer to communicatively interact with one or more of the engines or the engine group shown in FIG. 2E.

Client computer 3700 may interact with at least one member of the engine group by establishing the client computer as the certified client through communication with the engine system and participating as the certified client communicating with the engine system.

The MOPI realtime component 3730 may include the program system 4000, or be included within the program system 4000 as the implementation of the method of operating the client computer to communicatively interact with one or more of the engines or the engine group shown in FIG. 2E.

API component 3734 may include the program system 4000, or be included within the program system 4000 as the implementation of the method of operating the client computer to communicatively interact with one or more of the engines or the engine group shown in FIG. 2E.

Security module 3736 may be included in program system 4000. Alternatively, security module 3736 may be used through a software interface by program system 4000. Security module 3736 may include a third party vendor supplied software component. Security module 3736 may include an implementation of the Secure Socket Layer protocol.

Client computer 3720 may include security device 3800 insuring security independently of the method of using the market engine or the software controlling client computer 3720. Additionally both the MOPI realtime component 3730 and the client computer 3720 may act together to provide two layers of security. MOPI realtime component 3730 may include security module 3736 providing the ability to encrypt the communication with server system 3500.

Client computer 3720 may be coupled 3802 to encryption device 3800. Client computer 3720 may control the operation of encryption device 3800.

The RTOI software component 3750 may include the program system 4000, or be included within the program system 4000 as the implementation of the method of operating the client computer to communicatively interact with one or more of the engines or the engine group shown in FIG. 2E.

API component 3754 may include the program system 4000, or be included within the program system 4000 as the implementation of the method of operating the client computer to communicatively interact with one or more of the engines or the engine group shown in FIG. 2E.

Security module 3756 may be included in program system 4000. Alternatively, security module 3756 may be used through a software interface by program system 4000. Security module 3756 may include a third party vendor supplied software component. Security module 3756 may include an implementation of the Secure Socket Layer protocol.

Encryption receiver 3810 may receive 3812 messages from one or more of the engine group from network 3200. The results of processing the received message may be conveyed 3814 to client computer 3740.

Encryption transmitter 3820 may receive 3822 messages from client computer 3740 to be encrypted. The encrypted messages may then be sent 3824 from encryption transmitter 3820 to network 3200.

In certain embodiments of the invention, a single security device may incorporate encryption receiver 3810 and encryption transmitter 3740.

Encryption receiver 3810 may receive 3812 messages from and encryption transmitter 3820 may transmit 3824 messages to the same engine of the engine system. Encryption receiver 3810 may receive 3812 messages from and encryption transmitter 3820 may transmit 3824 messages to different engines of the engine system.

The RTOI realtime component 3770 may include the program system 4000, or be included within the program system 4000 as the implementation of the method of operating the client computer to communicatively interact with one or more of the engines or the engine group shown in FIG. 2E.

API component 3774 may include the program system 4000, or be included within the program system 4000 as the implementation of the method of operating the client computer to communicatively interact with one or more of the engines or the engine group shown in FIG. 2E.

Security module 3776 may be included in program system 4000. Alternatively, security module 3776 may be used through a software interface by program system 4000. Security module 3776 may include a third party vendor supplied software component. Security module 3776 may include an implementation of the Secure Socket Layer protocol.

The EMS realtime component 3790 may include the program system 4000, or be included within the program system 4000 as the implementation of the method of operating the client computer to communicatively interact with one or more of the engines or the engine group shown in FIG. 2E.

API component 3792 may include the program system 4000, or be included within the program system 4000 as the implementation of the method of operating the client computer to communicatively interact with one or more of the engines or the engine group shown in FIG. 2E.

Client computer 3700 may include encryption device 3830 insuring security independently of the method of using the market engine. Both the EMS realtime component 3790 and client computer 3700 may act together to provide two layers of security. EMS realtime component 3790 may include security module 3796 providing the ability to encrypt the communication with server system 3500.

Communication 3832 between client computer 3780 and encryption device 3830 may utilize memory access mechanism 3784. The memory access mechanism 3784 may be across a general-purpose bus. Communication 3832 may act as an input-output port scheme on the general-purpose bus.

Communication 3832 may also be implemented by use of a memory-mapping scheme whereby encryption device 3830 is accessed 3784 by special addresses 3832 in the memory domain.

Note that a client computer system may employ more than one security device. Further, a client computer system may employ different security measures in communication with different engines of the engine system.

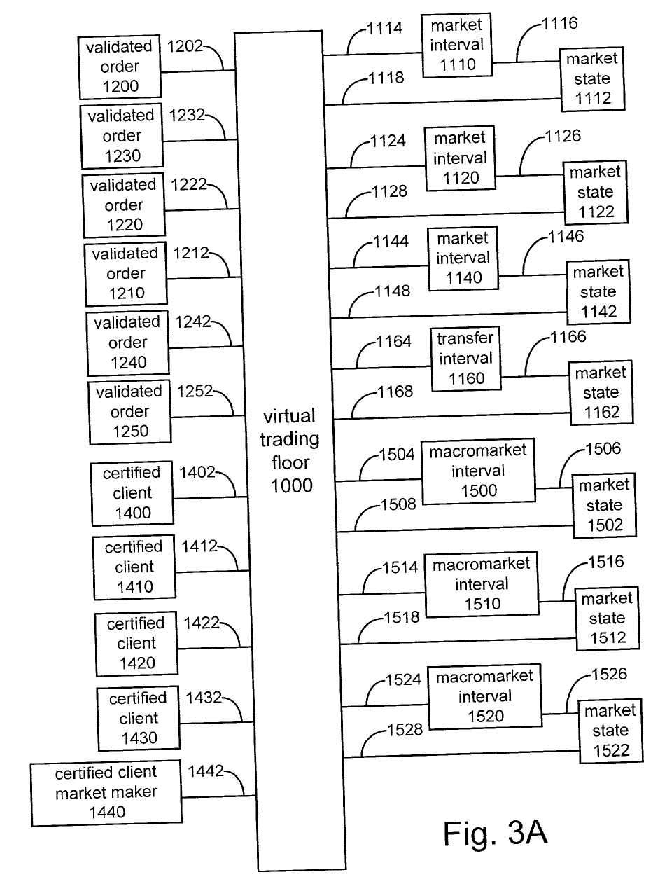

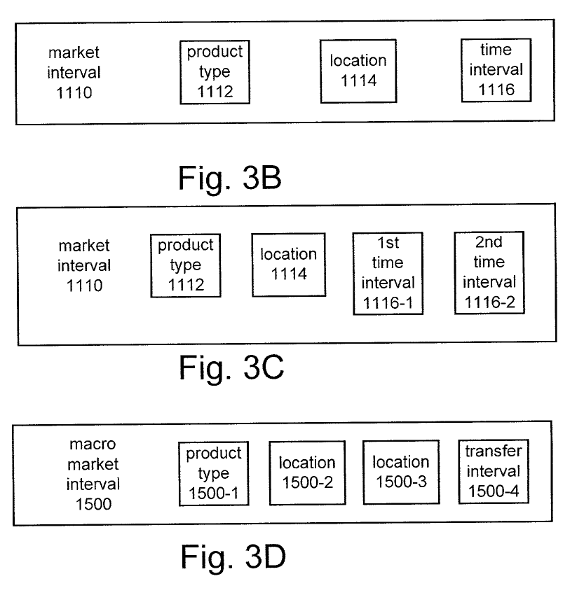

FIG. 3A depicts a virtual trading floor 1000, containing validated orders and market intervals with associated market states and further containing a certified client collection of certified clients.

The virtual trading floor mechanism 1000 comprises a collection of market intervals, each with an associated market state, and validated orders. A market contains a product type and a location. Trading in the market is done in terms of market intervals 1100, 1120, and 1140 as well as specialized market intervals including transfer intervals 1160 and macro market intervals 1200, 1210 and 1220.

Each market interval of a market contains the market product type, market location, plus a calendar scheme with an interval end. The market state of a market interval comprises a market price for the market interval product type at the market interval location during the market interval time interval.

Note that some market intervals such as market interval 1160 are further denoted as transfer intervals, further shown in FIG. 3D. A transfer interval 1160 includes a location further distinguished as having a start location 1163 and a delivery location 1164. For many fungible non-ephemeral commodities, not only is a product type 1161 specified, but also a transfer type 1162 is specified. By way of example, a container of wheat may be transported by truck, train, barge or ship. As with other market intervals, there is a time interval 1165 involved, which designated the expected time of transport.

Macro market intervals 1200, 1210, and 1220 are also shown. These are specialized market intervals which reflect at least one origin market interval and at least one destination market interval. FIG. 3E provides a more detailed discussion of macro markets for fungible non-ephemeral commodities. FIG. 3F provides a more detailed discussion of macro markets for fungible ephemeral commodities.

A validated order may contain an amount of the market interval product type, a price for the market interval product type. The validated order is either a bid validated order or an ask validated order.

FIG. 3A also depicts a certified client collection comprised of certified clients. Certified clients may include, but are not limited to, human beings. Certified clients may further include, but are not limited to, corporate entities. Certified clients may also further include agents authorized by the certified clients to represent them in interactions regarding the virtual trading floor. Certified clients may also further include software agents executing on software agent computers authorized by certified clients to represent them in interactions regarding the virtual trading floor. Note that in certain embodiments of the invention, the market engine manages and/or maintains the certified client collection.

A virtual trading floor may support trading ephemeral, fungible commodities of an electrical power grid containing at least one AC power network. Each AC power network further contains a node collection of at least two nodes. The product type of the market intervals of the market interval collection may be a member of a product type collection comprised of energy and AC power transfer. The location of a market interval having an energy product type may be a first node of the node collection of an AC power network contained in the electrical power grid. The location of a market interval having an AC power transfer product type may be from a first node of a first AC power network contained in the electrical power grid to a second node of the first AC power network.

Some certified clients may be market makers 1440. Market makers are market participants who have taken on the additional role of attempting to arbitrage in transmission.

For fungible ephemeral commodities, market makers 1440 use the transaction system to access point-to-point transmission orders and individual flowgate orders. Market makers 1440 may also have their own inventories of point-to-point transmission rights and flowgate rights, which they may or may not choose to post in the market.

Market makers 1440 may also be described as market providers in certain economic systems, where the term “market maker” has a pre-established and divergent meaning.

Market makers 1440 may receive “request for quotes” from other certified clients. In energy markets, these requests may be triggered whenever a participant opens an Energy Market screen for a particular facility, market, strip, and lot size. Using mathematical models of their own choosing, market makers may generate quotes for the transmission products displayed on the participant's screen. These quotes may be submitted to the transaction system as market maker quotes.

The transaction system may identify market maker quotes, and may keep them separate from the standing orders submitted by participants who actually own, or wish to buy, transmission. The reason is that the market maker quotes are derived from the standing orders, and market makers will not want to consider these derived quotes when creating new derived quotes. If they did, the number of possibilities for them to consider would explode, with no gain in information.

Market makers may interactively submit their quotes to the transaction system. Speed in calculating quotes would be of the essence, since the only real risk to the market maker is posting a quote based on stale data.

Market makers may withdraw their quotes at any time, even after the participant has signaled his/her acceptance and it is on the way back through the network to the market maker. Market makers may not, however, refuse an order that is based on a quote that is still posted at the time they receive that order. Not having this rule would open the way for all kinds of gaming by market makers, which would undermine the integrity of the market. Like market makers everywhere, market makers in this system must be constantly reevaluating and updating their quotes.

A single market could have multiple competing market makers. Market makers may compete for competitive advantage based on the speed of their responses (thereby minimizing losses due to stale quotes), the ability of their algorithms to find the best price, their skill at maintaining strategic inventories of flowgates and point-to-point transmission rights, and their operating costs. This kind of competition encourages innovation, low costs, and liquidity, and is good for the participants.

Market makers may be allowed to go into a negative position in individual flowgate rights, or even point-to-point rights, assuming they have sufficient credit with the RTO. If the market maker is still in a negative position at the scheduling deadline, he/she will be billed for the missing transmission rights, just as if they had submitted an uncovered schedule. To the participant who bought the transmission right from a market maker with a negative position, the transmission right is the same as any other. This rule provides a “cushion” that insures liquidity in the market. It means that market makers always have a way to quote a price for any transmission the participants may desire to buy or sell. The rule is harmless, in such embodiments, all of these transmission rights affect only the financial settlement.

Allowing market makers to go into negative positions in transmission rights also removes any incentive to hoard transmission rights. Without this rule, hoarding could be attractive in a system with hundreds of flowgates, since one participant could buy up all the rights to some flowgate that is not perceived as scarce for very little money. Without a liquid market in even one flowgate, it might be impossible for market makers to create quotes for many point-topoint rights.

There may be rules prohibiting a single participant from owning more than a certain fraction of a single flowgate. But such rules require policing and can get in the way of some participants with legitimate needs, and might not be effective if several participants act in concert (with or without explicit collusion).

The RTO's role may begin with the initial auctions. The RTO auctions both flowgate rights and point-to-point rights, based on an algorithm that maximizes the value received. This algorithm is similar to the algorithm currently used by PJM to auction FTRs.

Thus, once a new transmission provider is acknowledged by the RTO, it would enter the revenue process at the RTO auction by becoming part of the trading followed by scheduling followed by settlement processes.

Under normal conditions, the RTO stands behind all point-to-point rights, both those auctioned initially and those created (and recreated) by market makers and participants. Any participant can obtain reasonable price certainty by buying a point-to-point right. In the event that one of the 400 flowgates has to be de-rated, the RTO may buy back the flowgate rights or optionally redispatch around the problem.

In the event that a new constraint appears in the system that is not one of the traded flowgates, the RTO may buy back existing flowgate rights in order to force flows to meet the new constraint, or optionally redispatch around the problem. No new flowgates are ever added after the initial auction. With hundreds of degrees of freedom, the RTO has plenty of levers to deal with virtually any constraint that may occur. The real-time LMP runs as if the constraints are on the traded flowgates that the RTO actually uses to limit flow, not the unrepresented constraint.

In general, not representing a constraint in the network creates a potential opportunity for gaming, since the participant could create congestion on the constraint, then get paid by the RTO to mitigate it. However, in a system with hundreds of flowgates, an individual participant is not likely to be able to create much congestion on an unrepresented constraint without exceeding the limit on flowgates that are represented. If the congestion on the unrepresented constraint is due to an equipment failure, the RTO may pay to mitigate the problem, as it would do under FTRs.

In extreme situations, it may not be possible for the RTO to buy back flowgate rights or redispatch at a reasonable cost. In these situations, the RTO may be allowed to buy-back rights from participants on a pro-rata basis at a preset ceiling price.

Such bundled point-to-point rights possess at least the following advantages.

Forward price discovery of congestion costs allows planning of unit maintenance, unit commitment, and hydroelectric resources.

Bundled point-to-point rights advantageously minimize market involvement of RTO in the market, including involvement in the selection of commercially significant flowgates.

Easily traded market instruments for hedging congestion costs, providing virtually complete hedging of risk for participants.

Flowgates provide a mechanism for resolving seams issues between control areas.

Bundled point-to-point rights with a flowgate foundation assure least cost redispatch within system constraints.

Bundled point-to-point rights with a flowgate foundation give a complete set of congestion costs between all locations at delivery time.

Bundled point-to-point rights with a flowgate foundation support participants producing and consuming energy with minimal advance scheduling.

Bundled point-to-point rights with a flowgate foundation provide the ability to handle large numbers of constraints.

FIG. 3B depicts a market interval containing a product type, location and time interval. The product types may include ephemeral, fungible commodities. All product types may be ephemeral, fungible commodities.

Location may refer to a single node. A node may be specified geographically. A node may be specified in terms of nodes in a network. The network may contain both a collection of nodes and a collection of lines, each line extends from a first node to a second node. Note that the term line as used herein does not exclusively imply a straight line. A node may be specified in terms of a node of a network contained in a grid of one or more networks, further containing special lines connecting nodes of potentially distinct networks.

Location may additionally refer to a transition or transfer from a first node to a second node.

A market interval has a uniform price for its product type within the time interval. A market interval may also have uniform buy and sell positions, to support uniform movement of the product within the market interval. A single market interval may be seen to act as an independent commodity market of the fungible, ephemeral commodity for its product type.

FIG. 3C depicts a refinement of a market interval as depicted in FIG. 3B further containing multiple time intervals.

In FIG. 3C, two time intervals are depicted by way of example. More than two time intervals may be contained in one market interval. Each of the multiple time intervals may not temporally overlap the other contained time intervals of the market interval.

Note that both market positions and market prices may have similar formats. Both market positions and market prices may include representations as a quantity, which is a scalar value, and a point or set of points over a calendar line known herein as a time interval. Arithmetic functions and operations including, but not limited to, addition, subtraction, negation, multiplication, minimums and maximums are readily extended to apply to these scalar values over calendar time.

As stated elsewhere in this document, the minimal condition placed upon the time intervals of a market interval is that they not overlap. It is often advantageous to place further constraints on market intervals in terms of the orders submitted to a virtual trading floor.

These constraints can be thought of as follows: if order market intervals were the footprints on the calendar line, a strip may be considered the shoe that left those footprints. While there may be an indefinitely large number of orders covering the calendar line, there are usually only a small finite number of shoes, i.e. strips involved with those orders. An order's market interval may be further constrained to only begin at discrete points on the calendar line.

By way of example, consider the following strips:

An hourly strip is a market interval that allows orders to be submitted for market intervals that start on the hour and last for an hour.

A daily strip is a market interval that allows orders to be submitted for market intervals that start on the local time day boundary and end on local time boundaries. As used here, local time means the local time with respect to the location of the market segment. Note that because the strip is specified in terms of the local time, the actual length may vary depending on the current calendar day at that location. For example, during daylight to standard time transition in the United States, the daily strip spans 25 hours instead of the standard 24 hours.

A daily off-peak strip allows orders for market intervals that start at the local time day boundary and continue until 6:00 AM local time and then start again at, 10:00 PM and continue until the ending day boundary.

Other examples may include, but are not limited to, five-minute strips, monthly strips and yearly strips. The set of strips a market may support must ensure that orders are submitted for non-partially overlapping intervals. These constraints require that strips either be sub-periods of another strip or compliment the strip. An example of two strips, which cannot co-exist in the same market, are the weekly strip and the monthly strip. This is because not all weeks are sub-periods of any one month.

A lot is the quantity in multiples of which an order must be contracted.

A basic function of a market segment is to match buy and sell orders at a single price. Certain embodiments of the invention will satisfy differing rules established for different markets belonging to different regulatory regions regarding that matching process. By way of example, in a bid-ask market, an incoming buy/sell order is immediately matched with the best buy/sell order standing in the market with the trade price as the limit price of the standing order.

In a call-auction market, buy and sell orders are collected together in a batch and matched sometime after they have been submitted. All orders in the batch are traded at the same price, which is calculated based upon the limit prices of all orders in the batch.

FIG. 3D depicts a macro market interval 1500 for a fungible, ephemeral commodity from FIG. 3A.

The invention also comprises a method of a certified client interactively using a transaction system supporting transactions involving at least one fungible, ephemeral commodity.

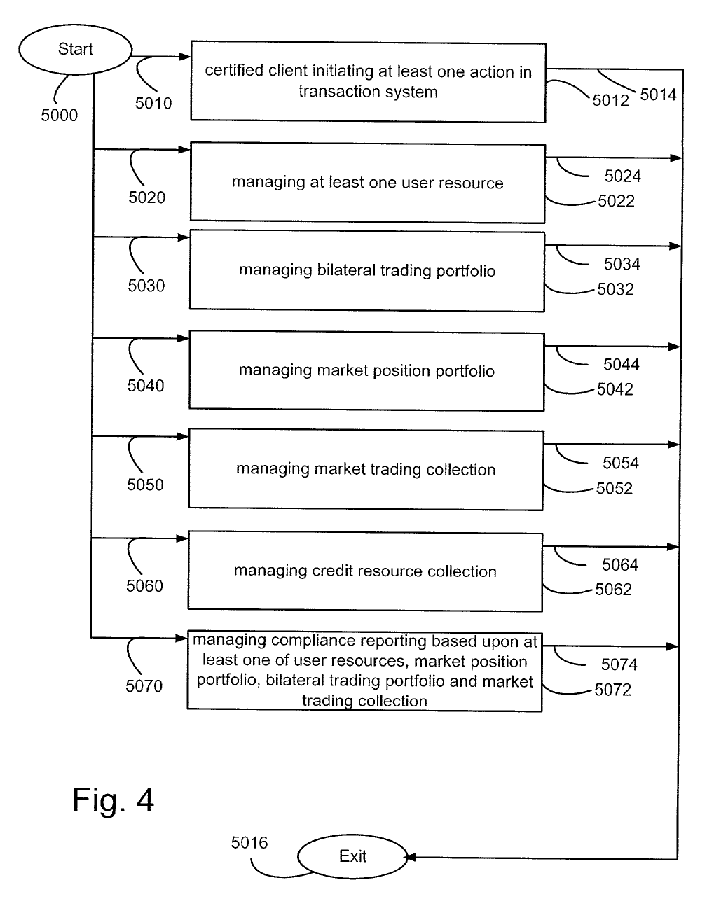

FIG. 4 depicts a detail flowchart of operation 5000 of FIG. 2A-2E for method of a certified client interactively using a transaction system supporting transactions involving at least one fungible, ephemeral commodity.

Arrow 5010 directs the flow of execution from starting operation 5000 to operation 5012. Operation 5012 performs the certified client initiating at least one action in the transaction system. Arrow 5014 directs execution from operation 5012 to operation 5016. Operation 5016 terminates the operations of this flowchart.

The method is further comprised of at least two of the following operations belonging to the basic usage collection.

Arrow 5020 directs the flow of execution from starting operation 5000 to operation 5022. Operation 5022 performs managing at least one user resource. Arrow 5024 directs execution from operation 5022 to operation 5016. Operation 5016 terminates the operations of this flowchart.

Arrow 5030 directs the flow of execution from starting operation 5000 to operation 5032. Operation 5032 performs managing a bilateral trading portfolio comprising at least one bilateral trade in at least one of the fungible, ephemeral commodities. Arrow 5034 directs execution from operation 5032 to operation 5016. Operation 5016 terminates the operations of this flowchart.

Arrow 5040 directs the flow of execution from starting operation 5000 to operation 5042. Operation 5042 performs managing a market position portfolio comprising at least one market position of at least one of the fungible, ephemeral commodities. Arrow 5044 directs execution from operation 5042 to operation 5016. Operation 5016 terminates the operations of this flowchart.

Arrow 5050 directs the flow of execution from starting operation 5000 to operation 5052. Operation 5052 performs managing a market trading is collection comprising at least one market trade in at least one of the fungible, ephemeral commodities. Arrow 5054 directs execution from operation 5052 to operation 5016. Operation 5016 terminates the operations of this flowchart.

Arrow 5060 directs the flow of execution from starting operation 5000 to operation 5062. Operation 5062 performs managing a credit resource collection comprising at least one credit resource. Arrow 5064 directs execution from operation 5062 to operation 5016. Operation 5016 terminates the operations of this flowchart.

Arrow 5070 directs the flow of execution from starting operation 5000 to operation 5072. Operation 5072 performs managing compliance reporting based upon at least one of the collection comprising the user resources, the market position portfolio, the bilateral trading portfolio and the market trading collection. Arrow 5074 directs execution from operation 5072 to operation 5016. Operation 5016 terminates the operations of this flowchart.

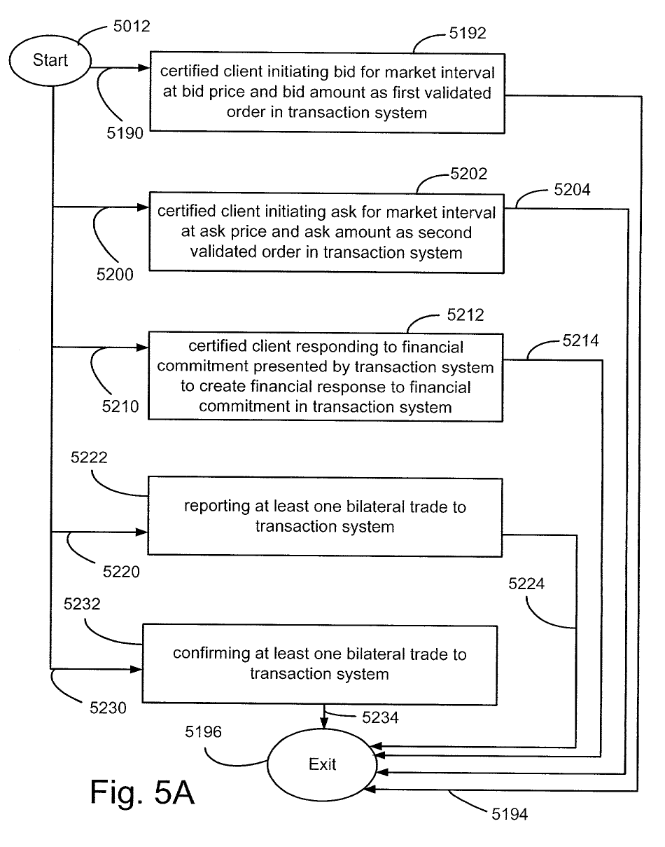

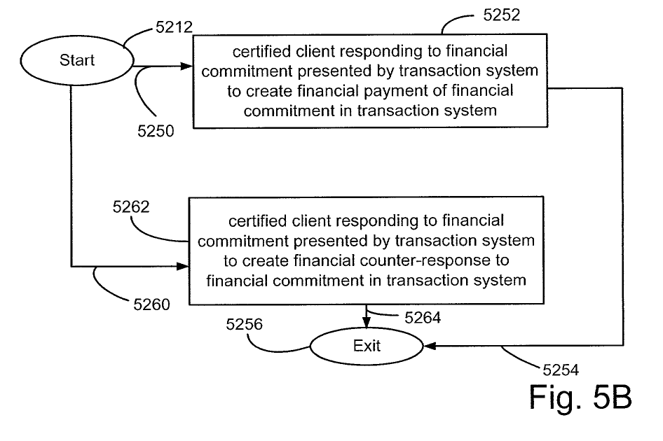

FIG. 5A depicts a detail flowchart of operation 5012 of FIG. 4 for the certified client initiating the action in the transaction system.

Arrow 5190 directs the flow of execution from starting operation 5012 to operation 5192. Operation 5192 performs the certified client initiating a bid for a market interval at a bid price and a bid amount as a first validated order in the transaction system. Arrow 5194 directs execution from operation 5192 to operation 5196. Operation 5196 terminates the operations of this flowchart.

Arrow 5200 directs the flow of execution from starting operation 5012 to operation 5202. Operation 5202 performs the certified client initiating an ask for a market interval at a ask price and a ask amount as a second validated order in the transaction system. Arrow 5204 directs execution from operation 5202 to operation 5196. Operation 5196 terminates the operations of this flowchart.

Arrow 5210 directs the flow of execution from starting operation 5012 to operation 5212. Operation 5212 performs the certified client responding to a financial commitment presented by the transaction system to create a financial response to the financial commitment in the transaction system. Arrow 5214 directs execution from operation 5212 to operation 5196. Operation 5196 terminates the operations of this flowchart.

Arrow 5220 directs the flow of execution from starting operation 5012 to operation 5222. Operation 5222 performs reporting at least one of the bilateral trades to the transaction system. Arrow 5224 directs execution from operation 5222 to operation 5226. Operation 5226 terminates the operations of this flowchart.

Arrow 5230 directs the flow of execution from starting operation 5012 to operation 5232. Operation 5232 performs confirming at least one of the bilateral trades to the transaction system. Arrow 5234 directs execution from operation 5232 to operation 5226. Operation 5226 terminates the operations of this flowchart.

FIG. 5B depicts a detail flowchart of operation 5212 of FIG. 5A for the certified client responding to the financial commitment presented by the transaction system.

Arrow 5250 directs the flow of execution from starting operation 5212 to operation 5252. Operation 5252 performs the certified client responding to the financial commitment presented by the transaction system to create a financial payment of the financial commitment in the transaction system. Arrow 5254 directs execution from operation 5252 to operation 5256. Operation 5256 terminates the operations of this flowchart.

Arrow 5260 directs the flow of execution from starting operation 5212 to operation 5262. Operation 5262 performs the certified client responding to the financial commitment presented by the transaction system to create a financial counter-response to the financial commitment in the transaction system. Arrow 5264 directs execution from operation 5262 to operation 5256. Operation 5256 terminates the operations of this flowchart.

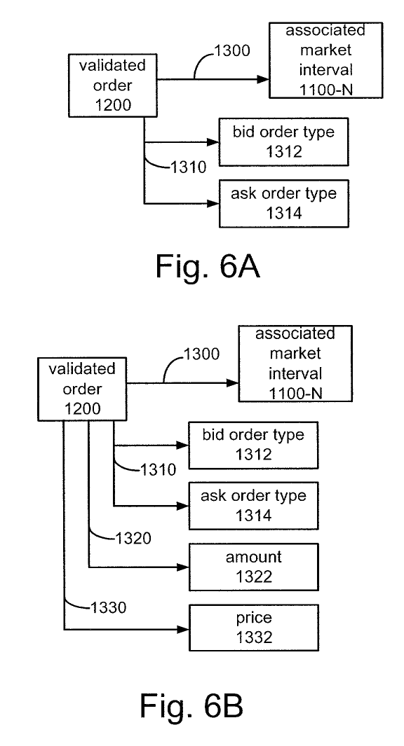

FIG. 6A depicts a validated order 1200 of the validated order collection.

Validated order 1200 has an associated 1300 market interval 1100-N of the market interval collection. The market interval collection is separately maintained in certain embodiments of the invention. Maintaining the validated order collection and market interval collections may be coupled.

Each validated order 1200 further contains a member of the order type collection 1310 which is either a bid order 1312 of the associated 1300 market interval 1100-N or an ask validated order 1314 of the associated 1300 market interval 1100-N.

FIG. 6B depicts a refinement of FIG. 6A of a validated order 1200 of the validated order collection.

As depicted in FIG. 6A, validated order 1200 has an associated 1300 market interval 1100-N of the market interval collection. The market interval collection is separately maintained in certain embodiments of the invention. Maintaining the validated order collection and market interval collections may be coupled.

As depicted in FIG. 6A, each validated order 1200 further contains a member of the order type collection 1310 which is either a bid order 1312 of the associated 1300 market interval 1100-N or an ask validated order 1314 of the associated 1300 market interval 1100-N.

A validated order may contain 1320 an amount 1322 of the product type 1110-N of the associated 1300 market interval 1100-N.

A validated order may contain 1330 a price 1332 of the product type 1110-N of the associated 1300 market interval 1100-N.

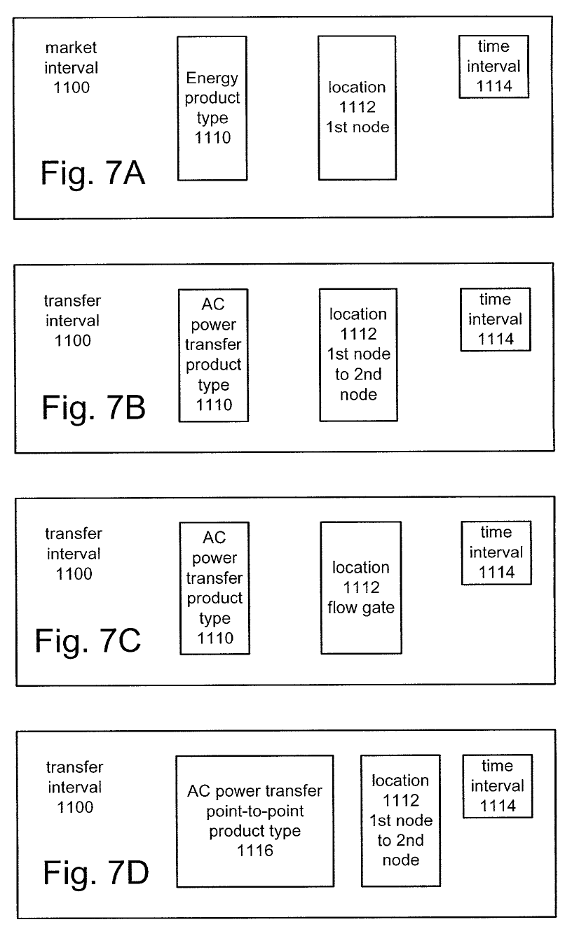

FIG. 7A depicts a refinement of FIG. 3B of a market interval of an energy product type. The product type 1110 of the market interval is further described as an energy product type 1110. The location 1112 is a first node of an AC power network contained in the electrical power grid.

FIG. 7B depicts a refinement of FIG. 3B of a market interval of an AC power transfer product type. The product type 1110 of the market interval is further described as an Energy product type 1110. The location 1112 is from a first node of a first AC power network contained in the electrical power grid to a second node of the first AC power network. Note that this form of location represents a transmission between the first node of the first AC power network and the second node of the first AC power network.

FIG. 7C depicts a refinement of FIG. 7B of a market interval of an AC power transfer product type. The product type 1110 of the market interval is described as an Energy product type 1110. The location 1112 is a flowgate of the flowgate collection of a first AC power network contained in the electrical power grid. Note that flowgates can represent a congestion constraint across more than one transmission line, and may not have a specific first node to second node description.

Such embodiments of the invention of a flowgate market interval are advantageous in providing a market to trade transfer capability between users. Because of the linear nature of AC power transfer throughout an AC power network, these transfer rights can be linearly accumulated to insure the contracted transfers are physically feasible in satisfying the overall flowgate constraints of the AC power network.

FIG. 7D depicts a refinement of FIGS. 7B and 7C of a market interval of an AC power transfer point-to-point product type. The product type 1116 of the market interval is a refinement of the AC power product type 1110 as depicted in FIG. 7B. The product type 1116 of the market interval is further described as an Energy product type 1110. The location 1112 is from a first node of a first AC power network contained in the electrical power grid to a second node of the first AC power network.

Note that as in FIG. 7B, this form of location represents a transmission between the first node of the first AC power network and the second node of the first AC power network. However, a market interval for an AC power transfer point-to-point product type further possesses all the ancillary flowgate transmission rights required for the power transmission from the first node to the second node of the AC power network.

Such market intervals support trading in bundles of flowgates rights as point-to-point rights. From a user perspective, point to point rights are what the market participants really want to buy and sell. They are much simpler to deal with and comprehend than flowgate rights.

In terms of maintaining market liquidity, participants should be very comfortable posting bids and offers for point-to-point AC power transfer rights, since they constitute complete products from a participant perspective.

Bids for AC power transfer point-to-point market intervals are comprised of bids for at least one flowgate transmission right sharing the same location. Bids for AC power transfer point-to-point market intervals may further comprise bids for each of the flowgates of the flowgate collection sharing the same location. Bids for AC power transfer point-to-point market intervals may further comprise transmission rights for at least one flowgate with differing location. This advantageously supports creating transmissions canceling adverse effects on one or more flowgates.

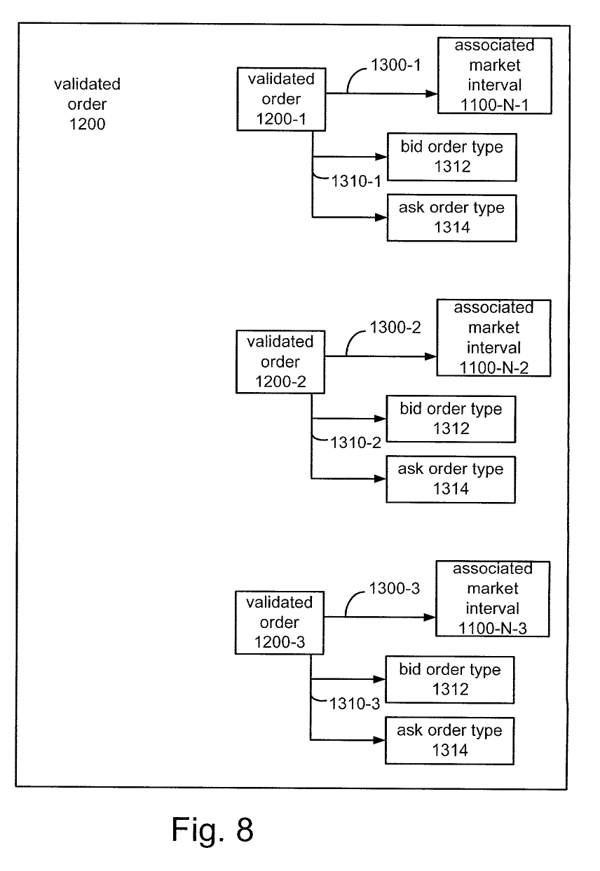

FIG. 8 depicts a validated order 1200 comprised of at least two validated orders, each with an associated market interval.

Validated order 1200-1 has an associated 1300-1 market interval 1100-N-1 of the market interval collection. Validated order 1200-1 further contains a member of the order type collection 1310-1 which is either a bid order 1312 of the associated 1300 market interval 1100-N-1 or an ask validated order 1314 is of the associated 1300 market interval 1100-N-1.

Validated order 1200-2 has an associated 1300-2 market interval 1100-N-2 of the market interval collection. Validated order 1200-2 further contains a member of the order type collection 1310-2 which is either a bid order 1312 of the associated 1300 market interval 1100-N-2 or an ask validated order 1314 of the associated 1300 market interval 1100-N-2.

Validated order 1200-3 has an associated 1300-3 market interval 1100-N-3 of the market interval collection. Validated order 1200-3 further contains a member of the order type collection 1310-3 which is either a bid order 1312 of the associated 1300 market interval 1100-N-3 or an ask validated order 1314 of the associated 1300 market interval 1100-N-3.

There may be no specific limit to the number of validated orders comprising a validated order. There may be a limit to the number of validated orders comprising a validated order.

The associated market intervals of multiple validated orders within a validated order may share the same product type. The associated market intervals of multiple validated orders within a validated order may share the same location.

The associated market intervals of multiple validated orders within a validated order may differ in product type. The associated market intervals of multiple validated orders within a validated order may differ in location.

As discussed in the background, the physics of AC power networks indicates each AC power network contained in the electrical power grid further contains a flowgate collection of flowgates. Each flowgate location being either from an associated first node of the AC power network to an associated second node of the AC power network, or in the case of a collection of constrained transmission lines, will be denoted by a flowgate designator. An AC power transfer amount from node1 to node2 produces an amount of AC power transfer across the flowgate as essentially an associated linear, skew-symmetric function of the amount from node1 to node2, for each of the flowgates of the flowgate collection. For each of the flowgates of the flowgate collection, there is at least one market interval in the market interval collection of AC power transfer product type with the flowgate location.

Each validated order of the validated order collection with the AC power transfer product type of the associated market interval may further contain an amount. A validated order of AC power transfer product type from the first node to the second node may be further comprised of a validated order of the flowgate associated market interval. The amount ordered for that flowgate is essentially the associated linear, skew-symmetric function of the amount from the first node to the second node, for each of the flowgates of the flowgate collection.

Note that there may be a price associated with each validated order of the AC power transfers of the flowgates. There may be a price associated with the AC power transfer from the first node to the second node.

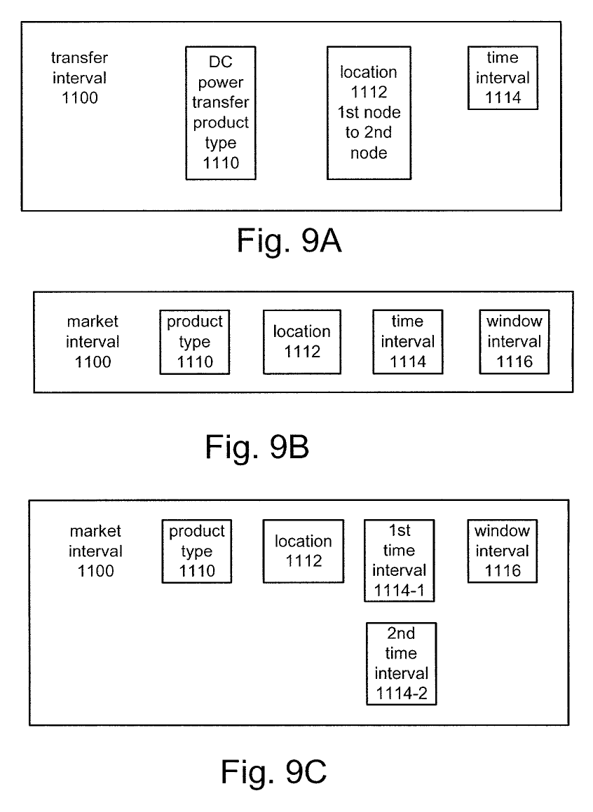

FIG. 9A depicts a market interval of a DC power line. An electrical power grid may further contain a DC power line collection of at least one DC power line at the location of the DC power line from a first node of a first AC power network to a second node of a second AC power network. The product type collection further comprises DC power transfer. For each DC power line of the DC power line collection, there is at least one associated market interval with DC power transfer product type, with the location as the location of the DC power line.

FIG. 9B depicts market interval 1100 of FIG. 3B further containing a window time interval during which the market interval is active only within the window time interval. The window time interval of the market interval entirely occurs before the time interval contained in the market interval for each market interval.

FIG. 9C depicts market interval 1100 of FIG. 9B containing a window time interval and multiple time intervals. Each of the time intervals does not overlap the other time intervals. The window time interval occurs before each of the time intervals.

Note that the invention may comprise managing more than one generator of a fungible, ephemeral commodity. The invention may include managing a first generator of a first fungible, ephemeral commodity and managing a second generator of a second fungible, ephemeral commodity. The invention may also include managing a generator of more than one fungible, ephemeral commodity.

The invention may include managing more than one load consuming a fungible, ephemeral commodity. The invention may include managing a first load consuming a first fungible, ephemeral commodity and managing a second load consuming a second fungible, ephemeral commodity. The invention may also include managing a load consuming more than one fungible, ephemeral commodity.

The invention may include managing more than one import providing a fungible, ephemeral commodity. The invention may include managing a first import providing a first fungible, ephemeral commodity and managing a second import providing a second fungible, ephemeral commodity. The invention may also include managing a import providing more than one fungible, ephemeral commodity.

The invention may include managing more than one export consuming a fungible, ephemeral commodity. The invention may include managing a first export consuming a first fungible, ephemeral commodity and managing a second export consuming a second fungible, ephemeral commodity. The invention may also include managing an export consuming more than one fungible, ephemeral commodity.

As used herein, presenting something to a certified client who is human may include, but is not limited to, visually displaying that something, placing a presentation of that something into a windowing system, which may be directed to display the something by the human and acoustically presenting that something to the certified client.

Presenting something to a certified client operating a computer interacting within the transaction system may further include, but is not limited to, transmitting a presentation of the something to the client computer. The client computer may further receive and process the presentation.

Presenting something to a software agent operating a software agent computer may include, but is not limited to, inserting or adding the processed presentation into a fact database accessible by the software agent.

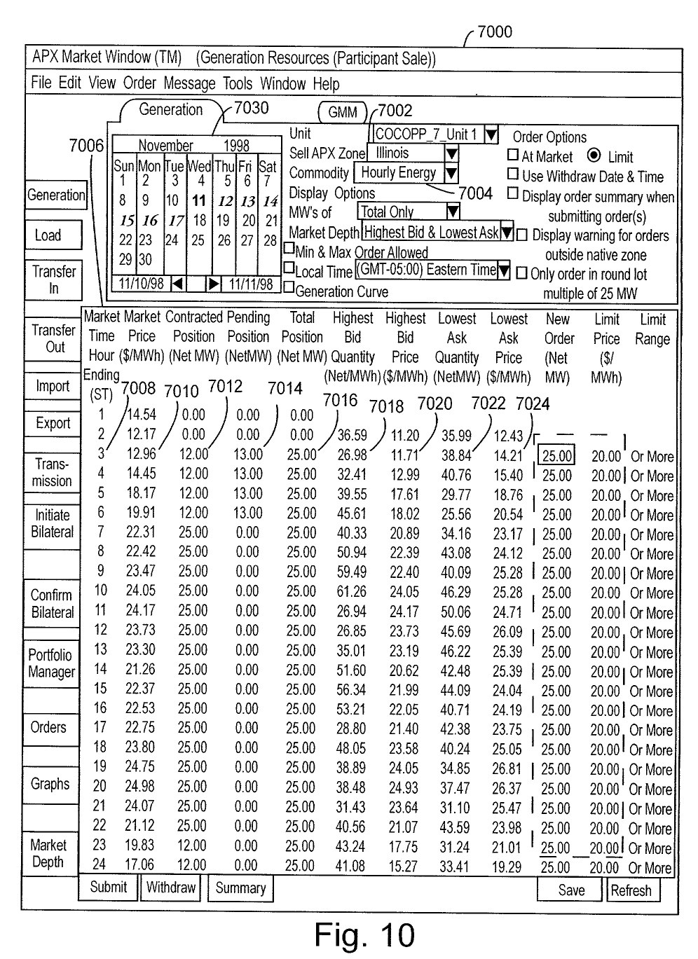

FIG. 10 depicts a view of certified client user interface 7000 showing an ordering screen with hourly time interval based market intervals for a specific energy market.

Note that in FIGS. 10 to 16, which show various views of certified client user interfaces, managing a market trading position portfolio is illustrated based upon the assumption that the certified client is actively trading.

In circumstances where the certified client is not actively trading, as for instance in situations regarding certified clients such as homes, factories and farms consuming and/or generating power below the minimum lot size, minor variants of FIGS. 10 to 16 would show the market position portfolios.

In general, managing a market trading portfolio is similar to managing a market position portfolio with the added capability

Client display screen 7000 may interactively show the market state of a number of related market intervals. Client display screen 7000 may indicate the market state of market intervals sharing the same product type 7004 and location 7002 and for successive time intervals 7008 for Nov. 11, 1998 as indicated by highlighted lettering in calendar 7030.

The column 7006 labeled “Market Time Hour Ending (ST)” has a succession of rows with entries from 1 to 24, indicating the hourly energy markets 7004 in the Illinois sell zone 7002. Consider the row labeled by the hour 7008 ending at “3”. This row displays the market state of the market interval with energy product type, Illinois sell zone location and hour time interval ending at 3:00 for Nov. 11, 1998. The current market price in dollars per megawatt-hour 7010 is “12.96”. The contracted position in net megawatts 7012 is “12.00”. The pending position in net megawatts 7014 is “13.00”. The total position in net megawatts 7016 is “25.00”, which is the sum of the contract and pending positions for that market interval. The highest bid quantity in net megawatts-hours 7018 is “26.98”. The highest bid price in dollars per megawatt-hour 7020 is “11.71”. The highest ask quantity in net megawatts hours 7022 is “38.84”. The highest ask price in dollars per megawatt-hour 7024 is “14.21”.

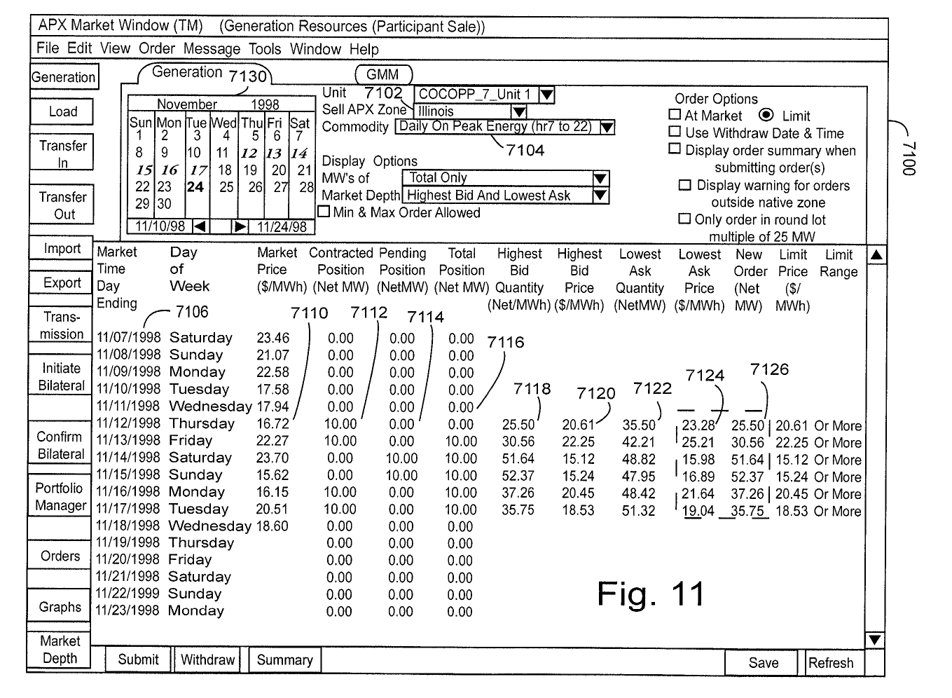

FIG. 11 depicts a view of certified client user interface 7100 showing an ordering screen for daily on-peak time interval based market intervals for a specific energy market.

Client display screen 7100 may interactively show the market state of a number of related market intervals. Client display screen 7100 may indicate the market state of market intervals sharing the same product type 7104 and location 7102 and for successive time intervals 7106 from Nov. 7,1998 to Nov. 24, 1998 as indicated by highlighted lettering in calendar 7130. Consider the row for Nov. 12, 1998.

The column labeled “Market Time Day Ending” has a succession of rows with entries from Nov. 7, 1998 to Nov. 23, 1998, indicating the daily on peak energy markets 7104 in the Illinois sell zone 7102.

The current market price in dollars per megawatt-hour 7110 is “16.72”. The contracted position in net megawatts 7112 is “10.00”. The pending position in net megawatts 7114 is “0.00”. The total position in net megawatts 7116 is “10.00”, which is the sum of the contract and pending positions for that market interval. The highest bid quantity in net megawatts-hours 7118 is “25.50”. The highest bid price in dollars per megawatt-hour 7120 is “20.61”. The lowest ask quantity in net megawatts-hours 7122 is “35.50”. The lowest ask price in dollars per megawatt-hour 7124 is “23.28”.

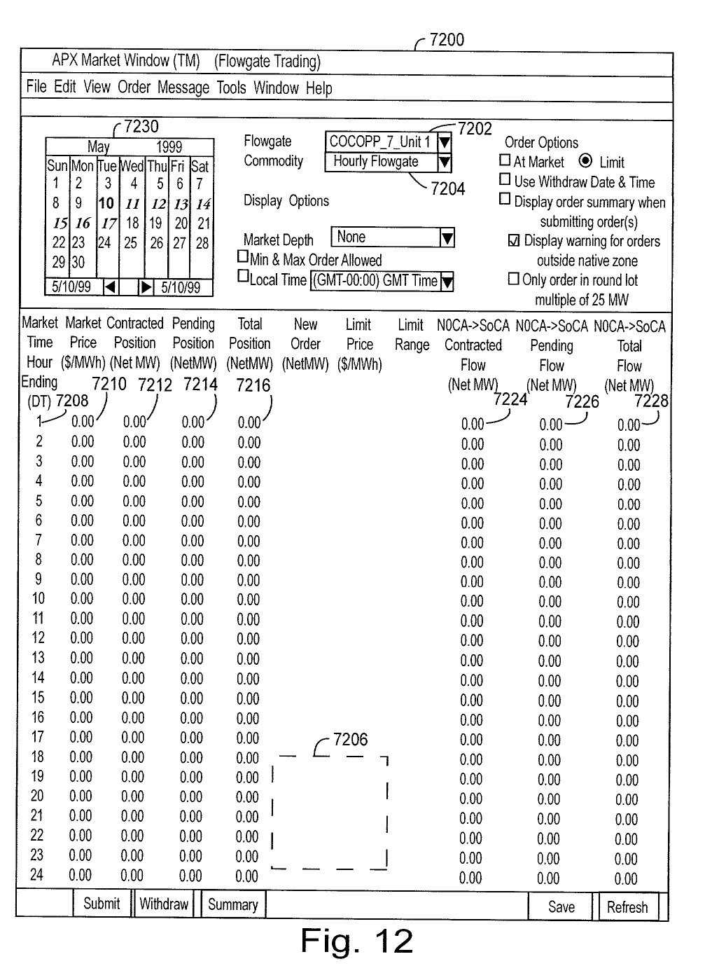

FIG. 12 depicts a view of certified client user interface 7200 showing an ordering screen for hourly time interval based market intervals for a specific flowgate market.

The displayed information 7200 includes a variety of fields, including field 7202, where a specific flowgate or intertie may be selected. Immediately below that field is field 7204 specifying commodity type, in this case, “Hourly Flowgate”. The column indicated by 7210 represents the current market price. The column to its right 7212 indicates the amount of the commodity already awarded. The box 7206 points to two columnar components. The left component represents the bid quantity and the right component represents the bid price per unit quantity on each row. Note that each row represents a distinct market interval, trading independently of the other market intervals.

Client display screen 7200 may show the market state of a number of related market intervals, may indicate the market state of market intervals sharing the same product type 7204 and location 7202 and for successive time intervals for May 10, 1999 as indicated by highlighted lettering in calendar 7230.

The column labeled “Market Time Hour Ending (DT)” 7208 has a succession of rows with entries from 1 to 24, indicating the hourly AC power transfer markets 7204 in the flowgate location “Flowgate_a” 7202. Consider the row labeled by the hour 7208 ending at “1”. This row displays the market state of the market interval with AC power transfer product type, flowgate 7202 location and hour time interval ending at 1:00 for May 10, 1999. The current market price in dollars per megawatt-hour 7210 is “0.00”. The contracted position in net megawatts 7212 is “0.00”. The pending position in net megawatts 7214 is “0.00”. The total position in net megawatts 7216 is “0.00”, which is the sum of the contract and pending positions for that market interval. The contracted flow 7224 is “0.00”. The pending flow 7226 is “0.00”. The total flow 7228 is “0.00”.

The user interface supporting many flowgates may be very similar to FIGS. 10, 11 and 12, with some added features. In the Energy Market screen of FIGS. 10 and 11, there are columns showing the market position in terms of bid and ask summaries.

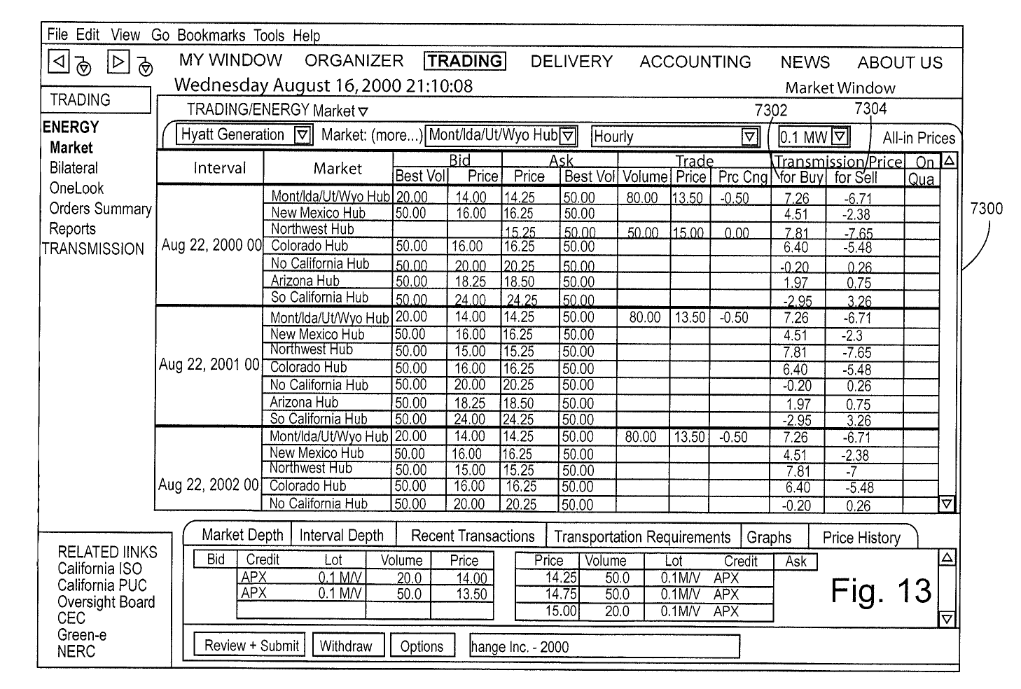

FIG. 13 depicts a view of certified client user interface 7300 showing an ordering screen for hourly time interval based market intervals with respect to a specific facility (“Hyatt Generation”) including energy transmission costs from multiple displayed markets.

The more specific information on energy and transmission prices are available in the tabs at the bottom of the screen. There is an “Interval Depth” tab (which may be called “All Market Depth”) and a “Market Depth” tab (which may be called “Single Market Depth”).

The “Transmission requirements” tab shows the required flowgate transmission rights for a point-to-point transmission from the Hub to the business location.

The column labeled 7302 shows the transmission cost to buy energy at the hub (Market) and transfer it to the business location (Hyatt Generation).

The column labeled 7304 shows the transmission cost to sell energy at the hub (Market) and transfer from the business location (Hyatt Generation). Costs 7302 and/or 7304 may be calculated from current market price of the required flowgate market intervals.

Certain embodiments of the invention include dynamic creation of transmission bids and offers shown in the Energy Market screen. When a participant opens the Energy Market screen for a particular facility, market, strip, and lot size, a signal is sent to the market makers. They may respond with bids and offers tailored for this particular screen. The dynamic capability may be needed because it is not feasible for market makers to continuously post bids and offers between every hub and every facility location.

Certain embodiments include “Transmission from Hub Depth” and “Transmission to Hub Depth” tabs. These tabs may show, in addition to quantity, price, and possibly credit, codes identifying the market maker making the bid or offer. The reason this information is needed is that different market makers may be relying on reconfiguring the same standing bids and offers to create their bids and offers. Hence, if the participant lifts or hits one of these bids or offers, the other market maker will likely withdraw their corresponding bid or offer. When a participant sees similar bids or offers from two different market makers, it is probably only possible to hit or lift one of them. Another way to deal with this problem might be to only display a stack of bids or offers from one market maker at a time—perhaps the one offering the best price.

When the participant enters a buy or sell order in the appropriate columns and presses the “submit” button, the user interface may display the energy order and a listing of all the flowgates and the transmission quantity through the flowgate required to deliver the energy. The user can check off which orders he/she wishes to place. The user may check all items to do a complete “all-in” order.

Alternatively, the invention includes at least one mechanism where most users could avoid any direct dealings in flowgates. The energy order may be displayed, along with a single order to buy (for energy purchases) or sell (for energy sales) transmission in the direction of the energy flow, and another order to sell or buy transmission in the direction against the energy flow. The user may check all three items to do a complete “all-in” order. The user who wished to buy energy and transmission without incurring any obligations would check only the first two lines. Users could do energy only orders by clicking only the first line, or transmission only orders by clicking one or both of the transmission lines.

The advantage of this macromarket trading scheme, is that there is just one transaction including the source generation, transmission rights and destination loading, where applicable, which preferably becomes a single contract. This creates a fundamental simplification in the conceptual effort required to trade energy delivery.

FIG. 14 depicts a view of certified client user interface 7400 showing an ordering screen for hourly time interval based market intervals from a trade book perspective.

Trade books are useful in the preliminary stages of trading energy, when the principal requirement is to create production and load commitments. A trade book has no business location. By way distinction, a facility always has a location.

Many power utility companies, as well as facilities operators employ a trade book approach for initial, relatively time-distant energy trading, and then switch to a facility based energy trading activity as the time approaches when scheduling the energy delivery becomes relevant. Such tasks are often performed by two separate groups of people within such organizations.

Note that the certified client may select various markets and at least the presentation use of the visible columns, which become part of the user view, which can be saved, selected and presented by name, such as “CA Hourly/Daily” in field 7402.

Note that this may effect and/or control the ordering of columns, rows, and/or the sorting of columns and/or rows

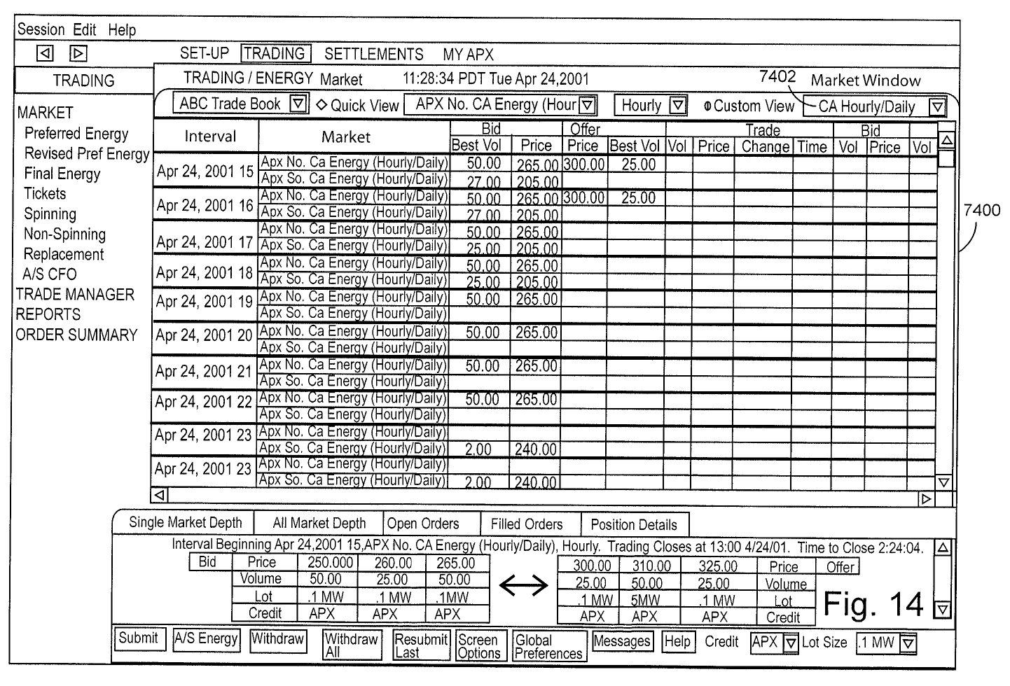

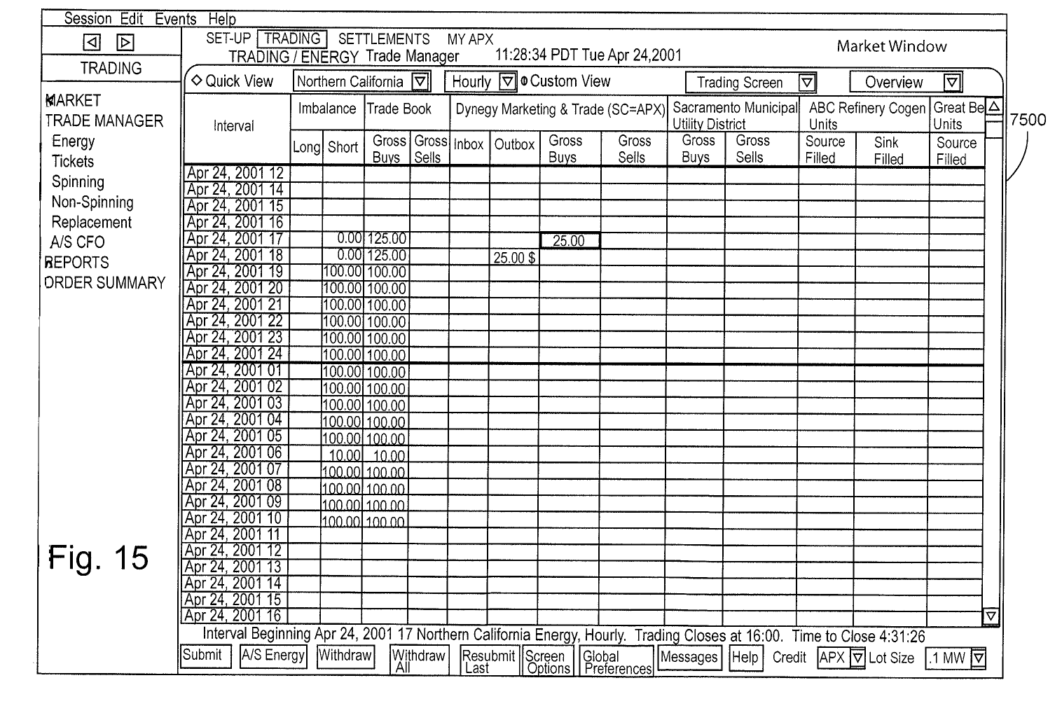

FIG. 15 depicts a view of certified client user interface 7500 showing an overview trading position for specific hours of two successive days including the trade book and a limited number of certified clients.

A certified client may use view 7500 in the scheduling process.

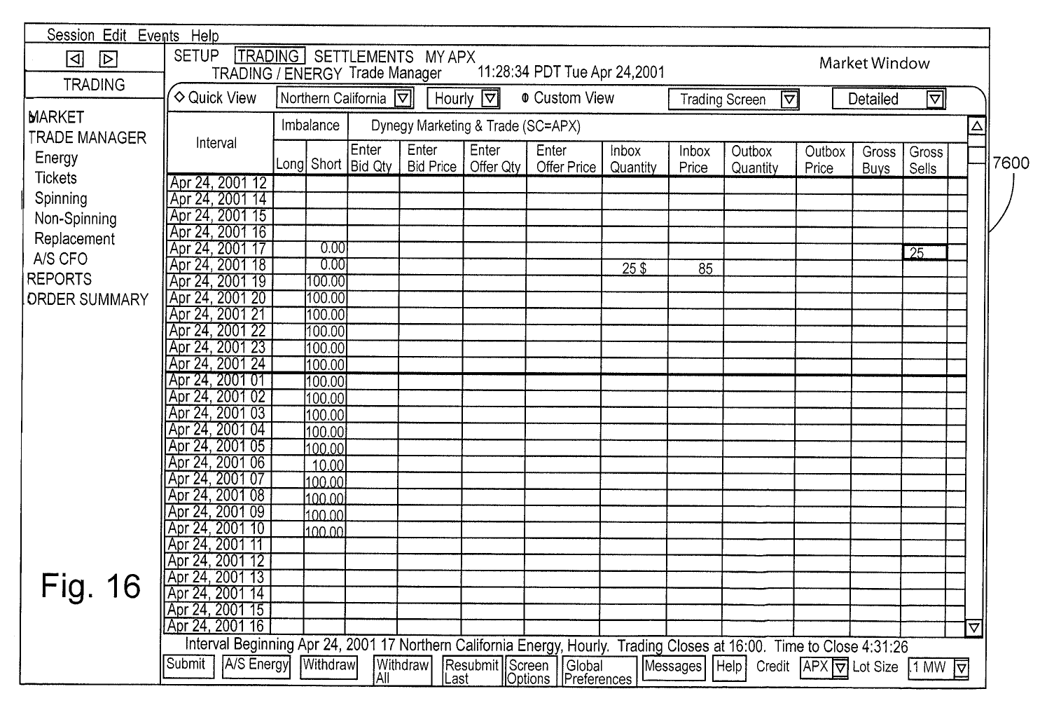

FIG. 16 depicts a detailed view of certified client user interface 7600 showing the trading position for specific hours of two successive days with regards to one certified client based upon FIG. 15.

FIG. 16 is sometimes referred to as a “drill down” from FIG. 15.

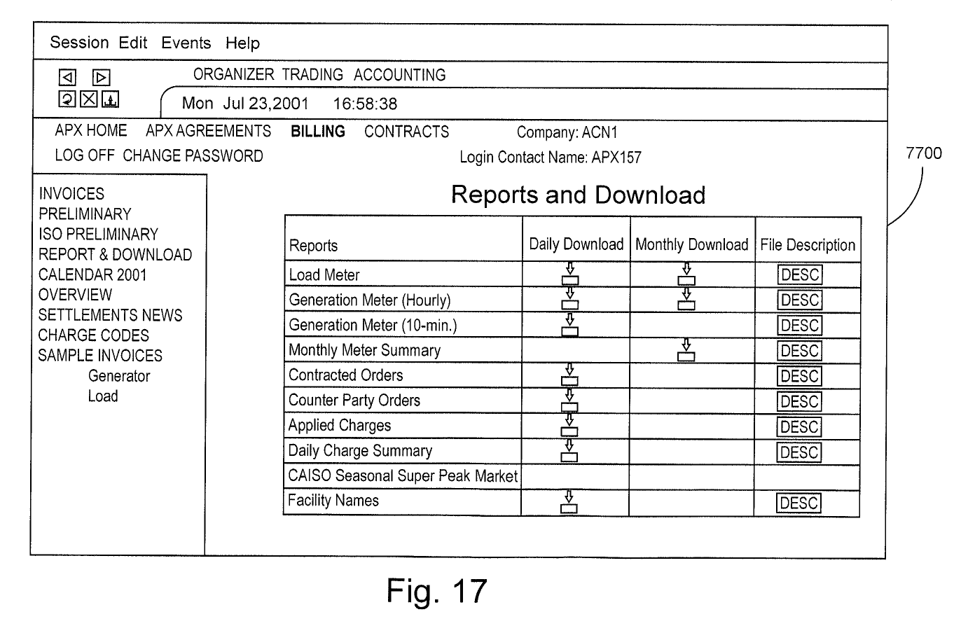

FIG. 17 depicts a view of certified client user interface 7700 providing an overview of the reports on transactions and/or schedules available for presentation to the user.

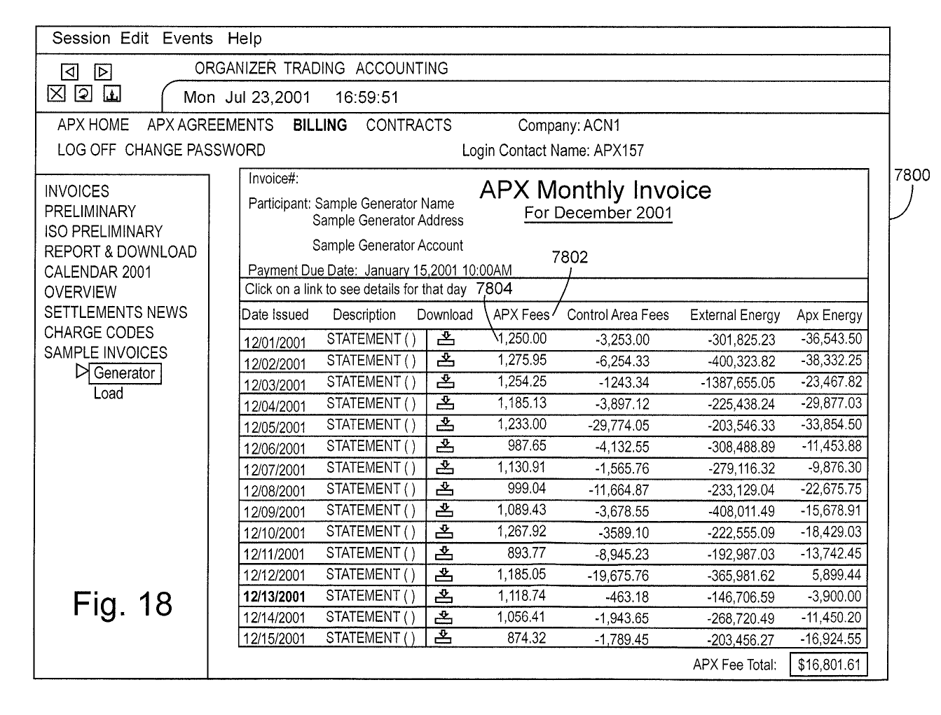

FIG. 18 depicts a view of certified client user interface 7800 providing a detailed view of the monthly invoice for the certified client including fees to the transaction engine service provider, who may be a first party, (APX Fees 7802).

Note individual financial obligations 7804 are shown as owed by the certified client to the first party. Responses to the financial statement include payment of the obligation 7804 to the first party. Such payments are a product of the process of using the transaction system of this invention.

Further note that there are potentially several first parties to whom or from whom moneys may be owed or are owing: A service provider supporting at least some of the operations of FIG. 4 such as APX may be a first party; a regulatory agency may be a first party; A network operator may be a first party; A public utility company; And often at least one other certified client, who performed or received benefit from the performance of a commitment through use of the transaction system, may also be a first party.

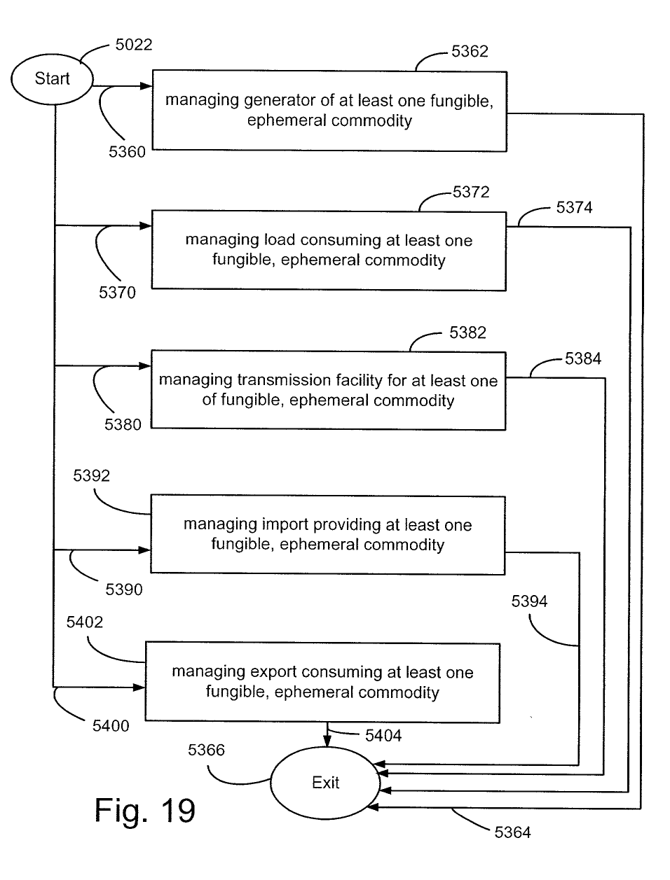

FIG. 19 depicts a detail flowchart of operation 5022 of FIG. 4 for managing the user resource.

Arrow 5360 directs the flow of execution from starting operation 5022 to operation 5362. Operation 5362 performs managing a generator of at least one of the fungible, ephemeral commodities. Arrow 5364 directs execution from operation 5362 to operation 5366. Operation 5366 terminates the operations of this flowchart.

Arrow 5370 directs the flow of execution from starting operation 5022 to operation 5372. Operation 5372 performs managing a load consuming at least one of the fungible, ephemeral commodities. Arrow 5374 directs execution from operation 5372 to operation 5366. Operation 5366 terminates the operations of this flowchart.

Arrow 5380 directs the flow of execution from starting operation 5022 to operation 5382. Operation 5382 performs managing a transmission facility for at least one of the fungible, ephemeral commodities. Arrow 5384 directs execution from operation 5382 to operation 5366. Operation 5366 terminates the operations of this flowchart.

Arrow 5390 directs the flow of execution from starting operation 5022 to operation 5392. Operation 5392 performs managing an import providing at least one of the fungible, ephemeral commodities. Arrow 5394 directs execution from operation 5392 to operation 5366. Operation 5366 terminates the operations of this flowchart.

Arrow 5400 directs the flow of execution from starting operation 5022 to operation 5402. Operation 5402 performs managing an export consuming at least one of the fungible, ephemeral commodities. Arrow 5404 directs execution from operation 5402 to operation 5366. Operation 5366 terminates the operations of this flowchart.

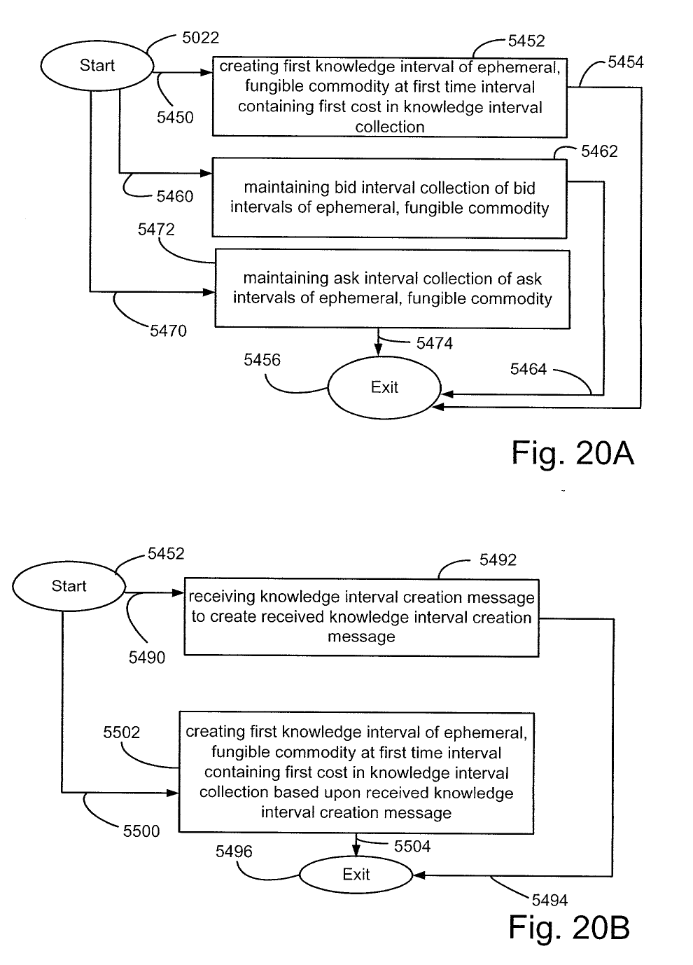

FIG. 20A depicts a detail flowchart of operation 5022 of FIG. 4 for managing the user resource.

Arrow 5450 directs the flow of execution from starting operation 5022 to operation 5452. Operation 5452 performs creating a first knowledge interval of the ephemeral, fungible commodity at a first time interval containing a first cost in the knowledge interval collection. Arrow 5454 directs execution from operation 5452 to operation 5456. Operation 5456 terminates the operations of this flowchart.

Certain embodiments of the invention include at least one of the two following operations.

Arrow 5460 directs the flow of execution from starting operation 5022 to operation 5462. Operation 5462 performs maintaining a bid interval collection of bid intervals of the ephemeral, fungible commodity, each comprised of a bid price, a bid amount, and a bid time interval. Arrow 5464 directs execution from operation 5462 to operation 5456. Operation 5456 terminates the operations of this flowchart.

Arrow 5470 directs the flow of execution from starting operation 5022 to operation 5472. Operation 5472 performs maintaining an ask interval collection of ask intervals of the ephemeral, fungible commodity, each comprised of a ask price, a ask amount, and a ask time interval. Arrow 5474 directs execution from operation 5472 to operation 5456. Operation 5456 terminates the operations of this flowchart.

Note that these bid intervals and ask intervals may be related or the same as the bids and asks initiated by the certified client. Such bids and asks may alternatively be integrated into a market trading portfolio.

FIG. 20B depicts a detail flowchart of operation 5452 of FIG. 20A for creating the first knowledge interval.

Arrow 5490 directs the flow of execution from starting operation 5452 to operation 5492. Operation 5492 performs receiving a knowledge interval creation message to create a received knowledge interval creation message. Arrow 5494 directs execution from operation 5492 to operation 5496. Operation 5496 terminates the operations of this flowchart.

Arrow 5500 directs the flow of execution from starting operation 5452 to operation 5502. Operation 5502 performs creating the first knowledge interval of the ephemeral, fungible commodity at the first time interval containing the first cost in the knowledge interval collection based upon the received knowledge interval creation message. Arrow 5504 directs execution from operation 5502 to operation 5496. Operation 5496 terminates the operations of this flowchart.

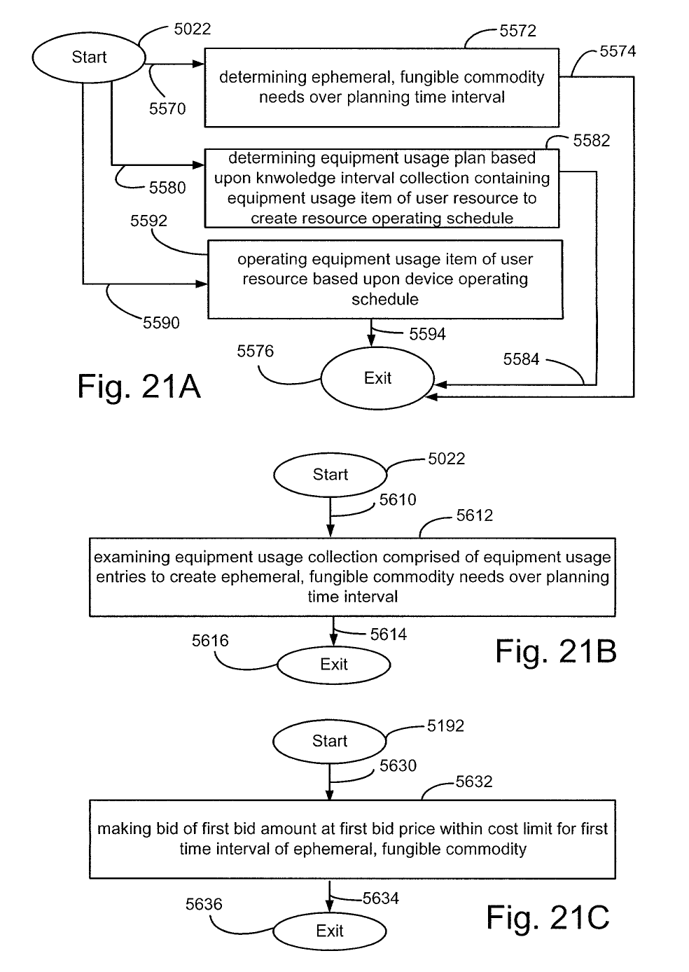

FIG. 21A depicts a detail flowchart of operation 5022 of FIG. 4 for managing the user resource.

Arrow 5570 directs the flow of execution from starting operation 5022 to operation 5572. Operation 5572 performs determining the ephemeral, fungible commodity needs over a planning time interval. Arrow 5574 directs execution from operation 5572 to operation 5576. Operation 5576 terminates the operations of this flowchart.

Arrow 5580 directs the flow of execution from starting operation 5022 to operation 5582. Operation 5582 performs determining an equipment usage plan based upon the knowledge interval collection containing an equipment usage item of the user resource to create a resource operating schedule. Arrow 5584 directs execution from operation 5582 to operation 5576. Operation 5576 terminates the operations of this flowchart.

The equipment usage item of the user resource is comprised of an activation time and an action belonging to an action collection comprising start-action, stop-action and throttle-action.

Arrow 5590 directs the flow of execution from starting operation 5022 to operation 5592. Operation 5592 performs operating the equipment usage item of the user resource based upon the device operating schedule. Arrow 5594 directs execution from operation 5592 to operation 5576. Operation 5576 terminates the operations of this flowchart.

FIG. 21B depicts a detail flowchart of operation 5022 of FIG. 4 for managing the user resource.

Arrow 5610 directs the flow of execution from starting operation 5022 to operation 5612. Operation 5612 performs examining an equipment usage collection comprised of equipment usage entries to create the ephemeral, fungible commodity needs over the planning time interval. Arrow 5614 directs execution from operation 5612 to operation 5616. Operation 5616 terminates the operations of this flowchart.

Each equipment usage entries contains a delivery time and a need schedule for the ephemeral, fungible commodity. The ephemeral, fungible commodity needs over the planning time interval comprise an amount.

The ephemeral, fungible commodity needs over the planning time interval further comprise a cost limit.

FIG. 21C depicts a detail flowchart of operation 5192 of FIG. 5A for the certified client initiating the bid.

Arrow 5630 directs the flow of execution from starting operation 5192 to operation 5632. Operation 5632 performs making the bid of a first bid amount at a first bid price within the cost limit for the first time interval of the ephemeral, fungible commodity. Arrow 5634 directs execution from operation 5632 to operation 5636. Operation 5636 terminates the operations of this flowchart.

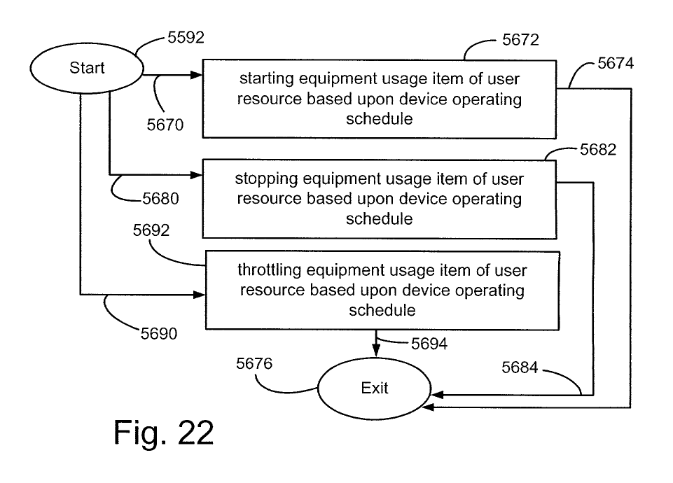

FIG. 22 depicts a detail flowchart of operation 5592 of FIG. 21A for operating the equipment usage item.

Arrow 5670 directs the flow of execution from starting operation 5592 to operation 5672. Operation 5672 performs starting the equipment usage item of the user resource based upon the device operating schedule. Arrow 5674 directs execution from operation 5672 to operation 5676. Operation 5676 terminates the operations of this flowchart.

Arrow 5680 directs the flow of execution from starting operation 5592 to operation 5682. Operation 5682 performs stopping the equipment usage item of the user resource based upon the device operating schedule. Arrow 5684 directs execution from operation 5682 to operation 5676. Operation 5676 terminates the operations of this flowchart.

Arrow 5690 directs the flow of execution from starting operation 5592 to operation 5692. Operation 5692 performs throttling the equipment usage item of the user resource based upon the device operating schedule. Arrow 5694 directs execution from operation 5692 to operation 5676. Operation 5676 terminates the operations of this flowchart.

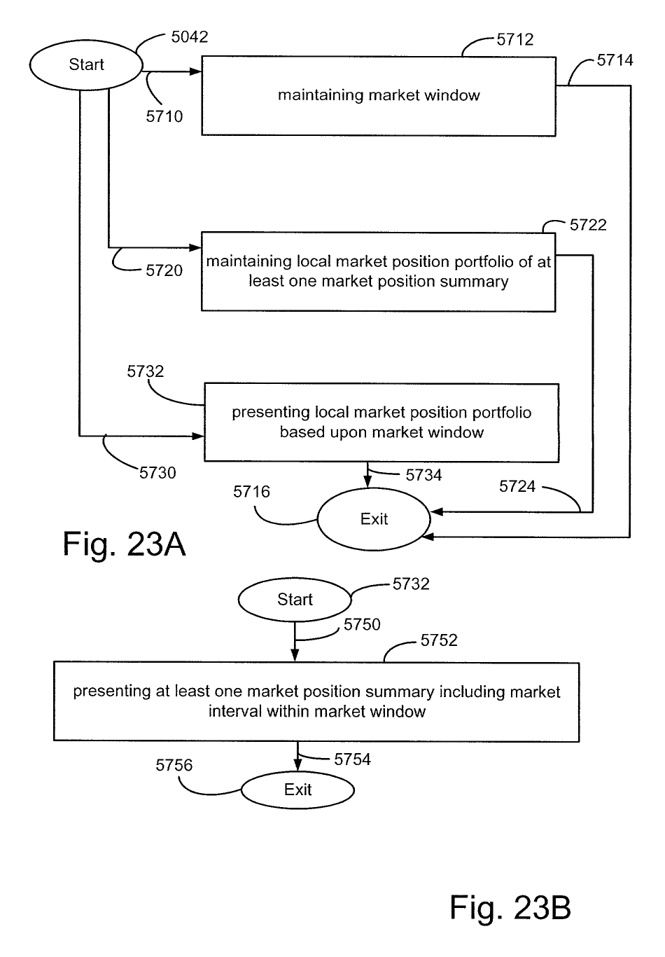

FIG. 23A depicts a detail flowchart of operation 5042 of FIG. 4 for managing the market position portfolio.

Arrow 5710 directs the flow of execution from starting operation 5042 to operation 5712. Operation 5712 performs maintaining a market window. Arrow 5714 directs execution from operation 5712 to operation 5716. Operation 5716 terminates the operations of this flowchart.

Arrow 5720 directs the flow of execution from starting operation 5042 to operation 5722. Operation 5722 performs maintaining a local market position portfolio comprised of at least one market position summary. Arrow 5724 directs execution from operation 5722 to operation 5716. Operation 5716 terminates the operations of this flowchart.

Each of the market position summaries includes a market interval of the fungible, ephemeral commodity within the market window.

Arrow 5730 directs the flow of execution from starting operation 5042 to operation 5732. Operation 5732 performs presenting the local market position portfolio based upon the market window. Arrow 5734 directs execution from operation 5732 to operation 5716. Operation 5716 terminates the operations of this flowchart.

FIG. 23B depicts a detail flowchart of operation 5732 of FIG. 23A for presenting the local market position portfolio.

Arrow 5750 directs the flow of execution from starting operation 5732 to operation 5752. Operation 5752 performs presenting at least one of the market position summaries including the market interval within the market window. Arrow 5754 directs execution from operation 5752 to operation 5756. Operation 5756 terminates the operations of this flowchart.

Note that at least one of the market position summaries of the local market position portfolio may include an amount-held, a current bid summary, a current ask summary, a current market price and a current order summary.

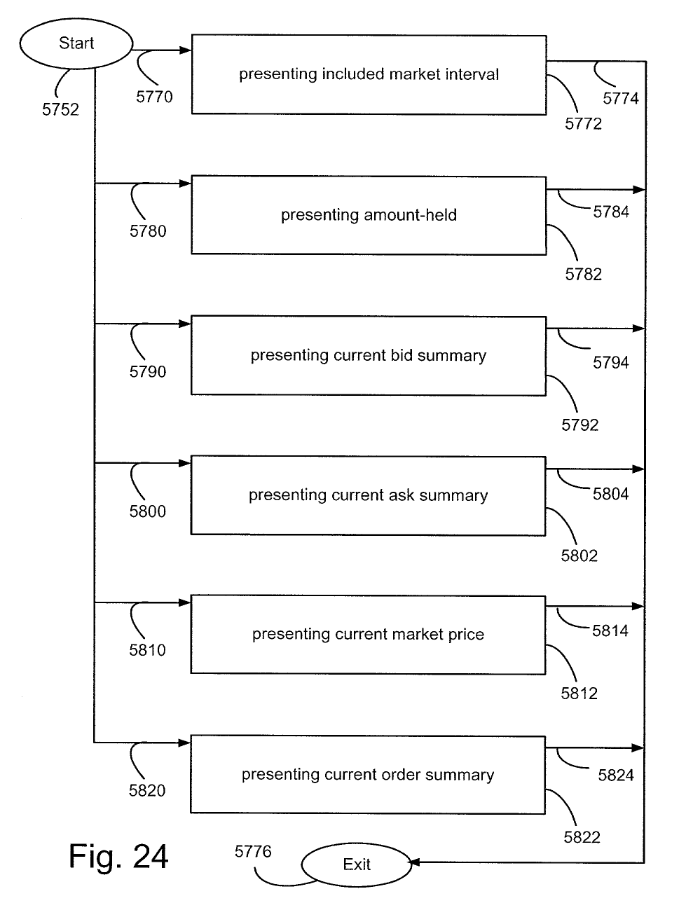

FIG. 24 depicts a detail flowchart of operation 5752 of FIG. 23B for presenting the market position summary.

Arrow 5770 directs the flow of execution from starting operation 5752 to operation 5772. Operation 5772 performs presenting the included market interval. Arrow 5774 directs execution from operation 5772 to operation 5776. Operation 5776 terminates the operations of this flowchart.

Arrow 5780 directs the flow of execution from starting operation 5752 to operation 5782. Operation 5782 performs presenting the amount-held. Arrow 5784 directs execution from operation 5782 to operation 5776. Operation 5776 terminates the operations of this flowchart.

Arrow 5790 directs the flow of execution from starting operation 5752 to operation 5792. Operation 5792 performs presenting the current bid summary. Arrow 5794 directs execution from operation 5792 to operation 5776. Operation 5776 terminates the operations of this flowchart.

Arrow 5800 directs the flow of execution from starting operation 5752 to operation 5802. Operation 5802 performs presenting the current ask summary. Arrow 5804 directs execution from operation 5802 to operation 5776. Operation 5776 terminates the operations of this flowchart.

Arrow 5810 directs the flow of execution from starting operation 5752 to operation 5812. Operation 5812 performs presenting the current market price. Arrow 5814 directs execution from operation 5812 to operation 5776. Operation 5776 terminates the operations of this flowchart.

Arrow 5820 directs the flow of execution from starting operation 5752 to operation 5822. Operation 5822 performs presenting the current order summary. Arrow 5824 directs execution from operation 5822 to operation 5776. Operation 5776 terminates the operations of this flowchart.

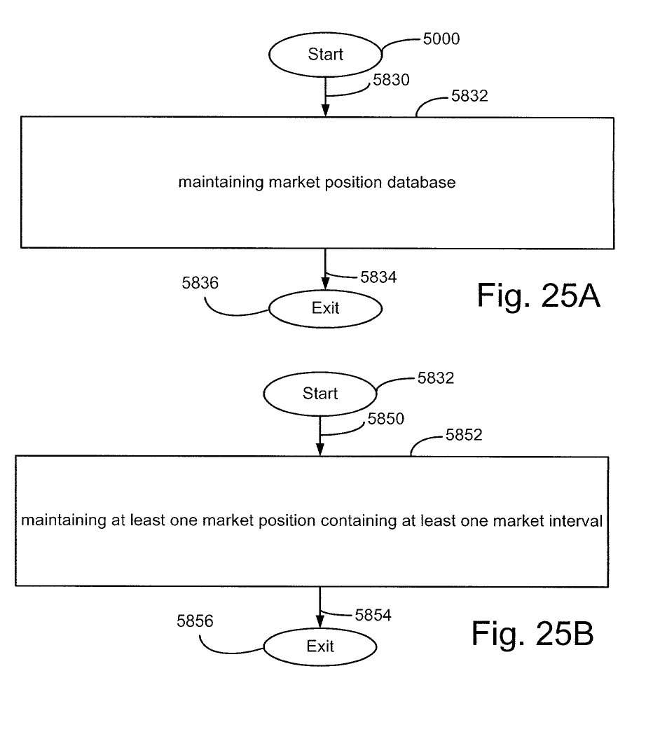

FIG. 25A depicts a detail flowchart of operation 5000 of FIG. 4 for the method of using the transaction system.

Arrow 5830 directs the flow of execution from starting operation 5000 to operation 5832. Operation 5832 performs maintaining a market position database. Arrow 5834 directs execution from operation 5832 to operation 5836. Operation 5836 terminates the operations of this flowchart.

FIG. 25B depicts a detail flowchart of operation 5832 of FIG. 25A for maintaining the market position database.

Arrow 5850 directs the flow of execution from starting operation 5832 to operation 5852. Operation 5852 performs maintaining at least one market position containing at least one of the market intervals. Arrow 5854 directs execution from operation 5852 to operation 5856. Operation 5856 terminates the operations of this flowchart.

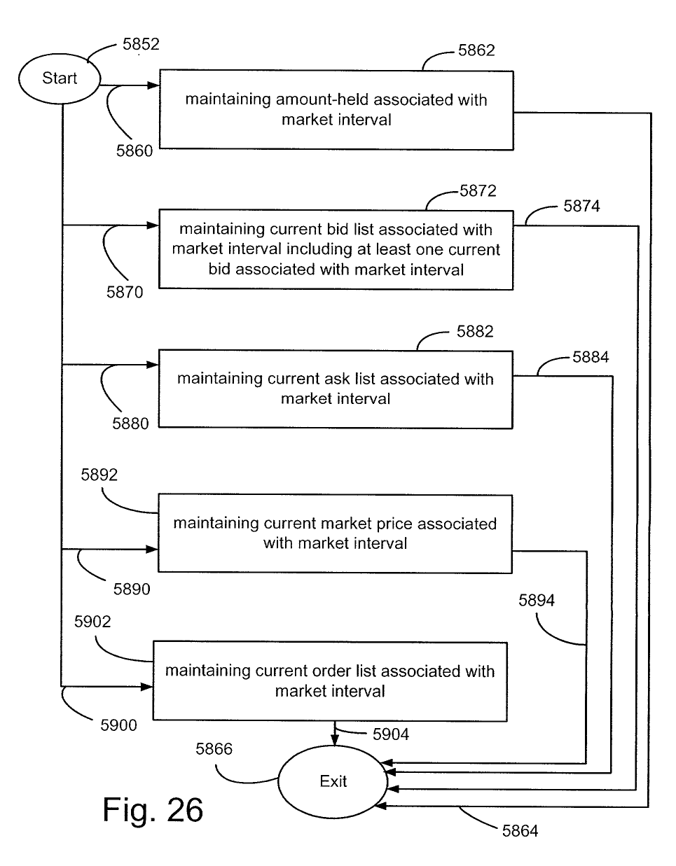

FIG. 26 depicts a detail flowchart of operation 5852 of FIG. 25B for maintaining the market position.

Arrow 5860 directs the flow of execution from starting operation 5852 to operation 5862. Operation 5862 performs maintaining an amount-held associated with the market interval. Arrow 5864 directs execution from operation 5862 to operation 5866. Operation 5866 terminates the operations of this flowchart.

Arrow 5870 directs the flow of execution from starting operation 5852 to operation 5872. Operation 5872 performs maintaining a current bid list associated with the market interval including at least one current bid associated with the market interval. Arrow 5874 directs execution from operation 5872 to operation 5866. Operation 5866 terminates the operations of this flowchart.

Arrow 5880 directs the flow of execution from starting operation 5852 to operation 5882. Operation 5882 performs maintaining a current ask list associated with the market interval including at least one ask associated with the market interval. Arrow 5884 directs execution from operation 5882 to operation 5866. Operation 5866 terminates the operations of this flowchart.

Arrow 5890 directs the flow of execution from starting operation 5852 to operation 5892. Operation 5892 performs maintaining a current market price associated with the market interval. Arrow 5894 directs execution from operation 5892 to operation 5866. Operation 5866 terminates the operations of this flowchart.

Arrow 5900 directs the flow of execution from starting operation 5852 to operation 5902. Operation 5902 performs maintaining a current order list associated with the market interval. Arrow 5904 directs execution from operation 5902 to operation 5866. Operation 5866 terminates the operations of this flowchart.

Certain embodiments of the invention support at least one of the operations of FIG. 26.

Note that at least one of the market intervals contains an AC power transfer product type as the fungible, ephemeral commodity and contains the location as a first of the nodes directed to a second of the nodes of the AC power network node collection.

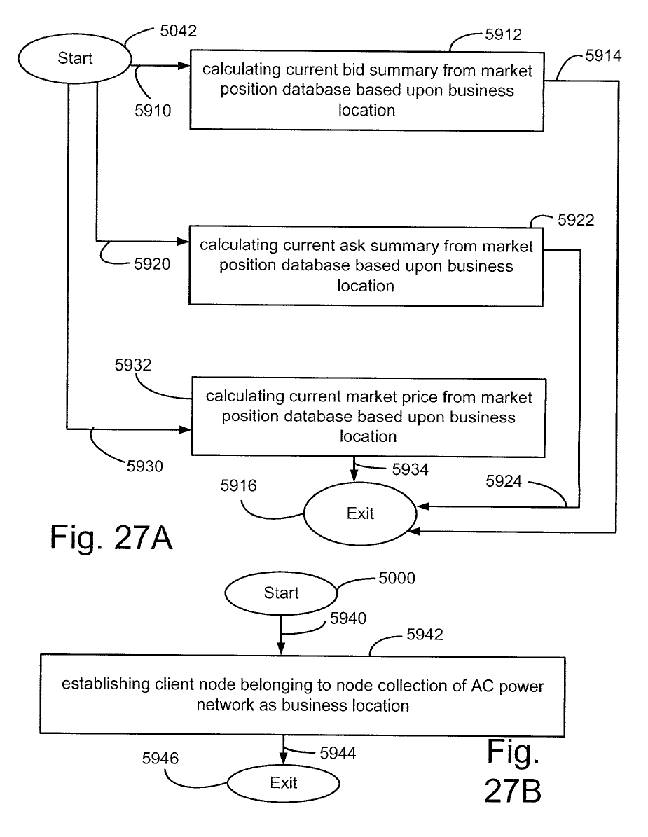

FIG. 27A depicts a detail flowchart of operation 5042 of FIG. 4 for maintaining the local market position portfolio.

Arrow 5910 directs the flow of execution from starting operation 5042 to operation 5912. Operation 5912 performs calculating the current bid summary from the market position database based upon the business location. Arrow 5914 directs execution from operation 5912 to operation 5916. Operation 5916 terminates the operations of this flowchart.

Arrow 5920 directs the flow of execution from starting operation 5042 to operation 5922. Operation 5922 performs calculating the current ask summary from the market position database based upon the business location. Arrow 5924 directs execution from operation 5922 to operation 5916. Operation 5916 terminates the operations of this flowchart.

Arrow 5930 directs the flow of execution from starting operation 5042 to operation 5932. Operation 5932 performs calculating the current market price from the market position database based upon the business location. Arrow 5934 directs execution from operation 5932 to operation 5916. Operation 5916 terminates the operations of this flowchart.

FIG. 27B depicts a detail flowchart of operation 5000 of FIG. 2A-2E for the method of using the transaction system.

Arrow 5940 directs the flow of execution from starting operation 5000 to operation 5942. Operation 5942 performs establishing a client node belonging to the node collection of the AC power network as the business location. Arrow 5944 directs execution from operation 5942 to operation 5946. Operation 5946 terminates the operations of this flowchart.

Note that the operations of FIG. 27A may each be further based upon the flowgate collection.

The market interval may contain the AC power transfer product type as the fungible, ephemeral commodity and further, the market interval may contain an AC power transfer point-to-point product type as the fungible, ephemeral commodity.

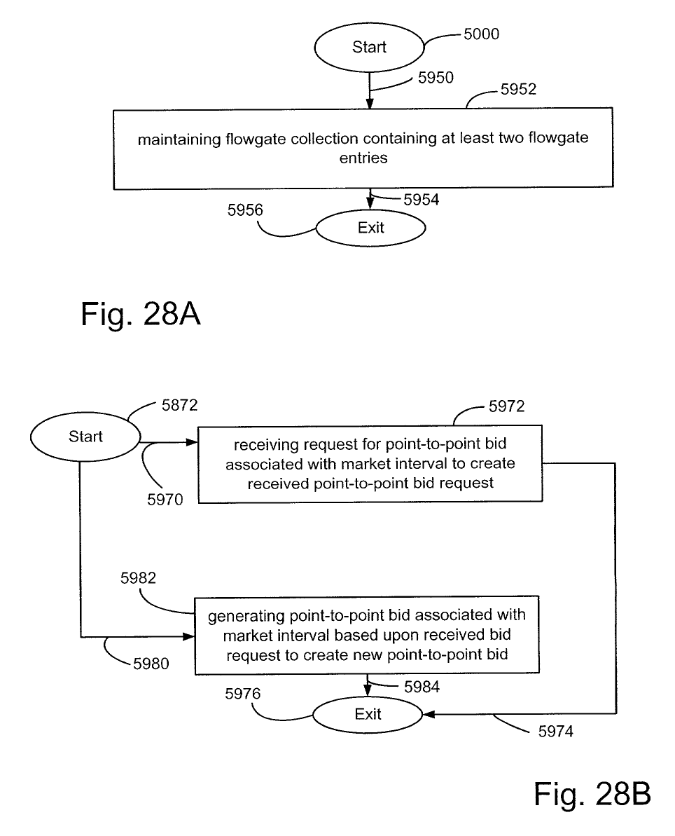

FIG. 28A depicts a detail flowchart of operation 5000 of FIG. 2A-2E for the method of using the transaction system.

Arrow 5950 directs the flow of execution from starting operation 5000 to operation 5952. Operation 5952 performs maintaining a flowgate collection containing at least two flowgate entries. Arrow 5954 directs execution from operation 5952 to operation 5956. Operation 5956 terminates the operations of this flowchart.

Each flowgate entry contained in the flowgate collection may include a factor, a from-node of the node collection and a to-node of the node collection.

For each of the flowgate entries contained in the flowgate collection, at least one of the market intervals contains the AC power transfer product type as the fungible, ephemeral commodity and the location coinciding with the flowgate entry.

Note that as new transmission resources become available, the flowgate collection may be altered. Note also that if transmission resources become damaged, as for instance may result from a hurricane, the flowgate collection may also be altered.

FIG. 28B depicts a detail flowchart of operation 5872 of FIG. 26 for maintaining the current bid list.

Arrow 5970 directs the flow of execution from starting operation 5872 to operation 5972. Operation 5972 performs receiving a request for a point-to-point bid associated with the market interval to create a received point-to-point bid request. Arrow 5974 directs execution from operation 5972 to operation 5976. Operation 5976 terminates the operations of this flowchart.

Arrow 5980 directs the flow of execution from starting operation 5872 to operation 5982. Operation 5982 performs generating a point-to-point bid associated with the market interval based upon the received bid request to create a new point-to-point bid associated with the market interval. Arrow 5984 directs execution from operation 5982 to operation 5976. Operation 5976 terminates the operations of this flowchart.

Note that certified client market makers 1440 may actively use the operations of FIG. 28B.

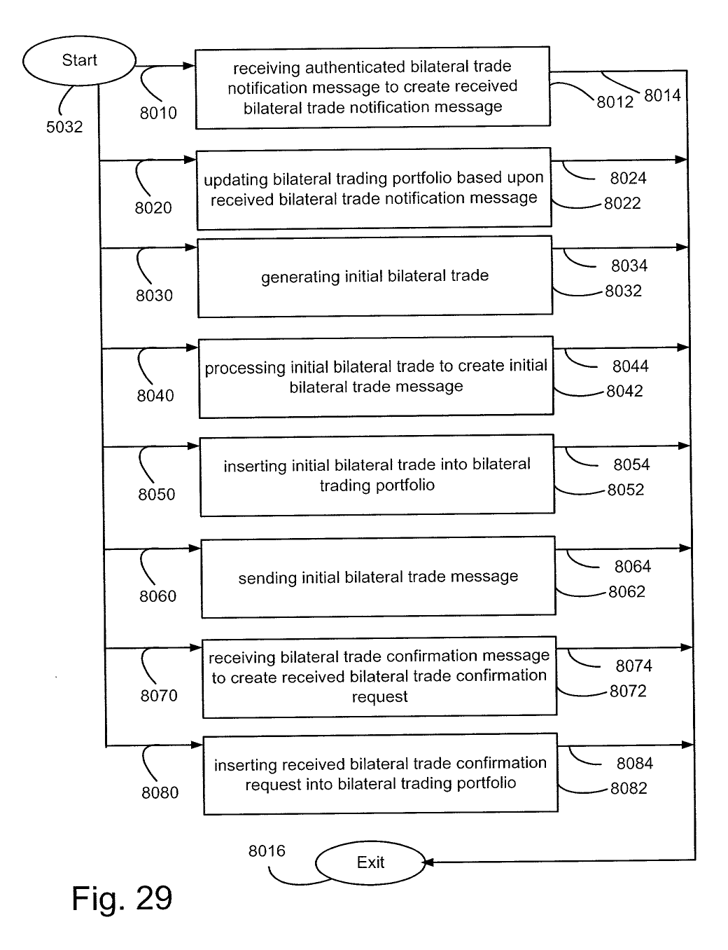

FIG. 29 depicts a detail flowchart of operation 5032 of FIG. 4 for managing the bilateral trading portfolio.

Arrow 8010 directs the flow of execution from starting operation 5032 to operation 8012. Operation 8012 performs receiving an authenticated bilateral trade notification message to create a received bilateral trade notification message. Arrow 8014 directs execution from operation 8012 to operation 8016. Operation 8016 terminates the operations of this flowchart.

Arrow 8020 directs the flow of execution from starting operation 5032 to operation 8022. Operation 8022 performs updating the bilateral trading portfolio based upon the received bilateral trade notification message. Arrow 8024 directs execution from operation 8022 to operation 8016. Operation 8016 terminates the operations of this flowchart.

Arrow 8030 directs the flow of execution from starting operation 5032 to operation 8032. Operation 8032 performs generating an initial bilateral trade. Arrow 8034 directs execution from operation 8032 to operation 8016. Operation 8016 terminates the operations of this flowchart.

Arrow 8040 directs the flow of execution from starting operation 5032 to operation 8042. Operation 8042 performs processing the initial bilateral trade to create an initial bilateral trade message. Arrow 8044 directs execution from operation 8042 to operation 8016. Operation 8016 terminates the operations of this flowchart.

Arrow 8050 directs the flow of execution from starting operation 5032 to operation 8052. Operation 8052 performs inserting the initial bilateral trade into the bilateral trading portfolio. Arrow 8054 directs execution from operation 8052 to operation 8016. Operation 8016 terminates the operations of this flowchart.

Arrow 8060 directs the flow of execution from starting operation 5032 to operation 8062. Operation 8062 performs sending the initial bilateral trade message. Arrow 8064 directs execution from operation 8062 to operation 8016. Operation 8016 terminates the operations of this flowchart.

Arrow 8070 directs the flow of execution from starting operation 5032 to operation 8072. Operation 8072 performs receiving a bilateral trade confirmation message to create a received bilateral trade confirmation request. Arrow 8074 directs execution from operation 8072 to operation 8016. Operation 8016 terminates the operations of this flowchart.

Arrow 8080 directs the flow of execution from starting operation 5032 to operation 8082. Operation 8082 performs inserting the received bilateral trade confirmation request into the bilateral trading portfolio. Arrow 8084 directs execution from operation 8082 to operation 8016. Operation 8016 terminates the operations of this flowchart.

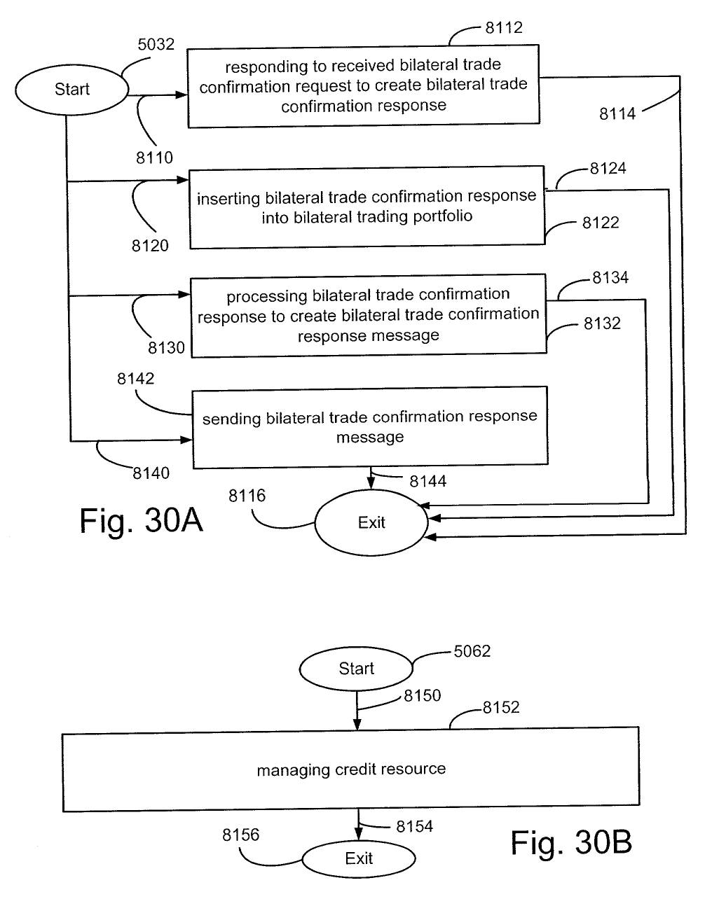

FIG. 30A depicts a detail flowchart of operation 5032 of FIG. 4 for managing the bilateral trading portfolio.

Arrow 8110 directs the flow of execution from starting operation 5032 to operation 8112. Operation 8112 performs responding to the received bilateral trade confirmation request to create a bilateral trade confirmation response.

Arrow 8114 directs execution from operation 8112 to operation 8116. Operation 8116 terminates the operations of this flowchart.

Arrow 8120 directs the flow of execution from starting operation 5032 to operation 8122. Operation 8122 performs inserting the bilateral trade confirmation response into the bilateral trading portfolio. Arrow 8124 directs execution from operation 8122 to operation 8116. Operation 8116 terminates the operations of this flowchart.

Arrow 8130 directs the flow of execution from starting operation 5032 to operation 8132. Operation 8132 performs processing the bilateral trade confirmation response to create a bilateral trade confirmation response message. Arrow 8134 directs execution from operation 8132 to operation 8116. Operation 8116 terminates the operations of this flowchart.

Arrow 8140 directs the flow of execution from starting operation 5032 to operation 8142. Operation 8142 performs sending the bilateral trade confirmation response message. Arrow 8144 directs execution from operation 8142 to operation 8116. Operation 8116 terminates the operations of this flowchart.

FIG. 30B depicts a detail flowchart of operation 5062 of FIG. 4 for managing the credit resource collection, for each of the credit resources of the credit resource collection.

Arrow 8150 directs the flow of execution from starting operation 5062 to operation 8152. Operation 8152 performs managing the credit resource. Arrow 8154 directs execution from operation 8152 to operation 8156. Operation 8156 terminates the operations of this flowchart.

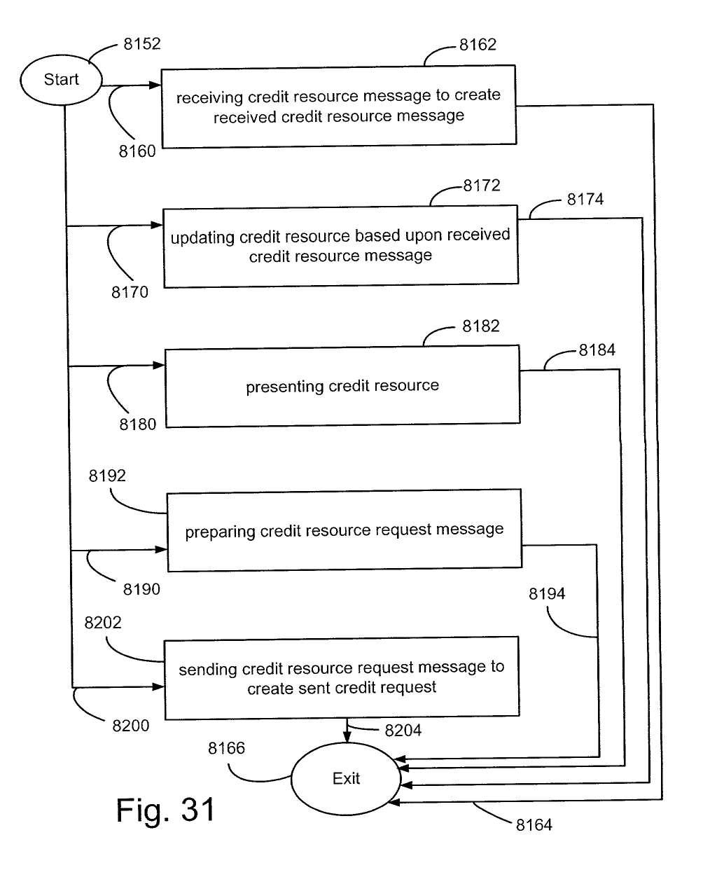

FIG. 31 depicts a detail flowchart of operation 8152 of FIG. 30B for managing the credit resource, for at least one of the credit resources of the credit resource collection.

Arrow 8160 directs the flow of execution from starting operation 8152 to operation 8162. Operation 8162 performs receiving a credit resource message to create a received credit resource message. Arrow 8164 directs execution from operation 8162 to operation 8166. Operation 8166 terminates the operations of this flowchart.

Arrow 8170 directs the flow of execution from starting operation 8152 to operation 8172. Operation 8172 performs updating the credit resource based upon the received credit resource message. Arrow 8174 directs execution from operation 8172 to operation 8166. Operation 8166 terminates the operations of this flowchart.

Arrow 8180 directs the flow of execution from starting operation 8152 to operation 8182. Operation 8182 performs presenting the credit resource. Arrow 8184 directs execution from operation 8182 to operation 8166. Operation 8166 terminates the operations of this flowchart.

Arrow 8190 directs the flow of execution from starting operation 8152 to operation 8192. Operation 8192 performs preparing a credit resource request message. Arrow 8194 directs execution from operation 8192 to operation 8166. Operation 8166 terminates the operations of this flowchart.

Arrow 8200 directs the flow of execution from starting operation 8152 to operation 8202. Operation 8202 performs sending the credit resource request message to create a sent credit request. Arrow 8204 directs execution from operation 8202 to operation 8166. Operation 8166 terminates the operations of this flowchart.

Note that one or more of the operations of FIG. 31 may act as refinements of one or more of the operations of FIG. 5B and/or act as a refinement of operation 5212 of FIG. 5A.

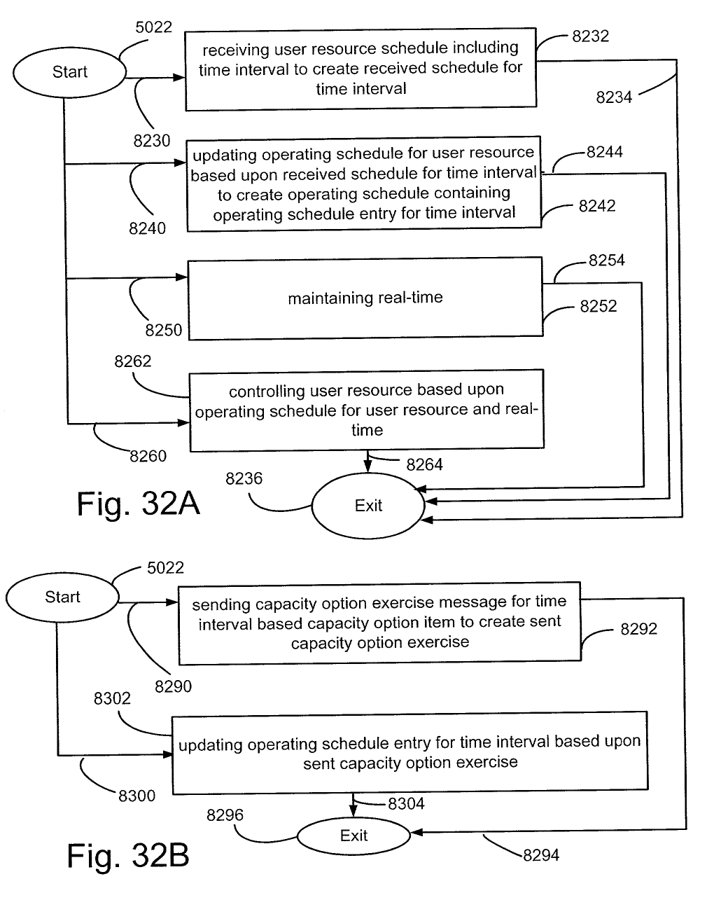

FIG. 32A depicts a detail flowchart of operation 5022 of FIG. 4 for managing the user resource.

Arrow 8230 directs the flow of execution from starting operation 5022 to operation 8232. Operation 8232 performs receiving a user resource schedule including a time interval to create a received schedule for the time interval. Arrow 8234 directs execution from operation 8232 to operation 8236. Operation 8236 terminates the operations of this flowchart.

Arrow 8240 directs the flow of execution from starting operation 5022 to operation 8242. Operation 8242 performs updating an operating schedule for the user resource based upon the received schedule for the time interval to create the operating schedule containing an operating schedule entry for the time interval. Arrow 8244 directs execution from operation 8242 to operation 8236. Operation 8236 terminates the operations of this flowchart.

Arrow 8250 directs the flow of execution from starting operation 5022 to operation 8252. Operation 8252 performs maintaining a real-time. Arrow 8254 directs execution from operation 8252 to operation 8236. Operation 8236 terminates the operations of this flowchart.

Arrow 8260 directs the flow of execution from starting operation 5022 to operation 8262. Operation 8262 performs controlling the user resource based upon the operating schedule for the user resource and based upon the realtime. Arrow 8264 directs execution from operation 8262 to operation 8236. Operation 8236 terminates the operations of this flowchart.

Note that a market trading system component and a scheduling system component within the transaction system may use the same real-time clocking scheme, or separate and distinct real-time clocking schemes. This will effect operating the equipment usage item 5592, maintaining the market window 5712, by way of example. The market window preferably closes long enough before the real-time it refers to, so that all commitments are scheduled, and those schedules received by the certified client reliably. ###

The operating schedule entry for the time interval contained in the operating schedule for the user resource may include a capacity option item.

FIG. 32B depicts a detail flowchart of operation 5022 of FIG. 4 for managing the user resource.

Arrow 8290 directs the flow of execution from starting operation 5022 to operation 8292. Operation 8292 performs sending a capacity option exercise message for the time interval based the capacity option item to create a sent capacity option exercise. Arrow 8294 directs execution from operation 8292 to operation 8296. Operation 8296 terminates the operations of this flowchart. Arrow 8300 directs the flow of execution from starting operation 5022 to operation 8302. Operation 8302 performs updating the operating schedule entry for the time interval based upon the sent capacity option exercise.

Arrow 8304 directs execution from operation 8302 to operation 8296. Operation 8296 terminates the operations of this flowchart.

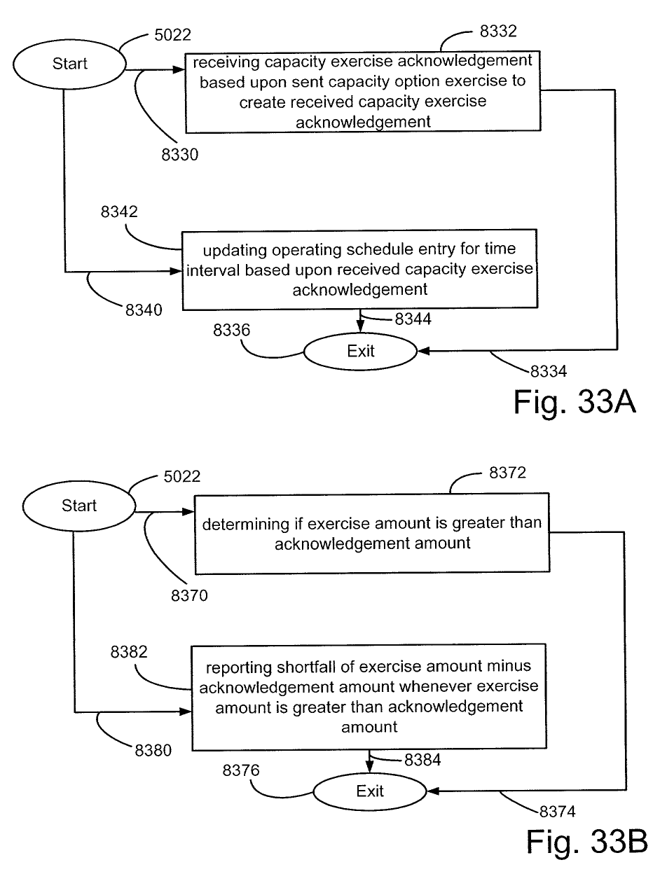

FIG. 33A depicts a detail flowchart of operation 5022 of FIG. 4 for managing the user resource.

Arrow 8330 directs the flow of execution from starting operation 5022 to operation 8332. Operation 8332 performs receiving a capacity exercise acknowledgment based upon the sent capacity option exercise to create a received capacity exercise acknowledgment. Arrow 8334 directs execution from operation 8332 to operation 8336. Operation 8336 terminates the operations of this flowchart.

Arrow 8340 directs the flow of execution from starting operation 5022 to operation 8342. Operation 8342 performs updating the operating schedule entry for the time interval based upon the received capacity exercise acknowledgment. Arrow 8344 directs execution from operation 8342 to operation 8336. Operation 8336 terminates the operations of this flowchart.

In certain embodiments of the invention, a sent capacity option exercise includes an exercise amount and the received capacity exercise acknowledgment includes an acknowledgment amount.

FIG. 33B depicts a detail flowchart of operation 5022 of FIG. 4 for managing the user resource.

Arrow 8370 directs the flow of execution from starting operation 5022 to operation 8372. Operation 8372 performs determining if the exercise amount is greater than the acknowledgment amount. Arrow 8374 directs execution from operation 8372 to operation 8376. Operation 8376 terminates the operations of this flowchart.

Arrow 8380 directs the flow of execution from starting operation 5022 to operation 8382. Operation 8382 performs reporting a shortfall of the exercise amount minus the acknowledgment amount whenever the exercise amount is greater than the acknowledgment amount. Arrow 8384 directs execution from operation 8382 to operation 8376. Operation 8376 terminates the operations of this flowchart.

Note that a market trade may be associated with at least one of said market intervals of said fungible, ephemeral commodity by said certified client with a member of the trade specification collection.

A trade specification collection may include a bid specification, an ask specification and a commitment specification. Each of these specifications may include an amount and price.

Additionally any of these specifications may refer to a capacity option which would include at least an exercise price.

A commitment specification may further include references to one or more other certified clients participating in the commitment.

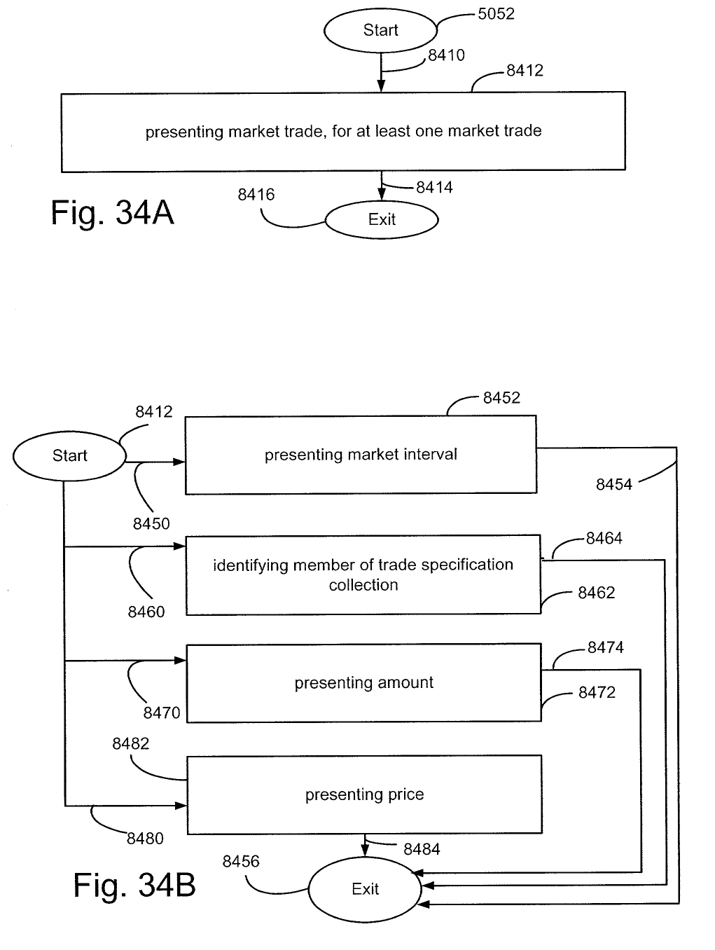

FIG. 34A depicts a detail flowchart of operation 5052 of FIG. 4 for managing said market trade collection.

Arrow 8410 directs the flow of execution from starting operation 5052 to operation 8412. Operation 8412 performs presenting said market trade, for at least one of said market trades. Arrow 8414 directs execution from operation 8412 to operation 8416. Operation 8416 terminates the operations of this flowchart.

FIG. 34B depicts a detail flowchart of operation 8412 of FIG. 34A for presenting said market trade, for at least one of said market trades.

Arrow 8450 directs the flow of execution from starting operation 8412 to operation 8452. Operation 8452 performs presenting said market interval. Arrow 8454 directs execution from operation 8452 to operation 8456. Operation 8456 terminates the operations of this flowchart.

Arrow 8460 directs the flow of execution from starting operation 8412 to operation 8462. Operation 8462 performs identifying said member of said trade specification collection. Arrow 8464 directs execution from operation 8462 to operation 8456. Operation 8456 terminates the operations of this flowchart.

Note that identifying the trade specification collection member may be achieved by at least any of the following: a visual token or icon located near the presentation of the trade; a columnar region in which all the market trades for that specification member are listed; and a color coding of a market trade based upon the specification collection membership.

Arrow 8470 directs the flow of execution from starting operation 8412 to operation 8472. Operation 8472 performs presenting said amount. Arrow 8474 directs execution from operation 8472 to operation 8456. Operation 8456 terminates the operations of this flowchart.

Arrow 8480 directs the flow of execution from starting operation 8412 to operation 8482. Operation 8482 performs presenting said price. Arrow 8484 directs execution from operation 8482 to operation 8456. Operation 8456 terminates the operations of this flowchart.

Note that as used herein, presentation of a market trade to a certified client, who is a software agent, may include the operations of FIG. 34B asserting facts to the software agent.

In many circumstances, the identification of other certified clients involved in at least the commitment trades can be expected, even though this may not always be the case.

Consider a collective trading situation of a group of small facility operators pooling their resources to trade in a general market such as the virtual trading floor. Such small operators may be unable to individually participate in the general market, due to minimum lot size constraints. In such situations, the individual certified client may not be informed of other trading certified clients, just of the open bids and asks as well as commitments within their collective group.

The preceding embodiments of the invention have been provided by way of example and are not meant to constrain the scope of the following Claims.

In the claims

1. A transaction system supporting transactions involving at least one fungible, ephemeral commodity, comprising:
a computer communicatively coupled to a certified client, and accessibly coupled to a computer memory, and controlled by a program system comprised of program steps residing in said memory of:
said certified client initiating at least one action in said transaction system; and further comprising at least two members of the basic usage program collection comprising program steps of:
managing at least one user resources;
managing a bilateral trading portfolio comprising at least one bilateral trade in at least one of said fungible, ephemeral commodities;
managing a market position portfolio comprising market positions of at least one of said fungible, ephemeral commodities;
managing a market trading collection comprising at least one market trade in at least one of said fungible, ephemeral commodities;
managing a credit resource collection comprising at least one credit resource; and
managing compliance reporting based upon at least one member of the collection comprising said user resources, said market position portfolio, said bilateral trading portfolio and said market trading collection;
wherein the program step of said certified client initiating said action in said transaction system is further comprised of at least one member of the collection comprising the program steps of:
initiating a bid for a market interval at a bid price and a bid amount as a first validated order;
initiating an ask for a market interval at a ask price and a ask amount as a second validated order;
responding to a financial commitment presented by said transaction system to create a financial response to said financial commitment;
reporting at least one of said bilateral trades to said transaction system; and
confirming at least one of said bilateral trades to said transaction system;
wherein said market interval includes a product type associated with at least one of said fungible, ephemeral commodities for at least one location for at least one time interval; and
wherein the program step of said certified client responding to said financial commitment presented by said transaction system is further comprised of at least one member of the collection comprising the program steps of
creating a financial payment of said financial commitment in said transaction system; and
creating a financial counter-response to said financial commitment in said transaction system.

2. The system of claim 1,
wherein the program step of managing said user resource further comprises at least one member of the collection comprising the program steps of:
managing a generator of at least one of said fungible, ephemeral commodities;
managing a load consuming at least one of said fungible, ephemeral commodities;
managing a transmission facility for at least one of said fungible, ephemeral commodities;
managing an import providing at least one of said fungible, ephemeral commodities; and
managing an export consuming at least one of said fungible, ephemeral commodities.

3. The system of claim 2,
wherein the program step managing said user resource is further comprised of the program step of:
creating a first knowledge interval of said ephemeral, fungible commodity at a first time interval containing a first cost in said knowledge interval collection; and further comprised of at least one member of the collection comprising the program steps of:
maintaining a bid interval collection of bid intervals of said ephemeral, fungible commodity, each comprised of a bid price, a bid amount, and a bid time interval; and
maintaining an ask interval collection of ask intervals of said ephemeral, fungible commodity, each comprised of a ask price, a ask amount, and a ask time interval;
wherein the program step creating said first knowledge interval is comprised of the program steps of:
receiving a knowledge interval creation message to create a received knowledge interval creation message; and
creating said first knowledge interval of said ephemeral, fungible commodity at said first time interval containing said first cost in said knowledge interval collection based upon said received knowledge interval creation message.

4. The system of claim 3,
wherein the program step managing said user resource is further comprised of the program steps of:
determining said ephemeral, fungible commodity needs over a planning time interval; and
determining an equipment usage plan based upon said knowledge interval collection containing an equipment usage item of said user resource comprised of an activation time and an action belonging to an action collection comprising start-action, stop-action and throttle-action to create a resource operating schedule; and
operating said equipment usage item of said user resource based upon said device operating schedule.

5. The system of claim 4,
wherein the program step managing said user resource is further comprised of the program step of:
examining an equipment usage collection comprised of equipment usage entries each containing a delivery time and a need schedule for said ephemeral, fungible commodity to create said ephemeral, fungible commodity needs over said planning time interval comprises an amount.

6. The system of claim 5,
wherein said ephemeral, fungible commodity needs over said planning time interval further comprises a cost limit; and
wherein the program step initiating said bid is further comprised of the program step of:
making said bid of a first bid amount at a first bid price within said cost limit for said first time interval of said ephemeral, fungible commodity.

7. The system of claim 4,
wherein the program step operating said equipment usage item based upon said device operating schedule is further comprised of at least one member of the collection comprising the program steps of
starting said equipment usage item of said user resource;
stopping said equipment usage item of said user resource; and
throttling said equipment usage item of said user resource.

8. The system of claim 1,
wherein the program step of managing said market position portfolio is comprised of the program steps of:
maintaining a market window;
maintaining a local market position portfolio comprised of at least one market position summary, each of said market position summaries including a market interval of said fungible, ephemeral commodity within said market window;
presenting said local market position portfolio based upon said market window;
wherein the program step of presenting said local market position portfolio is further comprised of:
presenting at least one of said market position summaries including said market interval within said market window.

9. The system of claim 8,
wherein at least one of said market position summaries of said local market position portfolio is further comprised of an amount-held, a current bid summary, a current ask summary, a current market price and a current order summary;
wherein the program step of presenting said market position summary further comprising the program steps of:
presenting said included market interval;
presenting said amount-held;
presenting said current bid summary;
presenting said current ask summary;
presenting said current market price; and
presenting said current order summary.

10. The system of claim 9,
the program system further comprising the program step of maintaining a market position database including the program step of:
maintaining at least one of said market positions containing at least one of said market intervals further including at least one member of the collection comprising the program steps of:
maintaining an amount-held associated with said market interval;
maintaining a current bid list associated with said market interval including at least one current bid;
maintaining a current ask list associated with said market interval including at least one ask;
maintaining a current market price associated with said market interval; and
maintaining a current order list associated with said market interval.

11. The system of claim 10,
wherein the program system further comprises the program step of:
establishing a client node belonging to said node collection of said AC power network as said business location; and
wherein the program step of maintaining said local market position portfolio is further comprised of at least one member of a calculation collection comprising the program steps of:
calculating said current bid summary from said market position database based upon said business location;
calculating said current ask summary from said market position database based upon said business location; and
calculating said current market price from said market position database based upon said business location.

12. The system of claim 11,
wherein at least one of said market intervals contains an AC power transfer product type as said fungible, ephemeral commodity and contains said location as a first of said nodes directed to a second of said nodes of said AC power network node collection.

13. The system of claim 12,
wherein the program system further comprises the program step of:
maintaining a flowgate collection containing at least two flowgate entries;
wherein each of said flowgate entries contained in said flowgate collection includes a factor, a from-node of said node collection and a to-node of said node collection;
wherein for each of said flowgate entries contained in said flowgate collection, at least one of said market intervals contains said AC power transfer product type as said fungible, ephemeral commodity and said location coinciding with said flowgate entry; and
wherein at least one member of said calculation collection is further based upon said flowgate collection.

14. The system of claim 13,
wherein said product type is further comprised of an AC power transfer point-to-point product type as said fungible, ephemeral commodity.

15. The system of claim 14,
wherein the program step maintaining said current bid list is further comprised of the program steps of:
receiving a request for a point-to-point bid associated with said market interval to create a received point-to-point bid request;
generating a point-to-point bid associated with said market interval based upon said received bid request to create a new point-to-point bid associated with said market interval further including the program steps of:
generating a bid associated with said market interval containing said AC power transfer product type and said location coinciding with said flowgate entry, for at least one flowgate entry contained in said flowgate collection; and
sending said new point-to-point bid associated with said market interval based upon said received bid request as an order message.

16. The system of claim 8,
wherein said market trade is associated with at least one of said market intervals of said fungible, ephemeral commodity by said certified client with a member of the trade specification collection;
wherein said trade specification collection is comprised of
a bid specification containing an amount, and a price;
an ask specification containing said amount, and said price; and
an contract specification containing said amount and said price;
wherein the program step managing said market trade collection is further comprised of the program step of
presenting said market trade, for at least one of said market trades, further comprised of the program steps of
presenting said market interval;
identifying said member of said trade specification collection;
presenting said amount; and
presenting said price.

17. The system of claim 1,
wherein the program step of managing said bilateral trading portfolio is further comprised of the program steps of:
managing said bilateral trade, for each of said bilateral trades of said bilateral trading portfolio.

18. The system of claim 1,
wherein the program step of managing said bilateral trading portfolio is further comprised of the program steps of:
receiving an authenticated bilateral trade notification message to create a received bilateral trade notification message;
updating said bilateral trading portfolio based upon said received bilateral trade notification message;
generating an initial bilateral trade;
processing said initial bilateral trade to create an initial bilateral trade message;
inserting said initial bilateral trade into said bilateral trading portfolio;
sending said initial bilateral trade message;
receiving a bilateral trade confirmation message to create a received bilateral trade confirmation request; and
inserting said received bilateral trade confirmation request into said bilateral trading portfolio.

19. The system of claim 18,
wherein the program step of managing said bilateral trading portfolio is further comprised of the program steps of:
responding to said received bilateral trade confirmation request to create a bilateral trade confirmation response;
inserting said bilateral trade confirmation response into said bilateral trading portfolio;
processing said bilateral trade confirmation response to create a bilateral trade confirmation response message; and
sending said bilateral trade confirmation response message.

20. The system of claim 1,
wherein the program step of managing said credit resource collection is comprised of the program steps of:
managing said credit resource, for each of said credit resources of said credit resource collection.

21. The system of claim 20,
wherein the program step of managing said credit resource, for at least one of said credit resources of said credit resource collection, is further comprised of the program steps of:
receiving a credit resource message from said transaction system to create a received credit resource message;
updating said credit resource based upon said received credit resource message;
presenting said credit resource;
preparing a credit resource request message; and
sending said credit resource request message to create a sent credit request.

22. The system of claim 21,
wherein the program step of receiving said credit resource message is further comprised of the program step of:
receiving a credit request response message from said transaction system based upon said sent credit request to create a received credit request response.

23. The system of claim 1,
wherein the program step of managing said user resource, is further comprised of the program steps of:
receiving a user resource schedule including a time interval from said transaction system to create a received schedule for said time interval;
updating an operating schedule for said user resource based upon said received schedule for said time interval to create said operating schedule containing an operating schedule entry for said time interval;
maintaining a real-time; and
controlling said user resource based upon said operating schedule for said user resource and based upon said real-time.

24. The system of claim 23,
wherein said operating schedule entry for said time interval contained in said operating schedule for said user resource includes a capacity option item; and
wherein the program step of managing said user resource is further comprised of the program steps of:
sending a capacity option exercise message for said time interval based said capacity option item to create a sent capacity option exercise; and
updating said operating schedule entry for said time interval based upon said sent capacity option exercise.

25. The system of claim 24,
wherein the program step of managing said user resource is further comprised of the program steps of:
receiving a capacity exercise acknowledgment based upon said sent capacity option exercise to create a received capacity exercise acknowledgment; and
updating said operating schedule entry for said time interval based upon said received capacity exercise acknowledgment.

26. The system of claim 25,
wherein said sent capacity option exercise includes an exercise amount;
wherein said received capacity exercise acknowledgment includes an acknowledgment amount;
wherein the program step of managing said user resource is further comprised of the program steps of:
determining if said exercise amount is greater than said acknowledgment amount, and
reporting a shortfall of said exercise amount minus said acknowledgment amount whenever said exercise amount is greater than said acknowledgment amount.

27. The system of claim 1,
wherein said program system supports said certified client acoustically communicating with said computer to interactively use said transaction system.

28. The system of claim 1, further comprising
a client computer communicatively coupled to a server computer included in a server system;
wherein said certified client operates said client computer to interactively use said transaction system.

29. The system of claim 28,
wherein said server system provides a market engine supporting a virtual trading floor involving said fungible, ephemeral commodities.

30. The system of claim 29,
wherein said server system further comprises an engine system supporting said virtual trading floor involving said fungible, ephemeral commodities.

31. A method for a certified client interactively using a transaction system supporting transactions involving at least one fungible, ephemeral commodity, comprising the step of:
said certified client initiating at least one action in said transaction system;
and further comprising at least two members of the basic usage collection comprising the steps of:
managing at least one user resource;
managing a bilateral trading portfolio comprising at least one bilateral trade in at least one of said fungible, ephemeral commodities;
managing a market position portfolio comprising at least one market position of at least one of said fungible, ephemeral commodities;
managing a market trading collection comprising at least one market trade in at least one of said fungible, ephemeral commodities;
managing a credit resource collection comprising at least one credit resource; and
managing compliance reporting based upon at least one member of the collection comprising said user resources, said market position portfolio, said bilateral trading portfolio and said market trading collection;
wherein the step of said certified client initiating said action in said transaction system is further comprised of at least one member of the collection comprising the steps of:
initiating a bid for a market interval at a bid price and a bid amount as a first validated order;
initiating an ask for a market interval at a ask price and a ask amount as a second validated order;
responding to a financial commitment presented by said transaction system to create a financial response to said financial commitment;
reporting at least one of said bilateral trades to said transaction system; and
confirming at least one of said bilateral trades to said transaction system;
wherein said market interval includes a product type associated with at least one of said fungible, ephemeral commodities for at least one location for at least one time interval; and
wherein the step of responding to said financial commitment presented by said transaction system is further comprised of at least one member of the collection comprising the steps of
creating a financial payment of said financial commitment; and
creating a financial counter-response to said financial commitment.

32. The method of claim 31,
wherein the step of managing said user resource further comprises at least one member of the collection comprising the steps of:
managing a generator of at least one of said fungible, ephemeral commodities;
managing a load consuming at least one of said fungible, ephemeral commodities;
managing a transmission facility for at least one of said fungible, ephemeral commodities;
managing an import providing at least one of said fungible, ephemeral commodities; and
managing an export consuming at least one of said fungible, ephemeral commodities.

33. The method of claim 32,
wherein the step managing said user resource is further comprised of the step of:
creating a first knowledge interval of said ephemeral, fungible commodity at a first time interval containing a first cost in said knowledge interval collection;
wherein the step managing said user resource is further comprised of at least one member of the collection comprising the steps of:
maintaining a bid interval collection of bid intervals of said ephemeral, fungible commodity, each comprised of a bid price, a bid amount, and a bid time interval; and
maintaining an ask interval collection of ask intervals of said ephemeral, fungible commodity, each comprised of a ask price, a ask amount, and a ask time interval;
wherein the step creating said first knowledge interval is comprised of the steps of:
receiving a knowledge interval creation message to create a received knowledge interval creation message; and
creating said first knowledge interval of said ephemeral, fungible commodity at said first time interval containing said first cost in said knowledge interval collection based upon said received knowledge interval creation message.

34. The method of claim 33,
wherein the step managing said user resource is further comprised of the steps of:
determining said ephemeral, fungible commodity needs over a planning time interval; and
determining an equipment usage plan based upon said knowledge interval collection containing an equipment usage item of said user resource comprised of an activation time and an action belonging to an action collection comprising start-action, stop-action and throttle-action to create a resource operating schedule; and
operating said equipment usage item of said user resource based upon said device operating schedule.

35. The method of claim 34,
wherein the step managing said user resource is further comprised of the step of:
examining an equipment usage collection comprised of equipment usage entries each containing a delivery time and a need schedule for said ephemeral, fungible commodity to create said ephemeral, fungible commodity needs over said planning time interval comprises an amount.

36. The method of claim 35,
wherein said ephemeral, fungible commodity needs over said planning time interval further comprises a cost limit; and
wherein the step initiating said bid is further comprised of the step of:
making said bid of a first bid amount at a first bid price within said cost limit for said first time interval of said ephemeral, fungible commodity.

37. The method of claim 34,
wherein the step operating said equipment usage item based upon said device operating schedule is further comprised of at least one member of the collection comprising the steps of
starting said equipment usage item of said user resource;
stopping said equipment usage item of said user resource; and
throttling said equipment usage item of said user resource.

38. The method of claim 31,
wherein the step of managing said market position portfolio is comprised of the steps of:
maintaining a market window;
maintaining a local market position portfolio comprised of at least one market position summary, each of said market position summaries including a market interval of said fungible, ephemeral commodity within said market window;
presenting said local market position portfolio based upon said market window;
wherein the step of presenting said local market position portfolio is further comprised of
presenting at least one of said market position summaries including said market interval within said market window.

39. The method of claim 38,
wherein at least one of said market position summaries of said local market position portfolio is further comprised of an amount-held, a current bid summary, a current ask summary, a current market price and a current order summary;
wherein the step of presenting said market position summary further comprising the steps of
presenting said included market interval;
presenting said amount-held;
presenting said current bid summary;
presenting said current ask summary;
presenting said current market price; and
presenting said current order summary.

40. The method of claim 39, further comprising the step of:
maintaining a market position database including the step of
maintaining at least one of said market positions containing at least one of said market intervals further including at least one member of the collection comprising the steps of
maintaining an amount-held associated with said market interval;
maintaining a current bid list associated with said market interval including at least one current bid;
maintaining a current ask list associated with said market interval including at least one ask;
maintaining a current market price associated with said market interval; and
maintaining a current order list associated with said market interval.

41. The method of claim 40, further comprising the step of:
establishing a client node belonging to said node collection of said AC power network as said business location; and
wherein the step maintaining said local market position portfolio is further comprised of at least one member of a calculation collection comprising the steps of:
calculating said current bid summary from said market position database based upon said business location;
calculating said current ask summary from said market position database based upon said business location; and
calculating said current market price from said market position database based upon said business location.

42. The method of claim 41,
wherein at least one of said market intervals contains an AC power transfer product type as said fungible, ephemeral commodity and contains said location as a first of said nodes directed to a second of said nodes of said AC power network node collection.

43. The method of claim 42, further comprising the step of:
maintaining a flowgate collection containing at least two flowgate entries;
wherein each of said flowgate entries contained in said flowgate collection includes a factor, a from-node of said node collection and a to-node of said node collection;
wherein for each of said flowgate entries contained in said flowgate collection, at least one of said market intervals contains said AC power transfer product type as said fungible, ephemeral commodity and said location coinciding with said flowgate entry; and
wherein at least one member of said calculation collection is further is based upon said flowgate collection.

44. The method of claim 43,
wherein said product type is further comprised of an AC power transfer point-to-point product type as said fungible, ephemeral commodity.

45. The method of claim 44,
wherein the step maintaining said current bid list is further comprised of the steps of:
receiving a request for a point-to-point bid associated with said market interval to create a received point-to-point bid request;
generating a point-to-point bid associated with said market interval based upon said received bid request to create a new point-to-point bid associated with said market interval further including the steps of:
generating a bid associated with said market interval containing said AC power transfer product type and said location coinciding with said flowgate entry, for at least one flowgate entry contained in said flowgate collection; and
sending said new point-to-point bid associated with said market interval based upon said received bid request as an order message.

46. The method of claim 38,
wherein said market trade is associated with at least one of said market intervals of said fungible, ephemeral commodity by said certified client with a member of the trade specification collection;
wherein said trade specification collection is comprised of
a bid specification containing an amount, and a price;
an ask specification containing said amount, and said price; and
an order specification containing said amount and said price;
wherein the step managing said market trade collection is further comprised of the step of
presenting said market trade, for at least one of said market trades, further comprised of the steps of
presenting said market interval;
identifying said member of said trade specification collection;
presenting said amount; and
presenting said price.

47. The method of claim 31,
wherein the step of managing said bilateral trading portfolio is further comprised of the steps of:
managing said bilateral trade, for each of said bilateral trades of said bilateral trading portfolio.

48. The method of claim 31,
wherein the step of managing said bilateral trading portfolio is further comprised of the steps of:
receiving an authenticated bilateral trade notification message to create a received bilateral trade notification message;
updating said bilateral trading portfolio based upon said received bilateral trade notification message;
generating an initial bilateral trade;
processing said initial bilateral trade to create an initial bilateral trade message;
inserting said initial bilateral trade into said bilateral trading portfolio;
sending said initial bilateral trade message;
receiving a bilateral trade confirmation message to create a received bilateral trade confirmation request; and
inserting said received bilateral trade confirmation request into said bilateral trading portfolio.

49. The method of claim 48,
wherein the step of managing said bilateral trading portfolio is further comprised of the steps of:
responding to said received bilateral trade confirmation request to create a bilateral trade confirmation response;
inserting said bilateral trade confirmation response into said bilateral trading portfolio;
processing said bilateral trade confirmation response to create a bilateral trade confirmation response message; and
sending said bilateral trade confirmation response message.

50. The method of claim 31,
wherein the step of managing said credit resource collection is comprised of the steps of:
managing said credit resource, for each of said credit resources of said credit resource collection.

51. The method of claim 50,
wherein the step of managing said credit resource, for at least one of said credit resources of said credit resource collection, is further comprised of the steps of:
receiving a credit resource message to create a received credit resource message;
updating said credit resource based upon said received credit resource message;
presenting said credit resource;
preparing a credit resource request message; and
sending said credit resource request message to create a sent credit request.

52. The method of claim 51,
wherein the step of receiving said credit resource message is further comprised of the step of:
receiving a credit request response message based upon said sent credit request to create a received credit request response.

53. The method of claim 31,
wherein the step of managing said user resource, is further comprised of the steps of:
receiving a user resource schedule including a time interval to create a received schedule for said time interval;
updating an operating schedule for said user resource based upon said received schedule for said time interval to create said operating schedule containing an operating schedule entry for said time interval;
maintaining a real-time; and
controlling said user resource based upon said operating schedule for said user resource and based upon said real-time.

54. The method of claim 53,
wherein said operating schedule entry for said time interval contained in said operating schedule for said user resource includes a capacity option item; and
wherein the step of managing said user resource is further comprised of the steps of:
sending a capacity option exercise message for said time interval based said capacity option item to create a sent capacity option exercise; and
updating said operating schedule entry for said time interval based upon said sent capacity option exercise.

55. The method of claim 54,
wherein the step of managing said user resource is further comprised of the steps of:
receiving a capacity exercise acknowledgment based upon said sent capacity option exercise to create a received capacity exercise acknowledgment; and
updating said operating schedule entry for said time interval based upon said received capacity exercise acknowledgment.

56. The method of claim 55,
wherein said sent capacity option exercise includes an exercise amount;
wherein said received capacity exercise acknowledgment includes an acknowledgment amount;
wherein the step of managing said user resource is further comprised of the steps of:
determining if said exercise amount is greater than said acknowledgment amount, and
reporting a shortfall of said exercise amount minus said acknowledgment amount whenever said exercise amount is greater than said acknowledgment amount.

57. The method of claim 31,
wherein said certified client acoustically communicates with said transaction system to interactively use said transaction system.

58. The method of claim 31,
wherein said transaction system is comprised of a client computer communicatively coupled to a server computer included in a server system;
wherein said certified client operates said client computer to interactively use said transaction system.

59. The method of claim 58,
wherein said server system provides a market engine supporting a virtual trading floor involving at least one of said fungible, ephemeral commodities.

60. The method of claim 59,
wherein said server system further comprises an engine system supporting said virtual trading floor involving said fungible, ephemeral commodities.

61. The method of claim 58,
wherein said client computer is controlled by a program system containing program steps residing in a memory accessibly coupled to said client computer;
wherein said program system is comprised of at least two members each implementing a member of said basic usage collection.

62. The method of claim 31,
wherein said financial commitment in said transaction system is further comprised of a first financial obligation to a first party;
wherein the step of said certified client responding to said financial commitment is further comprised of the step of
said certified client responding to said first financial obligation to said first party to create a first financial payment to said first party.

63. The first financial payment to said first party as a product of the process of claim 62.

64. A transaction system for supporting transactions involving at least one fungible, ephemeral commodity, comprising:
a means for using said transaction system communicatively coupled to a certified client comprising
a means for said certified client initiating at least one action in said transaction system; and further comprised of at least two members of the basic usage means collection comprising of:
a means for managing at least one user resources;
a means for managing a bilateral trading portfolio comprising at least one bilateral trade in at least one of said fungible, ephemeral commodities;
a means for managing a market position portfolio comprising market positions of at least one of said fungible, ephemeral commodities;
a means for managing a market trading collection comprising at least one market trade in at least one of said fungible, ephemeral commodities;
a means for managing a credit resource collection comprising at least one credit resource; and
a means for managing compliance reporting based upon at least one member of the collection comprising said user resources, said market position portfolio, said bilateral trading portfolio and said market trading collection;
wherein said means for said certified client initiating said action in said transaction system is further comprised of at least one member of the collection comprising:
a means for initiating a bid for a market interval at a bid price and a bid amount as a first validated order;
a means for a first ask for a market interval at a ask price and a ask amount as a second validated order;
a means for responding to a financial commitment presented by said transaction system to create a financial response to said financial commitment;
a means for reporting at least one of said bilateral trades to said transaction system; and
a means for confirming at least one of said bilateral trades to said transaction system;
wherein said market interval includes a product type associated with at least one of said fungible, ephemeral commodities for at least one location for at least one time interval; and
wherein said means for responding to said financial commitment presented by said transaction system is further comprised of at least one member of the collection comprising
a means for creating a financial payment of said financial commitment; and
a means for said certified client creating a financial counter-response to said financial commitment.

65. The system of claim 64,
wherein said means for managing said user resource further comprises at least one member of the collection comprising:
a means for managing a generator of at least one of said fungible, ephemeral commodities;
a means for managing a load consuming at least one of said fungible, ephemeral commodities;
a means for managing a transmission facility for at least one of said fungible, ephemeral commodities;
a means for managing an import providing at least one of said fungible, ephemeral commodities; and
a means for managing an export consuming at least one of said fungible, ephemeral commodities.

66. The system of claim 65,
wherein said means for managing said user resource is further comprised of:
a means for creating a first knowledge interval of said ephemeral, fungible commodity at a first time interval containing a first cost in said knowledge interval collection;
wherein said means for managing said user resource is further comprised of at least one member of the collection comprising:
a means for maintaining a bid interval collection of bid intervals of said ephemeral, fungible commodity, each comprised of a bid price, a bid amount, and a bid time interval; and
a means for maintaining an ask interval collection of ask intervals of said ephemeral, fungible commodity, each comprised of a ask price, a ask amount, and a ask time interval;
wherein said means for creating said first knowledge interval is comprised of:
a means for receiving a knowledge interval creation message to create a received knowledge interval creation message; and
a means for creating said first knowledge interval of said ephemeral, fungible commodity at said first time interval containing said first cost in said knowledge interval collection based upon said received knowledge interval creation message.

67. The system of claim 66,
wherein said means for managing said user resource is further comprised of:
a means for determining said ephemeral, fungible commodity needs over a planning time interval; and
a means for determining an equipment usage plan based upon said knowledge interval collection containing an equipment usage item of said user resource comprised of an activation time and an action belonging to an action collection comprising start-action, stop-action and throttle-action to create a resource operating schedule; and
a means for operating said equipment usage item of said user resource based upon said device operating schedule.

68. The system of claim of 67,
wherein said means for managing said user resource is further comprised of:
a means for examining an equipment usage collection comprised of equipment usage entries each containing a delivery time and a need schedule for said ephemeral, fungible commodity to create said ephemeral, fungible commodity needs over said planning time interval comprises an amount.

69. The system of claim of 68,
wherein said ephemeral, fungible commodity needs over said planning time interval further comprises a cost limit; and
wherein said means for initiating said bid is further comprised of:
a means for making said bid of a first bid amount at a first bid price within said cost limit for said first time interval of said ephemeral, fungible commodity.

70. The system of claim 67,
wherein said means for operating said equipment usage item based upon said device operating schedule is further comprised of at least one member of the collection comprising
a means for starting said equipment usage item of said user resource;
a means for stopping said equipment usage item of said user resource; and
a means for throttling said equipment usage item of said user resource.

71. The system of claim 64,
wherein said means for managing said market position portfolio is comprised of:
a means for maintaining a market window;
a means for maintaining a local market position portfolio comprised of at least one market position summary, each of said market position summaries including a market interval of said fungible, ephemeral commodity within said market window;
a means for presenting said local market position portfolio based upon said market window;
wherein said means for presenting said local market position portfolio is further comprised of:
a means for presenting at least one of said market position summaries including said market interval within said market window.

72. The system of claim 71,
wherein at least one of said market position summaries of said local market position portfolio is further comprised of an amount-held, a current bid summary, a current ask summary, a current market price and a current order summary;
wherein said means for presenting said market position summary further comprising:
a means for presenting said included market interval;
a means for presenting said amount-held;
a means for presenting said current bid summary;
a means for presenting said current ask summary;
a means for presenting said current market price; and
a means for presenting said current order summary.

73. The system of claim 72, further comprising
a means for maintaining a market position database including:
a means for maintaining at least one of said market positions containing at least one of said market intervals further including at least one member of the collection comprising:
a means for maintaining an amount-held associated with said market interval;
a means for maintaining a current bid list associated with said market interval including at least one current bid;
a means for maintaining a current ask list associated with said market interval including at least one ask;
a means for maintaining a current market price associated with said market interval; and
a means for maintaining a current order list associated with said market interval.

74. The system of claim 73, further comprising:
a means for establishing a client node belonging to said node collection of said AC power network as said business location; and
wherein said means for maintaining said local market position portfolio is further comprised of at least one member of a calculation collection comprising:
a means for calculating said current bid summary from said market position database based upon said business location;
a means for calculating said current ask summary from said market position database based upon said business location; and
a means for calculating said current market price from said market position database based upon said business location.

75. The system of claim 74,
wherein at least one of said market intervals contains an AC power transfer product type as said fungible, ephemeral commodity and contains said location as a first of said nodes directed to a second of said nodes of said AC power network node collection.

76. The system of claim 75, further comprising:
a means for maintaining a flowgate collection containing at least two flowgate entries;
wherein each of said flowgate entries contained in said flowgate collection includes a factor, a from-node of said node collection and a to-node of said node collection;
wherein for each of said flowgate entries contained in said flowgate collection, at least one of said market intervals contains said AC power transfer product type as said fungible, ephemeral commodity and said location coinciding with said flowgate entry; and
wherein at least one member of said calculation collection is further based upon said flowgate collection.

77. The system of claim 76,
wherein said product type is further comprised of an AC power transfer point-to-point product type as said fungible, ephemeral commodity.

78. The system of claim 77,
wherein said means for maintaining said current bid list is further comprised of:
a means for receiving a request for a point-to-point bid associated with said market interval to create a received point-to-point bid request;
a means for generating a point-to-point bid associated with said market interval based upon said received bid request to create a new point-to-point bid associated with said market interval further including:
a means for generating a bid associated with said market interval containing said AC power transfer product type and said location coinciding with said flowgate entry, for at least one flowgate entry contained in said flowgate collection; and
a means for sending said new point-to-point bid associated with said market interval based upon said received bid request as an order message.

79. The system of claim 71,
wherein said market trade is associated with at least one of said market intervals of said fungible, ephemeral commodity by said certified client with a member of the trade specification collection;
wherein said trade specification collection is comprised of
a bid specification containing an amount, and a price;
an ask specification containing said amount, and said price; and
an order specification containing said amount and said price;
wherein said means for managing said market trade collection is further comprised of
a means for presenting said market trade, for at least one of said market trades, further comprised of
a means for presenting said market interval;
a means for identifying said member of said trade specification collection;
a means for presenting said amount; and
a means for presenting said price.

80. The system of claim 64,
wherein said means for managing said bilateral trading portfolio is further comprised of:
a means for managing said bilateral trade, for each of said bilateral trades of said bilateral trading portfolio.

81. The system of claim 64,
wherein said means for managing said bilateral trading portfolio is further comprised of:
a means for receiving an authenticated bilateral trade notification message to create a received bilateral trade notification message; and
a means for updating said bilateral trading portfolio based upon said received bilateral trade notification message;
a means for generating an initial bilateral trade;
a means for processing said initial bilateral trade to create an initial bilateral trade message;
a means for inserting said initial bilateral trade into said bilateral trading portfolio; and
a means for sending said initial bilateral trade message;
a means for receiving a bilateral trade confirmation message to create a received bilateral trade confirmation request; and
a means for inserting said received bilateral trade confirmation request into said bilateral trading portfolio.

82. The system of claim 81,
wherein said means for managing said bilateral trading portfolio is further comprised of:
a means for responding to said received bilateral trade confirmation request to create a bilateral trade confirmation response;
a means for inserting said bilateral trade confirmation response into said bilateral trading portfolio;
a means for processing said bilateral trade confirmation response to create a bilateral trade confirmation response message; and
a means for sending said bilateral trade confirmation response message.

83. The system of claim 64,
wherein said means for managing said credit resource collection is comprised of:
a means for managing said credit resource, for each of said credit resources of said credit resource collection.

84. The system of claim 83,
wherein said means for managing said credit resource, for at least one of said credit resources of said credit resource collection, is further comprised of:
a means for receiving a credit resource message from said transaction system to create a received credit resource message;
a means for updating said credit resource based upon said received credit resource message;
a means for presenting said credit resource;
a means for preparing a credit resource request message; and
a means for sending said credit resource request message to create a sent credit request.

85. The system of claim 84,
wherein said means for receiving said credit resource message is further comprised of:
a means for receiving a credit request response message from said transaction system based upon said sent credit request to create a received credit request response.

86. The system of claim 64,
wherein said means for managing said user resource, is further comprised of:
a means for receiving a user resource schedule including a time interval from said transaction system to create a received schedule for said time interval;
a means for updating an operating schedule for said user resource based upon said received schedule for said time interval to create said operating schedule containing an operating schedule entry for said time interval;
a means for maintaining a real-time; and
a means for controlling said user resource based upon said operating schedule for said user resource and based upon said real-time.

87. The system of claim 86,
wherein said operating schedule entry for said time interval contained in said operating schedule for said user resource includes a capacity option item; and
wherein said means for managing said user resource is further comprised of:
a means for sending a capacity option exercise message for said time interval based said capacity option item to create a sent capacity option exercise; and
a means for updating said operating schedule entry for said time interval based upon said sent capacity option exercise.

88. The system of claim 87,
wherein said means for managing said user resource is further comprised of:
a means for receiving a capacity exercise acknowledgment based upon said sent capacity option exercise to create a received capacity exercise acknowledgment; and
a means for updating said operating schedule entry for said time interval based upon said received capacity exercise acknowledgment.

89. The system of claim 88,
wherein said sent capacity option exercise includes an exercise amount;
wherein said received capacity exercise acknowledgment includes an acknowledgment amount;
wherein said means for managing said user resource is further comprised of:
a means for determining if said exercise amount is greater than said acknowledgment amount; and
a means for reporting a shortfall of said exercise amount minus said acknowledgment amount whenever said exercise amount is greater than said acknowledgment amount.

90. The system of claim 64,
wherein said means for using said transaction system supports at least one member of the collection comprising:
said certified client acoustically communicating with said transaction system to interactively use said transaction system;
said certified client communicating in a tactile fashion with said transaction system to interactively use said transaction system;
said certified client communicating in a wireless fashion with said transaction system to interactively use said transaction system; and
said certified client communicating in a wireline fashion with said transaction system to interactively use said transaction system.

91. The system of claim 64,
wherein said transaction system is further comprised of at least one computer operated by said certified client and controlled by a program system comprised of program steps residing in a memory accessibly coupled to said computer.

92. The system of claim 91,
wherein said means for using said transaction system is implemented as at least one of said program steps in said program system.

93. The system of claim 91,
wherein at least one member of said basic usage means collection is implemented as at least one of said program steps in said program system.

94. The system of claim 64,
wherein said transaction system is further comprised of a client computer communicatively coupled to a server computer included in a server system;
wherein said certified client operates said client computer to interactively use said transaction system.

95. The system of claim 94,
wherein said server system provides a market engine supporting a virtual trading floor involving said fungible, ephemeral commodities.

96. The system of claim 95,
wherein said server system further comprises an engine system supporting said virtual trading floor involving said fungible, ephemeral commodities.

97. A transaction system supporting transactions involving at least one fungible, ephemeral commodity, comprising:
a computer communicatively coupled to a certified client, and accessibly coupled to a computer memory, and controlled by a program system comprised of program steps residing in said memory of:
said certified client initiating at least one action in said transaction system; and is further comprised of at least two members of the basic usage program collection comprising program steps of:
managing at least one user resource;
managing a bilateral trading portfolio comprising at least one bilateral trade in at least one of said fungible, ephemeral commodities;
managing a market position portfolio comprising market positions of at least one of said fungible, ephemeral commodities;
managing a market trading collection comprising at least one market trade in at least one of said fungible, ephemeral commodities;
managing a credit resource collection comprising at least one credit resource; and
managing compliance reporting based upon at least one member of the collection comprising said user resources, said market position portfolio, said bilateral trading portfolio and said market trading collection.

98. The system of claim 97,
wherein the program step of said certified client initiating said action in said transaction system is further comprised of at least one member of the collection comprising the program steps of:
initiating a bid for a market interval at a bid price and a bid amount as a first validated order;
initiating an ask for a market interval at a ask price and a ask amount as a second validated order;
responding to a financial commitment presented by said transaction system to create a financial response to said financial commitment;
reporting at least one of said bilateral trades to said transaction system; and
confirming at least one of said bilateral trades to said transaction system;
wherein said market interval includes a product type associated with at least one of said fungible, ephemeral commodities for at least one location for at least one time interval.

99. The system of claim 98,
wherein the program step of said certified client responding to said financial commitment is further comprised of at least one member of the collection comprising the program steps of
creating a financial payment of said financial commitment in said transaction system; and
creating a financial counter-response to said financial commitment in said transaction system.

100. The system of claim 98,
wherein the program step of managing said user resource further comprises at least one member of the collection comprising the program steps of:
managing a generator of at least one of said fungible, ephemeral commodities;
managing a load consuming at least one of said fungible, ephemeral commodities;
managing a transmission facility for at least one of said fungible, ephemeral commodities;
managing an import providing at least one of said fungible, ephemeral commodities; and
managing an export consuming at least one of said fungible, ephemeral commodities.

101. The system of claim 100,
wherein the program step managing said user resource is further comprised of the program step of:
creating a first knowledge interval of said ephemeral, fungible commodity at a first time interval containing a first cost in said knowledge interval collection; and further comprised of at least one member of the collection comprising the program steps of:
maintaining a bid interval collection of bid intervals of said ephemeral, fungible commodity, each comprised of a bid price, a bid amount, and a bid time interval; and
maintaining an ask interval collection of ask intervals of said ephemeral, fungible commodity, each comprised of a ask price, a ask amount, and a ask time interval;
wherein the program step creating said first knowledge interval is comprised of the program steps of:
receiving a knowledge interval creation message to create a received knowledge interval creation message; and
creating said first knowledge interval of said ephemeral, fungible commodity at said first time interval containing said first cost in said knowledge interval collection based upon said received knowledge interval creation message.

102. The system of claim 101,
wherein the program step managing said user resource is further comprised of the program steps of:
determining said ephemeral, fungible commodity needs over a planning time interval; and
determining an equipment usage plan based upon said knowledge interval collection containing an equipment usage item of said user resource comprised of an activation time and an action belonging to an action collection comprising start-action, stop-action and throttle-action to create a resource operating schedule; and
operating said equipment usage item of said user resource based upon said device operating schedule.

103. The system of claim 102,
wherein the program step managing said user resource is further comprised of the program step of:
examining an equipment usage collection comprised of equipment usage entries each containing a delivery time and a need schedule for said ephemeral, fungible commodity to create said ephemeral, fungible commodity needs over said planning time interval comprises an amount.

104. The system of claim 103,
wherein said ephemeral, fungible commodity needs over said planning time interval further comprises a cost limit; and
wherein the program step initiating said bid is further comprised of the program step of:
making said bid of a first bid amount at a first bid price within said cost limit for said first time interval of said ephemeral, fungible commodity.

105. The system of claim 102,
wherein the program step operating said equipment usage item based upon said device operating schedule is further comprised of at least one member of the collection comprising the program steps of
starting said equipment usage item of said user resource;
stopping said equipment usage item of said user resource; and
throttling said equipment usage item of said user resource.

106. The system of claim 97,
wherein the program step of managing said market position portfolio is comprised of the program steps of:
maintaining a market window;
maintaining a local market position portfolio comprised of at least one market position summary, each of said market position summaries including a market interval of said fungible, ephemeral commodity within said market window;
presenting said local market position portfolio based upon said market window;
wherein the program step of presenting said local market position portfolio is further comprised of:
presenting at least one of said market position summaries including said market interval within said market window.

107. The system of claim 106,
wherein at least one of said market position summaries of said local market position portfolio is further comprised of an amount-held, a current bid summary, a current ask summary, a current market price and a current order summary;
wherein the program step of presenting said market position summary further comprising the program steps of:
presenting said included market interval;
presenting said amount-held;
presenting said current bid summary;
presenting said current ask summary;
presenting said current market price; and
presenting said current order summary.

108. The system of claim 107,
wherein the program system is further comprised of the program step maintaining a market position database including the program step of:
maintaining at least one of said market positions containing at least one of said market intervals further including at least one member of the collection comprising the program steps of:
maintaining an amount-held associated with said market interval;
maintaining a current bid list associated with said market interval including at least one current bid;
maintaining a current ask list associated with said market interval including at least one ask;
maintaining a current market price associated with said market interval; and
maintaining a current order list associated with said market interval.

109. The system of claim 108,
wherein the program system is further comprised of the program step of:
establishing a client node belonging to said node collection of said AC power network as said business location; and
wherein the program step maintaining said local market position portfolio is further comprised of at least one member of a calculation collection comprising the program steps of:
calculating said current bid summary from said market position database based upon said business location;
calculating said current ask summary from said market position database based upon said business location; and
calculating said current market price from said market position database based upon said business location.

110. The system of claim 109,
wherein at least one of said market intervals contains an AC power transfer product type as said fungible, ephemeral commodity and contains said location as a first of said nodes directed to a second of said nodes of said AC power network node collection.

111. The system of claim 110,
wherein the program system is further comprised of the program step of:
maintaining a flowgate collection containing at least two flowgate entries;
wherein each of said flowgate entries contained in said flowgate collection includes a factor, a from-node of said node collection and a to-node of said node collection;
wherein for each of said flowgate entries contained in said flowgate collection, at least one of said market intervals contains said AC power transfer product type as said fungible, ephemeral commodity and said location coinciding with said flowgate entry; and
wherein at least one member of said calculation collection is further based upon said flowgate collection.

112. The system of claim 111,
wherein said product type is further comprised of an AC power transfer point-to-point product type as said fungible, ephemeral commodity.

113. The system of claim 112,
wherein the program step maintaining said current bid list is further comprised of the program steps of:
receiving a request for a point-to-point bid associated with said market interval to create a received point-to-point bid request;
generating a point-to-point bid associated with said market interval based upon said received bid request to create a new point-to-point bid associated with said market interval further including the steps of:
generating a bid associated with said market interval containing said AC power transfer product type and said location coinciding with said flowgate entry, for at least one flowgate entry contained in said flowgate collection; and
sending said new point-to-point bid associated with said market interval based upon said received bid request as an order message.

114. The system of claim 106,
wherein said market trade is associated with at least one of said market intervals of said fungible, ephemeral commodity by said certified client with a member of the trade specification collection;
wherein said trade specification collection is comprised of
a bid specification containing an amount, and a price;
an ask specification containing said amount, and said price; and
an order specification containing said amount and said price;
wherein the program step managing said market trade collection is further comprised of the program step of
presenting said market trade, for at least one of said market trades, further comprised of the program steps of
presenting said market interval;
identifying said member of said trade specification collection;
presenting said amount; and
presenting said price.

115. The system of claim 97,
wherein the program step of managing said bilateral trading portfolio is further comprised of the program steps of:
managing said bilateral trade, for each of said bilateral trades of said bilateral trading portfolio.

116. The system of claim 97,
wherein the program step of managing said bilateral trading portfolio is further comprised of the program steps of:
receiving an authenticated bilateral trade notification message to create a received bilateral trade notification message;
updating said bilateral trading portfolio based upon said received bilateral trade notification message;
generating an initial bilateral trade;
processing said initial bilateral trade to create an initial bilateral trade message;
inserting said initial bilateral trade into said bilateral trading portfolio;
sending said initial bilateral trade message;
receiving a bilateral trade confirmation message to create a received bilateral trade confirmation request; and
inserting said received bilateral trade confirmation request into said bilateral trading portfolio.

117. The system of claim 116,
wherein the program step of managing said bilateral trading portfolio is further comprised of the program steps of:
responding to said received bilateral trade confirmation request to create a bilateral trade confirmation response;
inserting said bilateral trade confirmation response into said bilateral trading portfolio;
processing said bilateral trade confirmation response to create a bilateral trade confirmation response message; and
sending said bilateral trade confirmation response message.

118. The system of claim 97,
wherein the program step of managing said credit resource collection is comprised of the program steps of:
managing said credit resource, for each of said credit resources of said credit resource collection.

119. The system of claim 118,
wherein the program step of managing said credit resource, for at least one of said credit resources of said credit resource collection, is further comprised of the program steps of:
receiving a credit resource message from said transaction system to create a received credit resource message;
updating said credit resource based upon said received credit resource message;
presenting said credit resource;
preparing a credit resource request message; and
sending said credit resource request message to create a sent credit request.

120. The system of claim 119,
wherein the program step of receiving said credit resource message is further comprised of the program step of:
receiving a credit request response message from said transaction system based upon said sent credit request to create a received credit request response.

121. The system of claim 97,
wherein the program step of managing said user resource, is further comprised of the program steps of:
receiving a user resource schedule including a time interval from said transaction system to create a received schedule for said time interval;
updating an operating schedule for said user resource based upon said received schedule for said time interval to create said operating schedule containing an operating schedule entry for said time interval;
maintaining a real-time; and
controlling said user resource based upon said operating schedule for said user resource and based upon said real-time.

122. The system of claim 121,
wherein said operating schedule entry for said time interval contained in said operating schedule for said user resource includes a capacity option item; and
wherein the program step of managing said user resource is further comprised of the program steps of:
sending a capacity option exercise message for said time interval based said capacity option item to create a sent capacity option exercise; and
updating said operating schedule entry for said time interval based upon said sent capacity option exercise.

123. The system of claim 122,
wherein the program step of managing said user resource is further comprised of the program steps of:
receiving a capacity exercise acknowledgment based upon said sent capacity option exercise to create a received capacity exercise acknowledgment; and
updating said operating schedule entry for said time interval based upon said received capacity exercise acknowledgment.

124. The system of claim 123,
wherein said sent capacity option exercise includes an exercise amount;
wherein said received capacity exercise acknowledgment includes an acknowledgment amount;
wherein the program step of managing said user resource is further comprised of the program steps of:
determining if said exercise amount is greater than said acknowledgment amount; and
reporting a shortfall of said exercise amount minus said acknowledgment amount whenever said exercise amount is greater than said acknowledgment amount.

125. The system of claim 97,
wherein said program system supports said certified client acoustically communicating with said computer to interactively use said transaction system.

126. The system of claim 97, further comprising
a client computer communicatively coupled to a server computer included in a server system;
wherein said certified client operates said client computer to interactively use said transaction system.

127. The system of claim 126,
wherein said server system provides a market engine supporting a virtual trading floor involving said fungible, ephemeral commodities.

128. The system of claim 127,
wherein said server system further comprises an engine system supporting said virtual trading floor involving said fungible, ephemeral commodities.

129. A method for a certified client interactively using a transaction system supporting transactions involving at least one fungible, ephemeral commodity, comprising the step of:
said certified client initiating at least one action in said transaction system;
and further comprising at least two members of the basic usage collection comprising the steps of:
managing at least one user resource;
managing a bilateral trading portfolio comprising at least one bilateral trade in at least one of said fungible, ephemeral commodities;
managing a market position portfolio comprising at least one market position of at least one of said fungible, ephemeral commodities;
managing a market trading collection comprising at least one market trade in at least one of said fungible, ephemeral commodities;
managing a credit resource collection comprising at least one credit resource; and
managing compliance reporting based upon at least one member of the collection comprising said user resources, said market position portfolio, said bilateral trading portfolio and said market trading collection.

130. The method of claim 129,
wherein the step of said certified client initiating said action in said transaction system is further comprised of at least one member of the collection comprising the steps of:
initiating a bid for a market interval at a bid price and a bid amount as a first validated order;
initiating an ask for a market interval at a ask price and a ask amount as a second validated order;
responding to a financial commitment presented by said transaction system to create a financial response to said financial commitment;
reporting at least one of said bilateral trades to said transaction system; and
confirming at least one of said bilateral trades to said transaction system;
wherein said market interval includes a product type associated with at least one of said fungible, ephemeral commodities for at least one location for at least one time interval.

131. The method of claim 130,
wherein the step of managing said user resource further comprises at least one member of the collection comprising the steps of:
managing a generator of at least one of said fungible, ephemeral commodities;
managing a load consuming at least one of said fungible, ephemeral commodities;
managing a transmission facility for at least one of said fungible, ephemeral commodities;
managing an import providing at least one of said fungible, ephemeral commodities; and
managing an export consuming at least one of said fungible, ephemeral commodities.

132. The method of claim 131,
wherein the step managing said user resource is further comprised of the step of:
creating a first knowledge interval of said ephemeral, fungible commodity at a first time interval containing a first cost in said knowledge interval collection;
wherein the step managing said user resource is further comprised of at least one member of the collection comprising the steps of:
maintaining a bid interval collection of bid intervals of said ephemeral, fungible commodity, each comprised of a bid price, a bid amount, and a bid time interval; and
maintaining an ask interval collection of ask intervals of said ephemeral, fungible commodity, each comprised of a ask price, a ask amount, and a ask time interval;
wherein the step creating said first knowledge interval is comprised of the steps of:
receiving a knowledge interval creation message to create a received knowledge interval creation message; and
creating said first knowledge interval of said ephemeral, fungible commodity at said first time interval containing said first cost in said knowledge interval collection based upon said received knowledge interval creation message.

133. The method of claim 132,
wherein the step managing said user resource is further comprised of the steps of:
determining said ephemeral, fungible commodity needs over a planning time interval; and
determining an equipment usage plan based upon said knowledge interval collection containing an equipment usage item of said user resource comprised of an activation time and an action belonging to an action collection comprising start-action, stop-action and throttle-action to create a resource operating schedule; and
operating said equipment usage item of said user resource based upon said device operating schedule.

134. The method of claim 133,
wherein the step managing said user resource is further comprised of the step of:
examining an equipment usage collection comprised of equipment usage entries each containing a delivery time and a need schedule for said ephemeral, fungible commodity to create said ephemeral, fungible commodity needs over said planning time interval comprises an amount.

135. The method of claim 134,
wherein said ephemeral, fungible commodity needs over said planning time interval further comprises a cost limit; and
wherein the step said certified client initiating said bid is further comprised of the step of:
making said bid of a first bid amount at a first bid price within said cost limit for said first time interval of said ephemeral, fungible commodity.

136. The method of claim 133,
wherein the step operating said equipment usage item based upon said device operating schedule is further comprised of at least one member of the collection comprising the steps of
starting said equipment usage item of said user resource;
stopping said equipment usage item of said user resource; and
throttling said equipment usage item of said user resource.

137. The method of claim 130,
wherein the step of responding to said financial commitment presented by said transaction system is further comprised of at least one member of the collection comprising the steps of
creating a financial payment of said financial commitment in said transaction system; and
creating a financial counter-response to said financial commitment in said transaction system.

138. The method of claim 137,
wherein said financial commitment in said transaction system is further comprised of a first financial obligation to a first party;
wherein the step of said certified client responding to said financial commitment is further comprised of the step of
said certified client responding to said first financial obligation to said first party to create a first financial payment to said first party.

139. The first financial payment to said first party as a product of the process of claim 138.

140. The method of claim 129,
wherein the step of managing said market position portfolio is comprised of the steps of:
maintaining a market window;
maintaining a local market position portfolio comprised of at least one market position summary, each of said market position summaries including a market interval of said fungible, ephemeral commodity within said market window;
presenting said local market position portfolio based upon said market window;
wherein the step of presenting said local market position portfolio is further comprised of
presenting at least one of said market position summaries including said market interval within said market window.

141. The method of claim 140,
wherein at least one of said market position summaries of said local market position portfolio is further comprised of an amount-held, a current bid summary, a current ask summary, a current market price and a current order summary;
wherein the step of presenting said market position summary further comprising the steps of
presenting said included market interval;
presenting said amount-held;
presenting said current bid summary;
presenting said current ask summary;
presenting said current market price; and
presenting said current order summary.

142. The method of claim 141, further comprising the step of:
maintaining a market position database including the step of
maintaining at least one of said market positions containing at least one of said market intervals further including at least one member of the collection comprising the steps of
maintaining an amount-held associated with said market interval;
maintaining a current bid list associated with said market interval including at least one current bid;
maintaining a current ask list associated with said market interval including at least one ask;
maintaining a current market price associated with said market interval; and
maintaining a current order list associated with said market interval.

143. The method of claim 142, further comprised of the step of:
establishing a client node belonging to said node collection of said AC power network as said business location; and
wherein the step maintaining said local market position portfolio is further comprised of at least one member of a calculation collection comprising the steps of:
calculating said current bid summary from said market position database based upon said business location;
calculating said current ask summary from said market position database based upon said business location; and
calculating said current market price from said market position database based upon said business location.

144. The method of claim 143,
wherein at least one of said market intervals contains an AC power transfer product type as said fungible, ephemeral commodity and contains said location as a first of said nodes directed to a second of said nodes of said AC power network node collection.

145. The method of claim 144, further comprised of the step of:
maintaining a flowgate collection containing at least two flowgate entries;
wherein each of said flowgate entries contained in said flowgate collection includes a factor, a from-node of said node collection and a to-node of said node collection;
wherein for each of said flowgate entries contained in said flowgate collection, at least one of said market intervals contains said AC power transfer product type as said fungible, ephemeral commodity and said location coinciding with said flowgate entry; and
wherein at least one member of said calculation collection is further based upon said flowgate collection.

146. The method of claim 145,
wherein said product type is further comprised of an AC power transfer point-to-point product type as said fungible, ephemeral commodity.

147. The method of claim 146,
wherein the step maintaining said current bid list is further comprised of the steps of:
receiving a request for a point-to-point bid associated with said market interval to create a received point-to-point bid request;
generating a point-to-point bid associated with said market interval based upon said received bid request to create a new point-to-point bid associated with said market interval further including the steps of:
generating a bid associated with said market interval containing said AC power transfer product type and said location coinciding with said flowgate entry, for at least one flowgate entry contained in said flowgate collection; and
sending said new point-to-point bid associated with said market interval based upon said received bid request as an order message.

148. The method of claim 140,
wherein said market trade is associated with at least one of said market intervals of said fungible, ephemeral commodity by said certified client with a member of the trade specification collection;
wherein said trade specification collection is comprised of
a bid specification containing an amount, and a price;
an ask specification containing said amount, and said price; and
an order specification containing said amount and said price;
wherein the step managing said market trade collection is further comprised of the step of
presenting said market trade, for at least one of said market trades, further comprised of the steps of
presenting said market interval;
identifying said member of said trade specification collection;
presenting said amount; and
presenting said price.

149. The method of claim 129,
wherein the step of managing said bilateral trading portfolio is further comprised of the steps of:
managing said bilateral trade, for each of said bilateral trades of said bilateral trading portfolio.

150. The method of claim 129,
wherein the step of managing said bilateral trading portfolio is further comprised of the steps of:
receiving an authenticated bilateral trade notification message to create a received bilateral trade notification message;
updating said bilateral trading portfolio based upon said received bilateral trade notification message;
generating an initial bilateral trade;
processing said initial bilateral trade to create an initial bilateral trade message;
inserting said initial bilateral trade into said bilateral trading portfolio;
sending said initial bilateral trade message;
receiving a bilateral trade confirmation message to create a received bilateral trade confirmation request; and
inserting said received bilateral trade confirmation request into said bilateral trading portfolio.

151. The method of claim 150,
wherein the step of managing said bilateral trading portfolio is further comprised of the steps of:
responding to said received bilateral trade confirmation request to create a bilateral trade confirmation response;
inserting said bilateral trade confirmation response into said bilateral trading portfolio;
processing said bilateral trade confirmation response to create a bilateral trade confirmation response message; and
sending said bilateral trade confirmation response message.

152. The method of claim 129,
wherein the step of managing said credit resource collection is comprised of the steps of:
managing said credit resource, for each of said credit resources of said credit resource collection.

153. The method of claim 152,
wherein the step of managing said credit resource, for at least one of said credit resources of said credit resource collection, is further comprised of the steps of:
receiving a credit resource message to create a received credit resource message;
updating said credit resource based upon said received credit resource message;
presenting said credit resource;
preparing a credit resource request message; and
sending said credit resource request message to create a sent credit request.

154. The method of claim 153,
wherein the step of receiving said credit resource message is further comprised of the step of:
receiving a credit request response message based upon said sent credit request to create a received credit request response.

155. The method of claim 129,
wherein the step of managing said user resource, is further comprised of the steps of:
receiving a user resource schedule including a time interval to create a received schedule for said time interval;
updating an operating schedule for said user resource based upon said received schedule for said time interval to create said operating schedule containing an operating schedule entry for said time interval;
maintaining a real-time; and
controlling said user resource based upon said operating schedule for said user resource and based upon said real-time.

156. The method of claim 155,
wherein said operating schedule entry for said time interval contained in said operating schedule for said user resource includes a capacity option item; and
wherein the step of managing said user resource is further comprised of the steps of:
sending a capacity option exercise message for said time interval based said capacity option item to create a sent capacity option exercise; and
updating said operating schedule entry for said time interval based upon said sent capacity option exercise.

157. The method of claim 156,
wherein the step of managing said user resource is further comprised of the steps of:
receiving a capacity exercise acknowledgment based upon said sent capacity option exercise to create a received capacity exercise acknowledgment; and
updating said operating schedule entry for said time interval based upon said received capacity exercise acknowledgment.

158. The method of claim 157,
wherein said sent capacity option exercise includes an exercise amount;
wherein said received capacity exercise acknowledgment includes an acknowledgment amount;
wherein the step of managing said user resource is further comprised of the steps of:
determining if said exercise amount is greater than said acknowledgment amount; and
reporting a shortfall of said exercise amount minus said acknowledgment amount whenever said exercise amount is greater than said acknowledgment amount.

159. The method of claim 129,
wherein said certified client acoustically communicates with said transaction system to interactively use said transaction system.

160. The method of claim 129,
wherein said transaction system is comprised of a client computer communicatively coupled to a server computer included in a server system;
wherein said certified client operates said client computer to interactively use said transaction system.

161. The method of claim 160,
wherein said server system provides a market engine supporting a virtual trading floor involving at least one of said fungible, ephemeral commodities.

162. The method of claim 161,
wherein said server system further comprises an engine system supporting said virtual trading floor involving said fungible, ephemeral commodities.

163. The method of claim 160,
wherein said client computer is controlled by a program system containing program steps residing in a memory accessibly coupled to said client computer;
wherein said program system is comprised of at least two members each implementing a member of said basic usage collection.

164. A transaction system for supporting transactions involving at least one fungible, ephemeral commodity, comprising:
a means for using said transaction system communicatively coupled to a certified client further comprising:
a means for said certified client initiating at least one action in said transaction system; and further comprised of at least two members of the basic usage means collection comprising of:
a means for managing at least one user resource;
a means for managing a bilateral trading portfolio comprising at least one bilateral trade in at least one of said fungible, ephemeral commodities;
a means for managing a market position portfolio comprising market positions of at least one of said fungible, ephemeral commodities;
a means for managing a market trading collection comprising at least one market trade in at least one of said fungible, ephemeral commodities;
a means for managing a credit resource collection comprising at least one credit resource; and
a means for managing compliance reporting based upon at least one member of the collection comprising said user resources, said market position portfolio, said bilateral trading portfolio and said market trading collection.

165. The system of claim 164,
wherein said means for said certified client initiating said action in said transaction system is further comprised of at least one member of the collection comprising:
a means for initiating a bid for a market interval at a bid price and a bid amount as a first validated order;
a means for initiating an ask for a market interval at a ask price and a ask amount as a second validated order;
a means for responding to a financial commitment presented by said transaction system to create a financial response to said financial commitment;
a means for reporting at least one of said bilateral trades to said transaction system; and
a means for confirming at least one of said bilateral trades to said transaction system;
wherein said market interval includes a product type associated with at least one of said fungible, ephemeral commodities for at least one location for at least one time interval.

166. The system of claim 165,
wherein said means for responding to said financial commitment presented by said transaction system is further comprised of at least one member of the collection comprising
a means for creating a financial payment of said financial commitment in said transaction system; and
a means for creating a financial counter-response to said financial commitment in said transaction system.

167. The system of claim 164,
wherein said means for managing said user resource further comprises at least one member of the collection comprising:
a means for managing a generator of at least one of said fungible, ephemeral commodities;
a means for managing a load consuming at least one of said fungible, ephemeral commodities;
a means for managing a transmission facility for at least one of said fungible, ephemeral commodities;
a means for managing an import providing at least one of said fungible, ephemeral commodities; and
a means for managing an export consuming at least one of said fungible, ephemeral commodities.

168. The system of claim 167,
wherein said means for managing said user resource is further comprised of:
a means for creating a first knowledge interval of said ephemeral, fungible commodity at a first time interval containing a first cost in said knowledge interval collection; and at least one member of the collection comprising:
a means for maintaining a bid interval collection of bid intervals of said ephemeral, fungible commodity, each comprised of a bid price, a bid amount, and a bid time interval; and
a means for maintaining an ask interval collection of ask intervals of said ephemeral, fungible commodity, each comprised of a ask price, a ask amount, and a ask time interval;
wherein said means for creating said first knowledge interval is comprised of:
a means for receiving a knowledge interval creation message to create a received knowledge interval creation message; and
a means for creating said first knowledge interval of said ephemeral, fungible commodity at said first time interval containing said first cost in said knowledge interval collection based upon said received knowledge interval creation message.

169. The system of claim 168,
wherein said means for managing said user resource is further comprised of:
a means for determining said ephemeral, fungible commodity needs over a planning time interval; and
a means for determining an equipment usage plan based upon said knowledge interval collection containing an equipment usage item of said user resource comprised of an activation time and an action belonging to an action collection comprising start-action, stop-action and throttle-action to create a resource operating schedule; and
a means for operating said equipment usage item of said user resource based upon said device operating schedule.

170. The system of claim of 169,
wherein said means for managing said user resource is further comprised of:
a means for examining an equipment usage collection comprised of equipment usage entries each containing a delivery time and a need schedule for said ephemeral, fungible commodity to create said ephemeral, fungible commodity needs over said planning time interval comprises an amount.

171. The system of claim of 170,
wherein said ephemeral, fungible commodity needs over said planning time interval further comprises a cost limit; and
wherein said means for said certified client initiating said bid is further comprised of:
a means for making said bid of a first bid amount at a first bid price within said cost limit for said first time interval of said ephemeral, fungible commodity.

172. The system of claim 169,
wherein said means for operating said equipment usage item based upon said device operating schedule is further comprised of at least one member of the collection comprising
a means for starting said equipment usage item of said user resource;
a means for stopping said equipment usage item of said user resource; and
a means for throttling said equipment usage item of said user resource.

173. The system of claim 164,
wherein said means for managing said market position portfolio is comprised of:
a means for maintaining a market window;
a means for maintaining a local market position portfolio comprised of at least one market position summary, each of said market position summaries including a market interval of said fungible, ephemeral commodity within said market window;
a means for presenting said local market position portfolio based upon said market window;
wherein said means for presenting said local market position portfolio is further comprised of:
a means for presenting at least one of said market position summaries including said market interval within said market window.

174. The system of claim 173,
wherein at least one of said market position summaries of said local market position portfolio is further comprised of an amount-held, a current bid summary, a current ask summary, a current market price and a current order summary;
wherein said means for presenting said market position summary further comprising:
a means for presenting said included market interval;
a means for presenting said amount-held;
a means for presenting said current bid summary;
a means for presenting said current ask summary;
a means for presenting said current market price; and
a means for presenting said current order summary.

175. The system of claim 174, further comprising:
a means for maintaining a market position database including:
a means for maintaining at least one of said market positions containing at least one of said market intervals further including at least one member of the collection comprising:
a means for maintaining an amount-held associated with said market interval;
a means for maintaining a current bid list associated with said market interval including at least one current bid;
a means for maintaining a current ask list associated with said market interval including at least one ask;
a means for maintaining a current market price associated with said market interval; and
a means for maintaining a current order list associated with said market interval.

176. The system of claim 175, further comprising:
a means for establishing a client node belonging to said node collection of said AC power network as said business location; and
wherein said means for maintaining said local market position portfolio is further comprised of at least one member of a calculation collection comprising:
a means for calculating said current bid summary from said market position database based upon said business location;
a means for calculating said current ask summary from said market position database based upon said business location; and
a means for calculating said current market price from said market position database based upon said business location.

177. The system of claim 176,
wherein at least one of said market intervals contains an AC power transfer product type as said fungible, ephemeral commodity and contains said location as a first of said nodes directed to a second of said nodes of said AC power network node collection.

178. The system of claim 177, further comprising:
a means for maintaining a flowgate collection containing at least two flowgate entries;
wherein each of said flowgate entries contained in said flowgate collection includes a factor, a from-node of said node collection and a to-node of said node collection;
wherein for each of said flowgate entries contained in said flowgate collection, at least one of said market intervals contains said AC power transfer product type as said fungible, ephemeral commodity and said location coinciding with said flowgate entry; and
wherein at least one member of said calculation collection is further based upon said flowgate collection.

179. The system of claim 178,
wherein said product type is further comprised of an AC power transfer point-to-point product type as said fungible, ephemeral commodity.

180. The system of claim 179,
wherein said means for maintaining said current bid list is further comprised of:
a means for receiving a request for a point-to-point bid associated with said market interval to create a received point-to-point bid request;
a means for generating a point-to-point bid associated with said market interval based upon said received bid request to create a new point-to-point bid associated with said market interval further including:
a means for generating a bid associated with said market interval containing said AC power transfer product type and said location coinciding with said flowgate entry, for at least one flowgate entry contained in said flowgate collection; and
a means for sending said new point-to-point bid associated with said market interval based upon said received bid request as an order message.

181. The system of claim 173,
wherein said market trade is associated with at least one of said market intervals of said fungible, ephemeral commodity by said certified client with a member of the trade specification collection;
wherein said trade specification collection is comprised of
a bid specification containing an amount, and a price;
an ask specification containing said amount, and said price; and
an order specification containing said amount and said price;
wherein said means for managing said market trade collection is further comprised of
a means for presenting said market trade, for at least one of said market trades, further comprised of
a means for presenting said market interval;
a means for identifying said member of said trade specification collection;
a means for presenting said amount; and
a means for presenting said price.

182. The system of claim 164,
wherein said means for managing said bilateral trading portfolio is further comprising:
a means for managing said bilateral trade, for at least one flowgate entry contained in said flowgate collection.

183. The system of claim 164,
wherein said means for managing said bilateral trading portfolio is further comprised of:
a means for receiving an authenticated bilateral trade notification message to create a received bilateral trade notification message; and
a means for updating said bilateral trading portfolio based upon said received bilateral trade notification message;
a means for generating an initial bilateral trade;
a means for processing said initial bilateral trade to create an initial bilateral trade message;
a means for inserting said initial bilateral trade into said bilateral trading portfolio; and
a means for sending said initial bilateral trade message;
a means for receiving a bilateral trade confirmation message to create a received bilateral trade confirmation request; and
a means for inserting said received bilateral trade confirmation request into said bilateral trading portfolio.

184. The system of claim 183,
wherein said means for managing said bilateral trading portfolio is further comprised of:
a means for responding to said received bilateral trade confirmation request to create a bilateral trade confirmation response;
a means for inserting said bilateral trade confirmation response into said bilateral trading portfolio;
a means for processing said bilateral trade confirmation response to create a bilateral trade confirmation response message; and
a means for sending said bilateral trade confirmation response message.

185. The system of claim 164,
wherein said means for managing said credit resource collection is comprised of:
a means for managing said credit resource, for each of said credit resources of said credit resource collection.

186. The system of claim 185,
wherein said means for managing said credit resource, for at least one of said credit resources of said credit resource collection, is further comprised of:
a means for receiving a credit resource message from said transaction system to create a received credit resource message;
a means for updating said credit resource based upon said received credit resource message;
a means for presenting said credit resource;
a means for preparing a credit resource request message; and
a means for sending said credit resource request message to create a sent credit request.

187. The system of claim 186,
wherein said means for receiving said credit resource message is further comprised of:
a means for receiving a credit request response message from said transaction system based upon said sent credit request to create a received credit request response.

188. The system of claim 164,
wherein said means for managing said user resource, is further comprised of:
a means for receiving a user resource schedule including a time interval from said transaction system to create a received schedule for said time interval;
a means for updating an operating schedule for said user resource based upon said received schedule for said time interval to create said operating schedule containing an operating schedule entry for said time interval;
a means for maintaining a real-time; and
a means for controlling said user resource based upon said operating schedule for said user resource and based upon said real-time.

189. The system of claim 188,
wherein said operating schedule entry for said time interval contained in said operating schedule for said user resource includes a capacity option item; and
wherein said means for managing said user resource is further comprised of:
a means for sending a capacity option exercise message for said time interval based said capacity option item to create a sent capacity option exercise; and
a means for updating said operating schedule entry for said time interval based upon said sent capacity option exercise.

190. The system of claim 189,
wherein said means for managing said user resource is further comprised of:
a means for receiving a capacity exercise acknowledgment based upon said sent capacity option exercise to create a received capacity exercise acknowledgment; and
a means for updating said operating schedule entry for said time interval based upon said received capacity exercise acknowledgment.

191. The system of claim 190,
wherein said sent capacity option exercise includes an exercise amount;
wherein said received capacity exercise acknowledgment includes an acknowledgment amount;
wherein said means for managing said user resource is further comprised of:
a means for determining if said exercise amount is greater than said acknowledgment amount; and
a means for reporting a shortfall of said exercise amount minus said acknowledgment amount whenever said exercise amount is greater than said acknowledgment amount.

192. The system of claim 164,
wherein said means for using said transaction system supports at least one member of the collection comprising:
said certified client acoustically communicating with said transaction system to interactively use said transaction system;
said certified client communicating in a tactile fashion with said transaction system to interactively use said transaction system;
said certified client communicating in a wireless fashion with said transaction system to interactively use said transaction system; and
said certified client communicating in a wireline fashion with said transaction system to interactively use said transaction system.

193. The system of claim 164,
wherein said transaction system is further comprised of at least one computer operated by said certified client and controlled by a program system comprised of program steps residing in a memory accessibly coupled to said computer.

194. The system of claim 193,
wherein said means for using said transaction system is implemented as at least one of said program steps in said program system.

195. The system of claim 193,
wherein at least one member of said basic usage means collection is implemented as at least one of said program steps in said program system.

196. The system of claim 193,
wherein said means for said certified client initiating said action is implemented as at least one of said program steps in said program system.

197. The system of claim 164,
wherein said transaction system is further comprised of a client computer communicatively coupled to a server computer included in a server system;
wherein said certified client operates said client computer to interactively use said transaction system.

198. The system of claim 197,
wherein said server system provides a market engine supporting a virtual trading floor involving said fungible, ephemeral commodities.

199. The system of claim 198,
wherein said server system further comprises an engine system supporting said virtual trading floor involving said fungible, ephemeral commodities.
